(19) United States
(12) Patent Application Publication
(10) Pub. No.: US 2004/0086752 A1
(43) Pub. Date: May 6, 2004

(54) Magnetoresistive element and method for manufacturing the same

(75) Inventors: Nozomu Matsukawa, Nara-shi (JP); Akihiro Odagawa, Nara-shi (JP); Yasunari Sugita, Osaka-shi (JP); Mitsuo Satomi, Katano-shi (JP); Yoshio Kawashima, Neyagawa-shi (JP); Masayoshi Hiramoto, Ikoma-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., Kadoma-shi (JP)

(21) Appl. No.: 10/693,283

(22) Filed: Oct. 24, 2003

Related U.S. Application Data
(63) Continuation of application No. PCT/JP02/06344, filed on Jun. 25, 2002.

(30) Foreign Application Priority Data
Jun. 26, 2001 (JP) 2001-192217

(51) Int. Cl. B32B 9/00

(52) U.S. Cl. 428/692

(57) ABSTRACT

The present invention provides a magnetoresistive element that has excellent magnetoresistance characteristics over a conventional magnetoresistive element. The magnetoresistive element is produced by a method including heat treatment at 330° C. or more and characterized in that the longest distance from a centerline of a non-magnetic layer to the interfaces between a pair of ferromagnetic layers and the non-magnetic layer is not more than 10 nm. This element can be produced, e.g., by forming an underlying film on a substrate, heat-treating the underlying film at 400° C. or more, decreasing surface roughness by irradiating the surface of the underlying film with an ion beam, and forming the ferromagnetic layers and the non-magnetic layer. The longest distance is reduced relatively even when M¹ (at least one element selected from Tc, Re, Ru, Os, Rh, Ir, Pd, Pt, Cu, Ag and Au) is added to the ferromagnetic layers in the range of 2 nm from the interfaces with the non-magnetic layer.

### BACKGROUND OF THE INVENTION

1. Field of the Invention

The present invention relates to a magnetoresistive element used in a magnetic head for magnetic recording such as a hard disk drive (HDD) and a magnetic random access memory (MRAM), and to a method for manufacturing the magnetoresistive element.

2. Description of the Related Art

A multi-layer film that has a basic structure of ferromagnetic layer/non-magnetic layer/ferromagnetic layer can provide a magnetoresistance effect when current flows across the non-magnetic layer. A spin tunnel effect can be obtained when using a tunnel insulating layer as the non-magnetic layer, and a CPP (current perpendicular to the plane) GMR effect can be obtained when using a conductive metal layer of Cu or the like as the non-magnetic layer. Both magnetoresistance effects (MR effects) depend on the magnitude of a relative angle between magnetizations of the ferromagnetic layers that sandwich the non-magnetic layer. The spin tunnel effect is derived from a change in transition probability of tunnel electrons flowing between the two magnetic layers with the relative angle of magnetizations. The CPP-GMR effect is derived from a change in spin-dependent scattering.

When a magnetoresistive element is used in a device, particularly in a magnetic memory such as MRAM, a monolithic structure combining the magnetoresistive element and a conventional Si semiconductor is necessary in view of cost and the degree of integration.

To remove defects in wiring, a Si semiconductor process includes heat treatment at high temperatures. This heat treatment is performed, e.g., in hydrogen at about 400° C. to 450° C. However, the MR characteristics of the magnetoresistive element are degraded under heat treatment at 300° C. to 350° C. or more.

A method for incorporating the magnetoresistive element after formation of the semiconductor element also has been proposed. However, this method requires that wiring or the like for applying a magnetic field to the magnetoresistive element should be formed after producing the magnetoresistive element. Therefore, heat treatment is needed eventually, or a variation in wiring resistance is caused to degrade reliability and stability of the element.

### SUMMARY OF THE INVENTION

A first magnetoresistive element of the present invention includes a substrate and a multi-layer film formed on the substrate. The multi-layer film includes a pair of ferromagnetic layers and a non-magnetic layer sandwiched between the pair of ferromagnetic layers. A resistance value depends on a relative angle formed by the magnetization directions of the pair of ferromagnetic layers. The magnetoresistive element is produced by a method including heat treatment of the substrate and the multi-layer film at 330° C. or more, in some cases 350° C. or more, and in other cases 400° C. or more. In this magnetoresistive element, when a centerline is defined so as to divide the non-magnetic layer into equal parts in the thickness direction, the longest distance R1 from the centerline to the interfaces between the pair of ferromagnetic layers and the non-magnetic layer is not more than 20 nm, and preferably not more than 10 nm.

Here, the longest distance R1 is determined by defining ten centerlines, each of which has a length of 50 nm, measuring the distances from the ten centerlines to the interfaces so as to find the longest distance for each of the ten centerlines, taking eight values except for the maximum and the minimum values from the ten longest distances, and calculating an average of the eight values.

The present invention also provides a method suitable for manufacturing the first magnetoresistive element. This method includes the following steps: forming a part of the multi-layer film other than the ferromagnetic layers and the non-magnetic layer on the substrate as an underlying film; heat-treating the underlying film at 400° C. or more; decreasing roughness of the surface of the underlying film by irradiating the surface with an ion beam; forming the remaining part of the multi-layer film including the ferromagnetic layers and the non-magnetic layer on the surface; and heat-treating the substrate and the multi-layer film at 330° C. or more, in some cases 350° C. or more, and in other cases 400° C. or more.

A second magnetoresistive element of the present invention includes a substrate and a multi-layer film formed on the substrate. The multi-layer film includes a pair of ferromagnetic layers and a non-magnetic layer sandwiched between the pair of ferromagnetic layers. A resistance value depends on a relative angle formed by the magnetization directions of the pair of ferromagnetic layers. The magnetoresistive element is produced by a method including heat treatment of the substrate and the multi-layer film at 330° C. or more, in some cases 350° C. or more, and in other cases 400° C. or more. In this magnetoresistive element, a composition in the range that extends by 2 nm from at least one of the interfaces between the pair of ferromagnetic layers and the non-magnetic layer in the direction opposite to the non-magnetic layer is expressed by

(FexCoyNiz)pM¹qM²rM³sAt

where M¹ is at least one element selected from the group consisting of Tc, Re, Ru, Os, Rh, Ir, Pd, Pt, Cu, Ag and Au, M² is at least one element selected from the group consisting of Mn and Cr, M³ is at least one element selected from the group consisting of Ti, Zr, Hf, V, Nb, Ta, Mo, W, Al, Si, Ga, Ge, In and Sn, A is at least one element selected from the group consisting of B, C, N, O, P and S, and x, y, z, p, q, r, s, and t satisfy the following equations: 0≦x≦100, 0≦y≦100, 0≦z≦100, x+y+z=100, 40≦p≦99.7, 0.3≦q≦60, 0≦r≦20, 0≦s≦30, 0≦t≦20, and p +q+r+s+t=100.

### BRIEF DESCRIPTION OF THE DRAWINGS

FIGS. 1A to 1C are cross-sectional views illustrating the longest distance R1.

FIG. 2 is a plan view showing an embodiment of a magnetoresistive element of the present invention.

FIG. 3 is a cross-sectional view showing an embodiment of a magnetoresistive element of the present invention.

FIG. 4 is a cross-sectional view showing an example of the basic configuration of a magnetoresistive element of the present invention.

FIG. 5 is a cross-sectional view showing another example of the basic configuration of a magnetoresistive element of the present invention.

FIG. 6 is a cross-sectional view showing yet another example of the basic configuration of a magnetoresistive element of the present invention.

FIG. 7 is a cross-sectional view showing still another example of the basic configuration of a magnetoresistive element of the present invention.

FIG. 8 is a cross-sectional view showing still another example of the basic configuration of a magnetoresistive element of the present invention.

FIG. 9 is a cross-sectional view showing still another example of the basic configuration of a magnetoresistive element of the present invention.

FIG. 10 is a cross-sectional view showing still another example of the basic configuration of a magnetoresistive element of the present invention.

FIG. 11 is a cross-sectional view showing still another example of the basic configuration of a magnetoresistive element of the present invention.

FIGS. 12A to 12D are cross-sectional views each showing a portion of a magnetoresistive element produced in examples.

### DESCRIPTION OF THE PREFERRED EMBODIMENTS

The experiments proved that heat treatment at high temperatures degrades flatness of the interfaces of a non-magnetic layer, and there is correlation between the flatness and the MR characteristics of an element. When an underlying film is processed and/or the composition in the vicinity of either of the interfaces is adjusted so as to reduce roughness of the interfaces of the non-magnetic layer after heat treatment, the MR characteristics of the element can be improved.

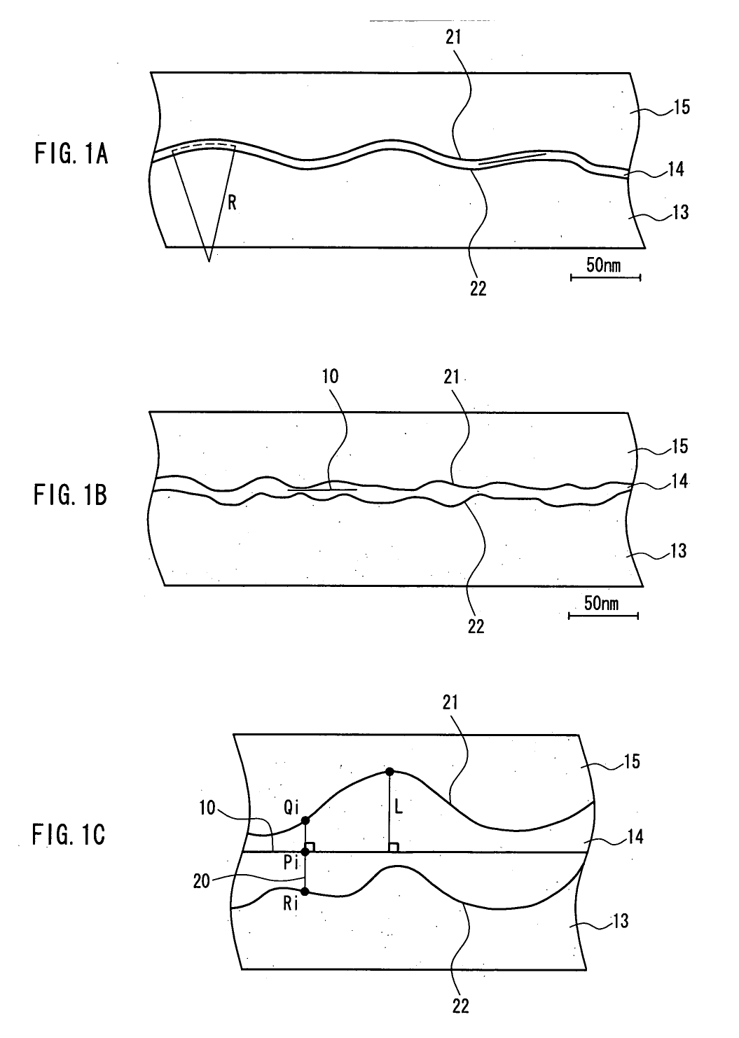

Among the types of “roughness” of the interfaces of the non-magnetic layer, the “roughness” that occurs in a relatively short period exerts a large effect on the MR characteristics. As shown in FIG. 1A, “waviness” may be generated on interfaces 21, 22 between ferromagnetic layers 13, 15 and a non-magnetic layer 14. The waviness can be expressed by a large radius of curvature R. However, the “waviness” as illustrated in FIG. 1A hardly affects the MR characteristics because of its long pitch. For more clear understanding of the relationship with the MR characteristics of an element, it is desirable to evaluate the state of the interfaces in the range of about 50 nm.

As shown in FIG. 1B, this specification defines a centerline 10 so as to divide the non-magnetic layer 14 into equal parts in the thickness direction and uses this centerline 10 as a reference line to understand the relationship with the MR characteristics. This method makes it possible to evaluate the state of the two interfaces 21, 22 at the same time. Specifically, the centerline 10 can be defined by a least-square method. As enlarged in FIG. 1C, this method takes into account a distance PiQi between a point Pi on the centerline 10 and an intersection point Qi of a normal 20 to the centerline 10 that goes through the point Pi and the interface 21, and a distance PiRi between the point Pi and an intersection point Ri of the normal 20 and the interface 22. The centerline 10 is defined so as to minimize ∫(PiQi)² dx under the condition that the sum of the square of PiQi is equal to that of PiRi (∫(PiQi)²dx=∫(PiRi)² dx).

By defining the centerline 10 in this manner, the longest distance L between the centerline 10 and the interfaces 21, 22 can be determined in accordance with the centerline 10. To eliminate measurement errors as much as possible, this specification determines ten longest distances L for each of ten arbitrarily defined centerlines, takes eight distances L except for the maximum and the minimum values (Lₘₐₓ, Lₘᵢₙ), calculates an average of the eight distances L, and uses this average as a measure R1 of evaluation.

This measurement may be performed based on a cross-sectional image of a transmission electron microscope (TEM). Simple evaluation also can be performed in the following manner: a model film is prepared by stopping the film forming process after the non-magnetic layer is deposited; the model film is subjected to in-situ heat treatment in the atmosphere of a reduced pressure; and the surface shape is observed with an atomic force microscope while maintaining the state of the film.

As long as the studies conducted, the evaluation with R1 is most suitable for understanding the relationship between the MR characteristics and the flatness of the non-magnetic layer. However, this relation may be explained better by the evaluation based on the minimum radius of curvature of the interfaces. At present, there is a limit to controlling the thickness of a sample for TEM observation. Therefore, except for a portion having a sufficiently small thickness, the interfaces tend to be overlapped in the thickness direction. Thus, it is impossible to clearly specify the minimum radius of curvature of a sample having a particularly small minimum radius of curvature. Depending on the progress in technique of producing samples for TEM observation, however, more appropriate evaluation criteria may be provided. For example, the minimum radius of curvature is measured at ten portions in the range of 50 to 100 nm, and eight values except for the maximum and the minimum values are taken to calculate an average in the same manner as described above.

The flatness of the non-magnetic layer is affected by the state of an underlying film on which a multi-layer structure is formed. In the multi-layer structure, the non-magnetic layer is positioned between the ferromagnetic layers (ferromagnetic layer/non-magnetic layer/ferromagnetic layer). When the multi-layer film further includes lower and upper electrodes that sandwich a pair of ferromagnetic layers, the underlying film includes the lower electrode. The lower electrode often has a relatively large thickness, e.g., about 100 nm to 2 μm. Therefore, the thickness of the underlying film, which has at least a portion formed with the lower electrode, is increased. The surface flatness of the underlying film with an increased thickness and the distortion in layers tend to affect the flatness of the non-magnetic layer to be formed on the underlying film.

The lower electrode is not limited to a single-layer film and may be a multi-layer film formed with a plurality of conductive films.

It is preferable that the underlying film is heat-treated at 400° C. or more and preferably 500° C. or less. This heat treatment can reduce the distortion of the underlying film. The heat treatment is not particularly limited and may be performed in the atmosphere of a reduced pressure or inert gas such as Ar.

The surface roughness of the underlying film can be suppressed by ion-milling the surface at a low angle or irradiating it with a gas cluster ion beam. The ion beam irradiation may be performed so that the angle of incidence of the ion beam at the surface of the underlying film is 5° to 25°. Here, the angle of incidence is 90° when the ion beam orients perpendicular to the surface and is 0° when it orients parallel to the surface.

Considering, e.g., the growth of crystal grains due to heat treatment, the process of decreasing roughness by ion beam irradiation should be performed after the heat treatment. The surface irradiated with the ion beam preferably is a plane on which the ferromagnetic layer is formed directly. However, it can be a plane for supporting the ferromagnetic layer via other layers.

The use of a single-crystal substrate makes it easy to produce an element having a low R1. There are some cases where an element having a small R1 can be obtained, e.g., by irradiating the lower electrode layer with an ion beam even if the single-crystal substrate is not used.

The flatness of the non-magnetic layer is affected also by the composition of the ferromagnetic layers in the vicinity of either of the interfaces of the non-magnetic layer.

Specifically, in the range of 2 nm, preferably in the range of 4 nm, from at least one of the interfaces between a pair of ferromagnetic layers and the non-magnetic layer, the composition of the ferromagnetic layer in contact with the at least one of the interfaces is expressed by

(FexCoyNiz)pM¹qM²rM³sAt

where M¹ is at least one element selected from the group consisting of Tc, Re, Ru, Os, Rh, Ir, Pd, Pt, Cu, Ag and Au, preferably Ir, Pd and Pt, M² is at least one element selected from the group consisting of Mn and Cr, M³ is at least one element selected from the group consisting of Ti, Zr, Hf, V, Nb, Ta, Mo, W, Al, Si, Ga, Ge, In and Sn, and A is at least one element selected from the group consisting of B, C, N, O, P and S.

Also, x, y, z, p, q, r, s, and t satisfy 0≦x≦100, 0≦y≦100 0≦z≦100, x+y+z=100, 40≦p≦99.7, 0.3≦q≦60, 0≦r≦20, 0≦s≦30, 0≦t≦20, and p+q+r+s+t=100.

In the above equations, p, q, and r may satisfy p+q+r=100 (s=0, t=0), and also p and q may satisfy p+q=100 (s=0, t=0, r=0).

When the element M¹ is included in the vicinity of either of the interfaces with the non-magnetic layer, a small R1 can be achieved easily. There are some cases where the MR characteristics after heat treatment at 330° C. or more are even more improved than those before the heat treatment by addition of the element M¹. The effects of the element M¹ are not clarified fully at present. Since these elements have a catalytic effect on oxygen or the like, the state of bonding between non-magnetic compounds that constitute the non-magnetic layer is enhanced, which may lead to an improvement in barrier characteristics.

When the content of the element M¹ is more than 60 at % (q>60), the function as a ferromagnetic material in the ferromagnetic layer is reduced, thus degrading the MR characteristics. The preferred content of the element M¹ is 3 to 30 at % (3≦q≦30).

The element M² is oxidized easily and becomes an oxide having magnetism after oxidation. The element M² may be used for an antiferromagnetic layer. When the element M² is diffused to the vicinity of either of the interfaces with the non-magnetic layer by heat treatment, it forms an oxide in the vicinity of either of the interfaces. This may cause degradation of the characteristics. However, when the element M² is not more than 20 at % (r≦20) and is present with the element M¹, the MR characteristics are not degraded significantly. In particular, when the content of the element M² is smaller than that of the element M¹ (q>r), there are some cases where the MR characteristics are improved rather than degraded. When added with the element M¹ (q>0, r>0), the element M² may contribute to the improvement in MR characteristics after heat treatment.

When the magnetoresistive element is used in a device, the magnetic characteristics, such as soft magnetic properties and high-frequency properties, become important other than the MR characteristics. In this case, the element M³ and the element A should be added appropriately within the above range.

The ratio of Fe, Co, and Ni is not particularly limited, as long as the total content is 40 to 99.7 at %. However, in the presence of all the three elements, it is preferable to establish 0≦x 100, 0≦y≦100, 0≦z≦90 (particularly, 0≦z≦65). In the case of a two-component system of Fe and Co (z=0), it is preferable to establish 5≦x≦100 and 0≦y≦95. In the case of a two-component system of Fe and Ni (y=0), it is preferable to establish 5≦x≦100 and 0≦z≦95.

To analyze the composition, a local composition analysis using, e.g., TEM may be preformed. A model film obtained by stopping the film forming process after the non-magnetic layer is deposited may be used as the ferromagnetic layer located below the non-magnetic layer. In this case, the model film is heat-treated at a predetermined temperature, then the non-magnetic layer is removed appropriately by milling, and thus the composition is measured with surface analysis such as Auger electron spectroscopy and XPS composition analysis.

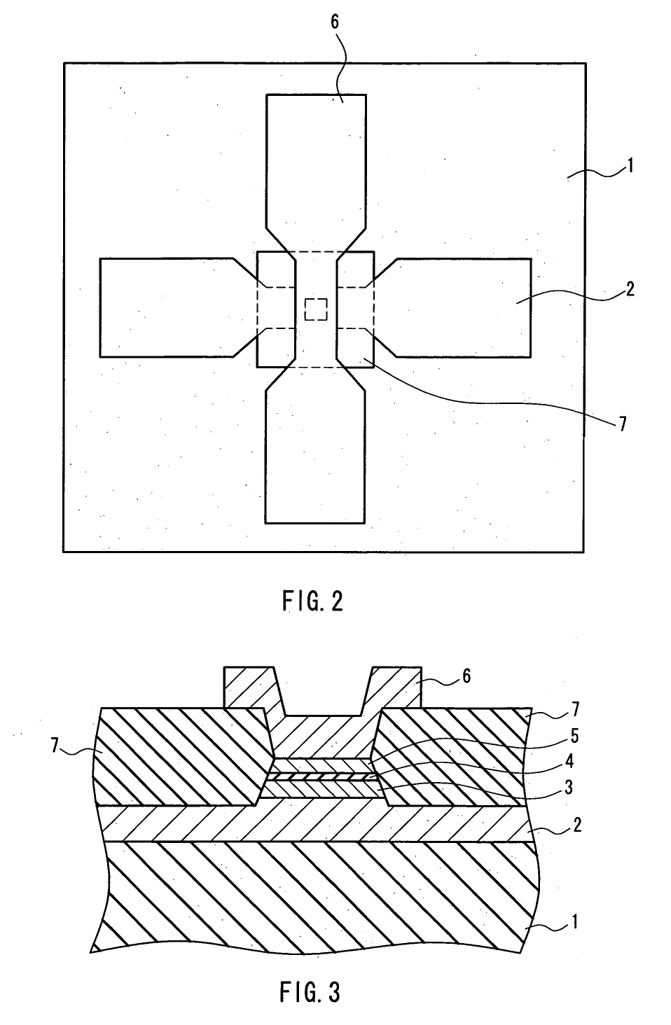

FIGS. 2 and 3 show the basic configuration of a magnetoresistive element. This element includes a lower electrode 2, a first ferromagnetic layer 3, a non-magnetic layer 4, a second ferromagnetic layer 5, and an upper electrode 6 in this order on a substrate 1. A pair of electrodes 2, 6 that sandwich a laminate of ferromagnetic layer/non-magnetic layer/ferromagnetic layer are isolated by an interlayer insulating film 7.

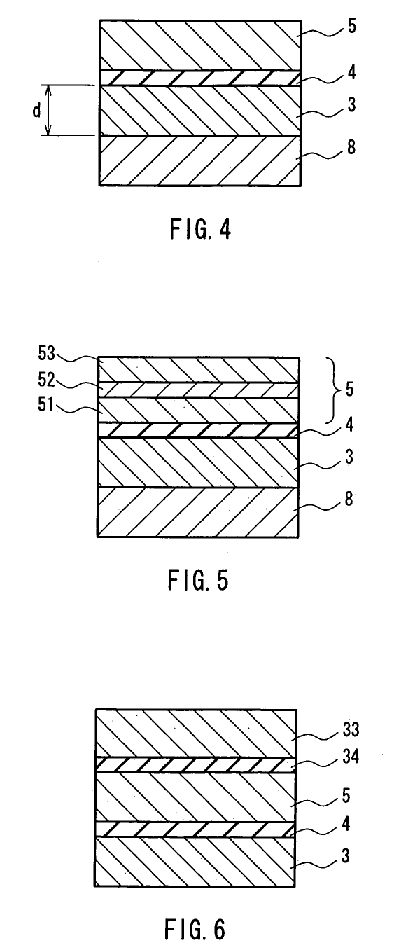

The film configuration of the magnetoresistive element is not limited to the above, and other layers can be added further as shown in FIGS. 4 to 11. If necessary, lower and upper electrodes are arranged respectively below and above the laminate shown, though these drawings omit both electrodes. Other layers that are not illustrated in the drawings (e.g.; an underlying layer and a protective layer) also can be added.

As shown in FIG. 4, an antiferromagnetic layer 8 is formed in contact with a ferromagnetic layer 3. In this element, the ferromagnetic layer 3 shows unidirectional anisotropy due to an exchange bias magnetic field with the antiferromagnetic layer 8, and thus the reversing magnetic field becomes larger. By adding the antiferromagnetic layer 8, the element becomes a spin-valve type element, in which the ferromagnetic layer 3 functions as a pinned magnetic layer and the ferromagnetic layer 5 functions as a free magnetic layer.

As shown in FIG. 5, a laminated ferrimagnetic material may be used as a free magnetic layer 5. The laminated ferrimagnetic material includes a pair of ferromagnetic layers 51, 53 and a non-magnetic metal film 52 sandwiched between the ferromagnetic layers.

As shown in FIG. 6, the element may be formed as a dual spin-valve type element. In this element, two pinned magnetic layers 3, 33 are arranged so as to sandwich a free magnetic layer 5, and non-magnetic layers 4, 34 are located between the free magnetic layer 5 and the pinned magnetic layers 3, 33.

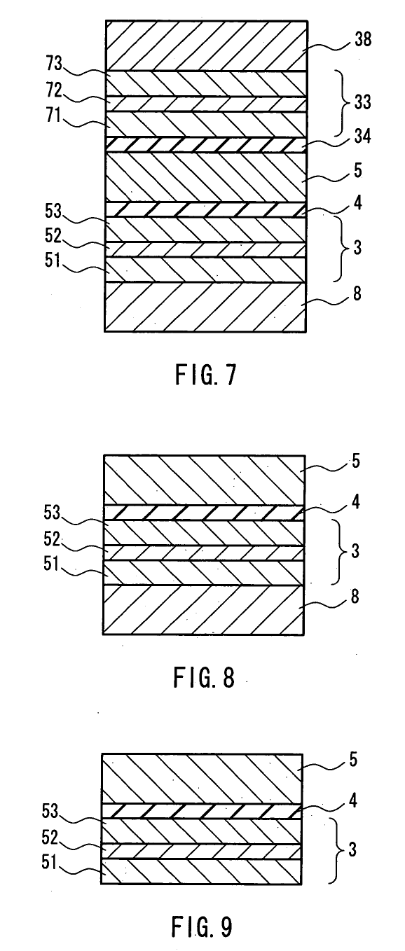

As shown in FIG. 7, laminated ferrimagnetic materials 51, 52, 53; 71, 72, 73 may be used as pinned magnetic layers 3, 33 in the dual spin-valve type element. In this element, antiferromagnetic layers 8, 38 are arranged in contact with the pinned magnetic layers 3, 33.

As shown in FIG. 8, a laminated ferrimagnetic material may be used as the pinned magnetic layer 3 of the element in FIG. 4. The laminated ferrimagnetic material includes a pair of ferromagnetic layers 51, 53 and a non-magnetic metal film 52 sandwiched between the ferromagnetic layers.

As shown in FIG. 9, the element may be formed as a differential coercive force type element that does not include an antiferromagnetic layer. In this element, a laminated ferrimagnetic material 51, 52, 53 is used as a pinned magnetic layer 3.

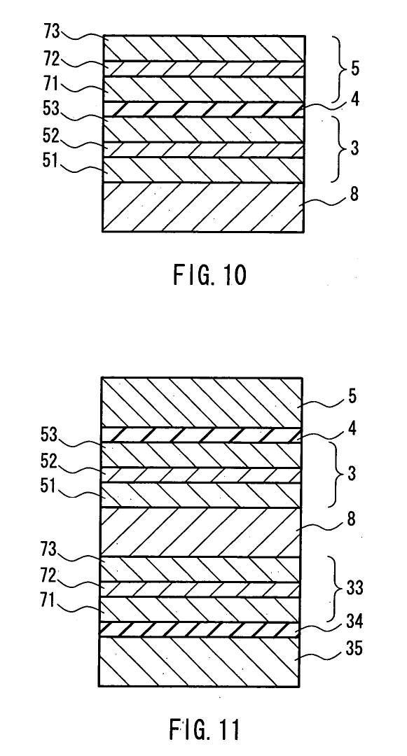

As shown in FIG. 10, a laminated ferrimagnetic material 71, 72, 73 may be used as the free magnetic layer 5 of the element in FIG. 8.

As shown in FIG. 11, a pinned magnetic layer 3(33), a non-magnetic layer 4(34), and a free magnetic layer 5(35) may be arranged on both sides of an antiferromagnetic layer 8. In this element, a laminated ferrimagnetic material 51(71), 52(72), 53(73) is used as the pinned magnetic layer 3(33).

As the substrate 1, a plate with an insulated surface, e.g., a Si substrate obtained by thermal oxidation, a quartz substrate, and a sapphire substrate can be used. Since the substrate surface should be smoother, a smoothing process, e.g., chemomechanical polishing (CMP) may be performed as needed. A switching element such as an MOS transistor may be produced on the substrate surface beforehand. In this case, it is preferable that an insulating layer is formed on the switching element, and then contact holes are provided in the insulating layer to make an electrical connection between the switching element and the magnetoresistive element to be formed on the top.

As the antiferromagnetic layer 8, a Mn-containing antiferromagnetic material or a Cr-containing material can be used. Examples of the Mn-containing antiferromagnetic material include PtMn, PdPtMn, FeMn, IrMn, and NiMn. The element M² may diffuse from these antiferromagnetic materials by heat treatment. Therefore, considering the preferred content (20 at % or less) of the element M² in the vicinity of the interface with the non-magnetic layer, an appropriate distance between the non-magnetic layer and the antiferromagnetic layer (indicated by d in FIG. 4) is 3 nm to 50 nm.

The conventionally known various materials also can be used for other layers of the multi-layer film without any limitation.

For example, a material with conductive or insulating properties can be used as the non-magnetic layer 2 in accordance with the type of the element. A conductive non-magnetic layer used in a CPP-GMR element can be made, e.g., of Cu, Au, Ag, Ru, Cr, and an alloy of these elements. The preferred thickness of the non-magnetic layer in the CPP-GMR element is 1 to 10 nm. The material for a tunnel insulating layer used in a TMR element is not particularly limited as well, and various insulators or semiconductors can be used. An oxide, a nitride, or an oxynitride of Al is suitable for the tunnel insulating layer. The preferred thickness of the non-magnetic layer in the TMR element is 0.8 to 3 nm.

Examples of a material for the non-magnetic film that constitutes the laminated ferrimagnetic material include Cr, Cu, Ag, Au, Ru, Ir, Re, Os, and an alloy and an oxide of theses elements. The preferred thickness of this non-magnetic film is 0.2 to 1.2 nm, though it varies depending on the material.

A method for forming each layer of the multi-layer film is not particularly limited, and a thin film producing method may be employed, e.g., sputtering, molecular beam epitaxy (MBE), chemical vapor deposition (CVD), pulse laser deposition, and ion beam sputtering. As a micro-processing method, well-known micro-processing methods, such as photolithography using a contact mask or stepper, EB lithography and focused ion beam (FIB) processing, may be employed.

For etching, well-known methods, such as ion milling and reactive ion etching (RIE), may be employed.

Even with a conventional magnetoresistive element, the MR characteristics after heat treatment sometimes is improved if the temperature is up to about 300° C. However, the MR characteristics are degraded after heat treatment at 300 to 350° C. or more. A magnetoresistive element of the present invention is superior to the conventional element in characteristics after heat treatment at 330° C. or more. However, such a difference in characteristics between the two elements is even more conspicuous with increasing heat treatment temperatures to 350° C. or more, and 400° C. or more.

Considering that the element is combined with a Si semiconductor process, the heat treatment temperature should be about 400° C. The present invention can provide an element that exhibits practical characteristics even for heat treatment at 400° C.

As described above, the present invention can provide a magnetoresistive element in which the MR characteristics are improved by heat treatment at 330° C. or more and also 350° C. or more, compared with the MR characteristics without heat treatment.

The reason for an improvement in MR characteristics by heat treatment is not clarified fully. However, the heat treatment may improve the barrier characteristics of the non-magnetic layer. This is because favorable MR characteristics can be obtained generally by reducing defects in a barrier or increasing the height of the barrier. Another possible reason is a change in chemical bond at the interfaces between the non-magnetic layer and the ferromagnetic layers. In either case, it is very important to achieve the effect of improving the MR characteristics even after heat treatment at 300° C. or more, considering the application of a magnetoresistive element to a device.

A composition that forms a single phase at heat treatment temperatures is suitable for the composition of the ferromagnetic layer in the vicinity of the interface.

An alloy having the same composition as that at the interfaces was molded by general molding, which then was heat-treated in inert gas at 350° C. to 450° C. for 24 hours. This alloy was cut substantially in half, and then the cutting planes were polished and etched. The state of particles on the surface was observed with a metallurgical microscope and an electron microscope. Moreover, the composition distribution was evaluated by the above composition analysis or EDX. The result confirmed that when a composition showed a nonuniform phase at heat treatment temperatures used, there was a high probability of degradation in MR characteristics after heat treatment for a long time.

A bulk differs from a thin film in phase stability depending on the effect of the interfaces. However, it is preferable that the composition of the ferromagnetic layers in the vicinity of each of the interfaces, specifically the composition given by the above equation, forms a single phase at predetermined heat treatment temperatures of 330° C. or more.

### EXAMPLES

### Example 1-1

A Pt film having a thickness of 100 nm was evaporated on a single-crystal MgO (100) substrate as a lower electrode with MBE, which then was heat-treated in vacuum at 400° C. for 3 hours. The substrate was irradiated with Ar ions at an incidence angle of 10° to 15° by using an ion gun, thus cleaning the surface and decreasing roughness on the surface.

Next, a NiFe film having a thickness of 8 nm was formed on the Pt film with RF magnetron sputtering. Further, an Al film formed with DC magnetron sputtering was oxidized by introducing pure oxygen into a vacuum chamber so as to produce an AlOx barrier. Subsequently, a Fe₅₀Co₅₀ film having a thickness of 10 nm was formed with RF magnetron sputtering. Thus, a laminate of ferromagnetic layer/non-magnetic layer/ferromagnetic layer (NiFe(8)/AlOx(1.2)/Fe₅₀Co₅₀(10)) was formed on the lower electrode. Here, the figures in parentheses denote the film thickness in nm (the film thickness is expressed in the same manner in the following).

With patterning by photolithography and ion milling etching, a plurality of magnetoresistive elements having the same configuration as that shown in FIGS. 1 and 2 were produced. A Cu film was formed as an upper electrode with DC magnetron sputtering, and a SiO₂ film was formed as an interlayer insulating film with ion beam sputtering.

The MR ratio of each of the magnetoresistive elements was measured by measuring a resistance with a DC four-terminal method while applying a magnetic field. The MR ratio was measured after each of the heat treatments at 260° C. for 1 hour, at 300° C. for 1 hour, at 350° C. for 1 hour, and at 400° C. for 1 hour. After measurement of the MR ratio, R1 was measured for each element. Table 1A shows the results.

TABLE 1A

| | | | 3 < | 10 < | |
|---|---|---|---|---|---|
| | R1 | R1 ≦ 3 | R1 ≦ 10 | R1 ≦ 20 | 20 < R1 |
| No heat | MR(%) | 12/13.5 | 11.9/13.2 | 10.5/12.8 | 8.2/— |
| treatment | (average/max) | | | | |
| | Number of | 80 | 12 | 6 | 1 |
| | corresponding | | | | |
| | samples | | | | |
| 260° C. | MR(%) | 14.1/15.2 | 13.8/14.8 | 12.5/13.2 | 8.5/9.2 |
| | (average/max) | | | | |
| | Number of | 82 | 12 | 3 | 3 |
| | corresponding | | | | |
| | samples | | | | |
| 300° C. | MR(%) | 15.8/16.0 | 15.5/15.9 | 14.5/14.9 | 2.1/9.2 |
| | (average/max) | | | | |
| | Number of | 62 | 15 | 9 | 12 |
| | corresponding | | | | |
| | samples | | | | |
| 350° C. | MR(%) | 16.2/16.4 | 15.7/16.0 | 14.5/14.9 | 1.9/5.2 |
| | (average/max) | | | | |
| | Number of | 17 | 14 | 26 | 33 |
| | corresponding | | | | |
| | samples | | | | |
| 400° C. | MR(%) | 16.4/16.6 | 15.9/16.1 | 14.5/14.9 | 1.8/2.3 |
| | (average/max) | | | | |
| | Number of | 3 | 6 | 15 | 51 |
| | corresponding | | | | |
| | samples | | | | |

The total number of samples varies depending on a heat treatment temperature.

### Example 1-2

A plurality of magnetoresistive elements were produced in the same manner as Example 1-1 except that a laminate of a NiFe film having a thickness of 6 nm and a Fe₈₀Pt₂₀ film having a thickness of 2 nm was used instead of the NiFe film. These elements included a laminate expressed by NiFe(6)/Fe₈₀Pt₂₀(2)/AlOx(1.2)/Fe₅₀Co₅₀(10). The MR ratio and R1 were measured for each magnetoresistive element in the same manner as the above. Table 1B shows the results.

TABLE 1B

| | | | 3 < | 10 < | |
|---|---|---|---|---|---|
| | R1 | R1 ≦ 3 | R1 ≦ 10 | R1 ≦ 20 | 20 < R1 |
| No heat | MR(%) | 21.1/25.1 | 20.2/22.7 | 15.2/— | —/— |
| treatment | (average/max) | | | | |
| | Number of | 87 | 12 | 1 | 0 |
| | corresponding | | | | |
| | samples | | | | |
| 260° C. | MR(%) | 23.4/26.3 | 21.9/24.6 | 14.9/15.3 | —/— |
| | (average/max) | | | | |
| | Number of | 87 | 10 | 3 | 0 |
| | corresponding | | | | |
| | samples | | | | |
| 300° C. | MR(%) | 24.6/26.5 | 23.2/25.2 | 14.5/15.1 | 6.8/— |
| | (average/max) | | | | |
| | Number of | 87 | 8 | 2 | 1 |
| | corresponding | | | | |
| | samples | | | | |
| 350° C. | MR(%) | 25.9/26.4 | 24.8/25.3 | 14.7/14.9 | 5.9/— |
| | (average/max) | | | | |
| | Number of | 85 | 5 | 2 | 1 |
| | corresponding | | | | |
| | samples | | | | |
| 400° C. | MR(%) | 26.6/26.9 | 25.1/25.2 | 14.1/14.6 | 6.2/6.6 |
| | (average/max) | | | | |
| | Number of | 80 | 4 | 3 | 2 |
| | corresponding | | | | |
| | samples | | | | |

The total number of samples varies depending on a heat treatment temperature.

### Comparative Example

For comparison, a plurality of magnetoresistive elements were produced in the same manner as Example 1-1 except for the heat treatment of electrodes and the irradiation with an ion gun. The MR ratio and R1 were measured for each magnetoresistive element in the same manner as the above. Table 1C shows the results.

TABLE 1C

| | | | | 10 < | |
|---|---|---|---|---|---|
| | R1 | R1 ≦ 3 | 3 < R1 ≦ 10 | R1 ≦ 20 | 20 < R1 |
| No heat | MR(%) | —/— | 11.8/12.5 | 10.4/12.6 | 8.1/9.1 |
| treatment | (average/max) | | | | |
| | Number of | 0 | 3 | 35 | 62 |
| | corresponding | | | | |
| | samples | | | | |
| 260° C. | MR(%) | —/— | 13.8/14.1 | 12.2/13.2 | 8.3/9.0 |
| | (average/max) | | | | |
| | Number of | 0 | 2 | 25 | 73 |
| | corresponding | | | | |
| | samples | | | | |
| 300° C. | MR(%) | —/— | —/— | 14.1/14.7 | 1.9/7.3 |
| | (average/max) | | | | |
| | Number of | 0 | 0 | 5 | 91 |
| | corresponding | | | | |
| | samples | | | | |
| 350° C. | MR(%) | —/— | —/— | —/— | 1.7/4.8 |
| | (average/max) | | | | |
| | Number of | 0 | 0 | 0 | 89 |
| | corresponding | | | | |
| | samples | | | | |
| 400° C. | MR(%) | —/— | —/— | —/— | 1.2/1.9 |
| | (average/max) | | | | |
| | Number of | 0 | 0 | 0 | 75 |
| | corresponding | | | | |
| | samples | | | | |

The total number of samples varies depending on a heat treatment temperature.

In a conventional method (Table 1C) that did not include the surface treatment of a lower electrode, all values of R1 were more than 20 nm after heat treatment at temperatures in excess of 300° C.

Table 1B shows that the addition of Pt to the magnetic layers in the vicinity of the non-magnetic layer can suppress an increase in R1 caused by heat treatment as compared with Table 1A, in which Pt is not added. Even if R1 is in the same range, the MR ratio can be improved by the addition of Pt.

### Example 1-3

A plurality of magnetoresistive elements were produced in the same manner as Example 1-1 except that a Si substrate obtained by thermal oxidation was used as a substrate, a Cu film having a thickness of 100 nm and a Ta film having a thickness of 5 nm were used as a lower electrode, and NiFe(8)/Co₇₅Fe₂₅(2)/BN(2.0)/Fe₅₀Co₅₀(5) was used as a laminate of ferromagnetic layer/non-magnetic layer/ferromagnetic layer. Both Cu and Ta films were formed with RF magnetron sputtering, the NiFe film was formed with DC magnetron sputtering, the Co₇₅Fe₂₅ film was formed with RF magnetron sputtering, the BN film was formed with reactive evaporation, and the Fe₅₀Co₅₀ film was formed with RF magnetron sputtering.

The MR ratio and R1 were measured for each magnetoresistive element in the same manner as the above. Table 2 shows the results.

TABLE 2

| | | | 3 < | 10 < | |
|---|---|---|---|---|---|
| | R1 | R1 ≦ 3 | R1 ≦ 10 | R1 ≦ 20 | 20 < R1 |
| No heat | MR(%) | 18.1/20.0 | 17.9/19.5 | 15.5/17.8 | 10.2/13.2 |
| treat- | (average/max) | | | | |
| ment | Number of | 67 | 22 | 7 | 4 |
| | corresponding | | | | |
| | samples | | | | |
| 260° C. | MR(%) | 18.2/20.1 | 18.0/19.7 | 16.5/17.9 | 12.1/13.5 |
| | (average/max) | | | | |
| | Number of | 69 | 21 | 5 | 5 |
| | corresponding | | | | |
| | samples | | | | |
| 300° C. | MR(%) | 19.5/20.3 | 19.1/19.9 | 17.5/18.8 | 11.8/13.5 |
| | (average/max) | | | | |
| | Number of | 36 | 36 | 9 | 15 |
| | corresponding | | | | |
| | samples | | | | |
| 350° C. | MR(%) | 19.7/20.5 | 19.2/20.2 | 17.5/18.8 | 5.8/11.8 |
| | (average/max) | | | | |
| | Number of | 15 | 16 | 21 | 36 |
| | corresponding | | | | |
| | samples | | | | |
| 400° C. | MR(%) | 19.9/20.6 | 19.2/20.0 | 16.8/18.5 | 2.8/5.6 |
| | (average/max) | | | | |
| | Number of | 1 | 8 | 13 | 52 |
| | corresponding | | | | |
| | samples | | | | |

The total number of samples varies depending on a heat treatment temperature.

### Example 1-4

A plurality of magnetoresistive elements were produced in the same manner as Example 1-1 except that a Si substrate obtained by thermal oxidation was used as a substrate, a Cu film having a thickness of 200 nm and a TiN film having a thickness of 3 nm were used as a lower electrode, and NiFe(8)/Co₇₅Fe₂₅(2)/AlOx(2.0)/Fe₅₀Co₅₀(5) was used as a laminate of ferromagnetic layer/non-magnetic layer/ferromagnetic layer. The AlOx film was oxidized with plasma oxidation.

The MR ratio and R1 were measured for each magnetoresistive element in the same manner as the above. Table 3 shows the results.

TABLE 3

| | | | 3 < | 10 < | |
|---|---|---|---|---|---|
| | R1 | R1 ≦ 3 | R1 ≦ 10 | R1 ≦ 20 | 20 < R1 |
| No heat | MR(%) | 22.1/24.2 | 21.5/24.1 | 20.1/22.8 | 15.5/17.9 |
| treat- | (average/max) | | | | |
| ment | Number of | 66 | 23 | 6 | 5 |
| | corresponding | | | | |
| | samples | | | | |
| 260° C. | MR(%) | 23.1/24.5 | 22.8/24.3 | 21.8/23.0 | 16.0/17.2 |
| | (average/max) | | | | |
| | Number of | 67 | 20 | 6 | 7 |
| | corresponding | | | | |
| | samples | | | | |
| 300° C. | MR(%) | 24.1/24.7 | 23.5/24.3 | 22.0/22.8 | 12.5/15.1 |
| | (average/max) | | | | |
| | Number of | 31 | 34 | 11 | 18 |
| | corresponding | | | | |
| | samples | | | | |
| 350° C. | MR(%) | 24.3/24.7 | 23.8/24.1 | 21.8/22.2 | 3.2/8.1 |
| | (average/max) | | | | |
| | Number of | 3 | 7 | 14 | 58 |
| | corresponding | | | | |
| | samples | | | | |
| 400° C. | MR(%) | —/— | 23.8/23.9 | 21.6/21.6 | 2.6/3.6 |
| | (average/max) | | | | |
| | Number of | 0 | 2 | 3 | 61 |
| | corresponding | | | | |
| | samples | | | | |

The total number of samples varies depending on a heat treatment temperature.

Basically the same results were obtained in both cases where Co₇₀Fe₃₀, Co₉₀Fe₁₀, Ni₆₀Fe₄₀, sendust, Fe₅₀Co₂₅Ni₂₅, Co₇₀Fe₅Si₁₅B₁₀, or the like was used as the ferromagnetic layers in the form of a single-layer or a multi-layer and where a Al₂O₃ film formed with reactive evaporation, a AlN film formed with plasma reaction, and a film of TaO, TaN or AlN formed with natural oxidation or nitridation was used as the non-magnetic layer.

Basically the same results also were obtained from the magnetoresistive elements having the configurations as shown in FIGS. 4 to 11. For the element that included a plurality of junctions (tunnel junctions) due to the non-magnetic layer, the maximum R1 was used as R1 of the element. In these elements, CrMnPt (thickness: 20 to 30 nm), Tb₂₅Co₇₅ (10 to 20 nm), PtMn (20 to 30 nm), IrMn (10 to 30 nm), or PdPtMn (15 to 30 nm) was used as the antiferromagnetic layer, and Ru (thickness: 0.7 to 0.9 nm), Ir (0.3 to 0.5 nm), or Rh (0.4 to 0.9 nm) was used as the non-magnetic metal film.

### Example 2

Example 1 confirmed that the MR ratio changed with the composition of the magnetic layers in the vicinity of the non-magnetic layer. In this example, the relationship between the composition of the ferromagnetic layer and the MR ratio was measured by using magnetoresistive elements that were produced by the same methods of film forming and processing as those in Example 1.

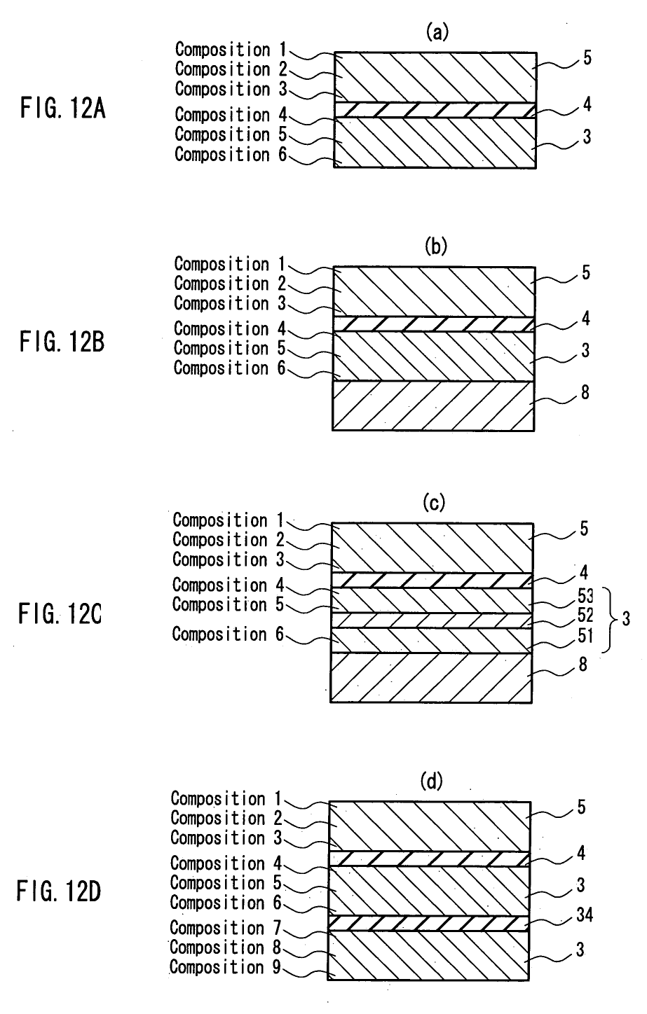

The composition of the ferromagnetic layer was analyzed with Auger electron spectroscopy, SIMS, and XPS. As shown in FIGS. 12A to 12D, the composition was measured in the vicinity and in the middle of the layer. In the vicinity of the interface, the composition in the range of 2 nm from the interface was measured. In the middle of the layer, the composition in the range of 2 nm, which extended in the thickness direction with the middle included, was measured. “Composition 1” to “Composition 9” in FIGS. 12A to 12D correspond to the items in each table below. The configurations of the elements in FIGS. 12A to 12D also correspond to the element types of a) to d) in each table.

An Al₂O₃ film (thickness: 1.0 to 2 nm) was used as the non-magnetic layer. The Al₂O₃ film was produced by forming an Al film with ICP magnetron sputtering and oxidizing the Al film in a chamber filled with a mixed gas of pure oxygen and high purity Ar. A Ru film (0.7 to 0.9 nm) was used as the non-magnetic metal layer, and PdPtMn (15 to 30 nm) was used as the antiferromagnetic layer.

In some magnetoresistive elements, the ferromagnetic layers were formed so that their compositions or composition ratios were changed in the thickness direction. This film formation was performed by adjusting an applied voltage to each of the targets.

TABLE 4a)

| | | Heat | | | | | | | |
|---|---|---|---|---|---|---|---|---|---|
| | | treat- | | | | | | | |
| | | ment | | | | | | | |
| | | tem- | | | | | | | |
| Sam- | | per- | | | | | | | |
| ple | Element | ature | MR | | | | | | |
| No. | type | (° C.) | (%) | Composition 1 | Composition 2 | Composition 3 | Composition 4 | Composition 5 | Composition 6 |
| 1 | a) | r.t. | 22.2 | Co₇₅Fe₂₅ | Co₇₅Fe₂₅ | Co₇₅Fe₂₅ | Co₇₅Fe₂₅ | Ni₈₀Fe₂₀ | Ni₈₀Fe₂₀ |
| | | 260 | 24.5 | | | | | | |
| | | 300 | 24.3 | | | | | | |
| | | 350 | 15.3 | | | | | | |
| | | 400 | 10.1 | | | | | | |
| 2 | a) | r.t. | 22.3 | (Co₇₅Fe₂₅)_{99.8}Pt_{0.2} | (Co₇₅Fe₂₅)_{99.8}Pt_{0.2} | (Co₇₅Fe₂₅)_{99.8}Pt_{0.2} | (Co₇₅Fe₂₅)_{99.8}Pt_{0.2} | Ni₈₀Fe₂₀ | Ni₈₀Fe₂₀ |
| | | 260 | 23.8 | | | | | | |
| | | 300 | 23.2 | | | | | | |
| | | 350 | 14.9 | | | | | | |
| | | 400 | 10.2 | | | | | | |
| 3 | a) | r.t. | 23.1 | (Co₇₅Fe₂₅)_{99.7}Pt_{0.3} | (Co₇₅Fe₂₅)_{99.7}Pt_{0.3} | (Co₇₅Fe₂₅)_{99.7}Pt_{0.3} | (Co₇₅Fe₂₅)_{99.7}Pt_{0.3} | Ni₈₀Fe₂₀ | Ni₈₀Fe₂₀ |
| | | 260 | 24.7 | | | | | | |
| | | 300 | 24.7 | | | | | | |
| | | 350 | 24 | | | | | | |
| | | 400 | 21.1 | | | | | | |
| 4 | a) | r.t. | 24.2 | (Co₇₅Fe₂₅)₉₇Pt₃ | (Co₇₅Fe₂₅)₉₇Pt₃ | (Co₇₅Fe₂₅)₉₇Pt₃ | (Co₇₅Fe₂₅)₉₇Pt₃ | Ni₈₀Fe₂₀ | Ni₈₀Fe₂₀ |
| | | 260 | 25.2 | | | | | | |
| | | 300 | 25.4 | | | | | | |
| | | 350 | 26.3 | | | | | | |
| | | 400 | 25.4 | | | | | | |
| 5 | a) | r.t. | 23.8 | (Co₇₅Fe₂₅)₈₅Pt₁₅ | (Co₇₅Fe₂₅)₈₅Pt₁₅ | (Co₇₅Fe₂₅)₈₅Pt₁₅ | (Co₇₅Fe₂₅)₈₅Pt₁₅ | Ni₈₀Fe₂₀ | Ni₈₀Fe₂₀ |
| | | 260 | 24.9 | | | | | | |
| | | 300 | 25.5 | | | | | | |
| | | 350 | 30.1 | | | | | | |
| | | 400 | 33.2 | | | | | | |
| 6 | a) | r.t. | 23.9 | (Co₇₅Fe₂₅)₇₁Pt₂₉ | (Co₇₅Fe₂₅)₇₁Pt₂₉ | (Co₇₅Fe₂₅)₇₁Pt₂₉ | (Co₇₅Fe₂₅)₇₁Pt₂₉ | Ni₈₀Fe₂₀ | Ni₈₀Fe₂₀ |
| | | 260 | 25.1 | | | | | | |
| | | 300 | 25.3 | | | | | | |
| | | 350 | 25 | | | | | | |
| | | 400 | 24.8 | | | | | | |
| 7 | a) | r.t. | 18.9 | (Co₇₅Fe₂₅)₄₁Pt₅₉ | (Co₇₅Fe₂₅)₄₁Pt₅₉ | (Co₇₅Fe₂₅)₄₁Pt₅₉ | (Co₇₅Fe₂₅)₄₁Pt₅₉ | Ni₈₀Fe₂₀ | Ni₈₀Fe₂₀ |
| | | 260 | 19.4 | | | | | | |
| | | 300 | 20.1 | | | | | | |
| | | 350 | 20.5 | | | | | | |
| | | 400 | 20.2 | | | | | | |
| 8 | a) | r.t. | 12.5 | (Co₇₅Fe₂₅)₃₈Pt₆₂ | (Co₇₅Fe₂₅)₃₈Pt₆₂ | (Co₇₅Fe₂₅)₃₈Pt₆₂ | (Co₇₅Fe₂₅)₃₈Pt₆₂ | Ni₈₀Fe₂₀ | Ni₈₀Fe₂₀ |
| | | 260 | 17.8 | | | | | | |
| | | 300 | 15.3 | | | | | | |
| | | 350 | 12.2 | | | | | | |
| | | 400 | 11.2 | | | | | | |

TABLE 4b)

| | | Heat treatment temperature | MR | | | | | | |
|---|---|---|---|---|---|---|---|---|---|
| Sample No. | Element type | (° C.) | (%) | Composition 1 | Composition 2 | Composition 3 | Composition 4 | Composition 5 | Composition 6 |
| 9 | a) | r.t. | 19.1 | Ni₆₀Fe₄₀ | Ni₆₀Fe₄₀ | Ni₆₀Fe₄₀ | Ni₆₀Fe₄₀ | Ni₈₀Fe₂₀ | Ni₈₀Fe₂₀ |
| | | 260 | 21.2 | | | | | | |
| | | 300 | 22.1 | | | | | | |
| | | 350 | 15.1 | | | | | | |
| | | 400 | 10.2 | | | | | | |
| 10 | a) | r.t. | 18.5 | (Ni₆₀Fe₄₀)_{99.8}Pt_{0.13}Pd_{0.07} | (Ni₆₀Fe₄₀)_{99.8}Pt_{0.13}Pd_{0.07} | (Ni₆₀Fe₄₀)_{99.8}Pt_{0.13}Pd_{0.07} | (Ni₆₀Fe₄₀)_{99.8}Pt_{0.13}Pd_{0.07} | Ni₈₀Fe₂₀ | Ni₈₀Fe₂₀ |
| | | 260 | 19.9 | | | | | | |
| | | 300 | 18.1 | | | | | | |
| | | 350 | 15.8 | | | | | | |
| | | 400 | 11.2 | | | | | | |
| 11 | a) | r.t. | 19.1 | (Ni₆₀Fe₄₀)_{99.7}Pt_{0.2}Pd_{0.1} | (Ni₆₀Fe₄₀)_{99.7}Pt_{0.2}Pd_{0.1} | (Ni₆₀Fe₄₀)_{99.7}Pt_{0.2}Pd_{0.1} | (Ni₆₀Fe₄₀)_{99.7}Pt_{0.2}Pd_{0.1} | Ni₈₀Fe₂₀ | Ni₈₀Fe₂₀ |
| | | 260 | 20.9 | | | | | | |
| | | 300 | 21.1 | | | | | | |
| | | 350 | 19.9 | | | | | | |
| | | 400 | 19.7 | | | | | | |
| 12 | a) | r.t. | 19.8 | (Ni₆₀Fe₄₀)₉₇Pt₂Pd₁ | (Ni₆₀Fe₄₀)₉₇Pt₂Pd₁ | (Ni₆₀Fe₄₀)₉₇Pt₂Pd₁ | (Ni₆₀Fe₄₀)₉₇Pt₂Pd₁ | Ni₈₀Fe₂₀ | Ni₈₀Fe₂₀ |
| | | 260 | 22.1 | | | | | | |
| | | 300 | 22.3 | | | | | | |
| | | 350 | 22.2 | | | | | | |
| | | 400 | 22.1 | | | | | | |
| 13 | a) | r.t. | 18.8 | (Ni₆₀Fe₄₀)₈₅Pt₁₀Pd₅ | (Ni₆₀Fe₄₀)₈₅Pt₁₀Pd₅ | (Ni₆₀Fe₄₀)₈₅Pt₁₀Pd₅ | (Ni₆₀Fe₄₀)₈₅Pt₁₀Pd₅ | Ni₈₀Fe₂₀ | Ni₈₀Fe₂₀ |
| | | 260 | 19.9 | | | | | | |
| | | 300 | 19.8 | | | | | | |
| | | 350 | 26.2 | | | | | | |
| | | 400 | 28.8 | | | | | | |
| 14 | a) | r.t. | 18.7 | (Ni₆₀Fe₄₀)₇₁Pt₁₉Pd₁₀ | (Ni₆₀Fe₄₀)₇₁Pt₁₉Pd₁₀ | (Ni₆₀Fe₄₀)₇₁Pt₁₉Pd₁₀ | (Ni₆₀Fe₄₀)₇₁Pt₁₉Pd₁₀ | Ni₈₀Fe₂₀ | Ni₈₀Fe₂₀ |
| | | 260 | 19.8 | | | | | | |
| | | 300 | 20.1 | | | | | | |
| | | 350 | 22.5 | | | | | | |
| | | 400 | 23.1 | | | | | | |
| 15 | a) | r.t. | 18.7 | (Ni₆₀Fe₄₀)₄₁Pt₃₉Pd₂₀ | (Ni₆₀Fe₄₀)₄₁Pt₃₉Pd₂₀ | (Ni₆₀Fe₄₀)₄₁Pt₃₉Pd₂₀ | (Ni₆₀Fe₄₀)₄₁Pt₃₉Pd₂₀ | Ni₈₀Fe₂₀ | Ni₈₀Fe₂₀ |
| | | 260 | 18.8 | | | | | | |
| | | 300 | 19.1 | | | | | | |
| | | 350 | 19.9 | | | | | | |
| | | 400 | 19.6 | | | | | | |
| 16 | a) | r.t. | 16.4 | (Ni₆₀Fe₄₀)₃₈Pt₄₁Pd₂₁ | (Ni₆₀Fe₄₀)₃₈Pt₄₁Pd₂₁ | (Ni₆₀Fe₄₀)₃₈Pt₄₁Pd₂₁ | (Ni₆₀Fe₄₀)₃₈Pt₄₁Pd₂₁ | Ni₈₀Fe₂₀ | Ni₈₀Fe₂₀ |
| | | 260 | 16.8 | | | | | | |
| | | 300 | 15.9 | | | | | | |
| | | 350 | 12.3 | | | | | | |
| | | 400 | 9.8 | | | | | | |

TABLE 4c)

| | | Heat | | | | | |
|---|---|---|---|---|---|---|---|
| | | treat- | | | | | |
| | | ment | | | | | |
| | | tem- | | | | | |
| Sam- | | per- | | | | | |
| ple | Element | ature | MR | | | | |
| No. | type | (° C.) | (%) | Composition 1 | Composition 2 | Composition 3 | Composition 4 |
| 17 | a) | r.t. | 22.5 | Co₉₀Fe₁₀ | Co₉₀Fe₁₀ | Co₇₅Fe₂₅ | Co₇₅Fe₂₅ |
| | | 260 | 24.5 | | | | |
| | | 300 | 24.1 | | | | |
| | | 350 | 15.2 | | | | |
| | | 400 | 9.9 | | | | |
| 18 | a) | r.t. | 21.8 | Co₉₀Fe₁₀ | Co₉₀Fe₁₀ | (Co₇₅Fe₂₅)_{99.8}Ir_{0.1}Pd_{0.05}Rh_{0.05} | (Co₇₅Fe₂₅)_{99.8}Ir_{0.1}Pd_{0.05}Rh_{0.05} |
| | | 260 | 23.7 | | | | |
| | | 300 | 23.4 | | | | |
| | | 350 | 15.3 | | | | |
| | | 400 | 11.3 | | | | |
| 19 | a) | r.t. | 22.2 | Co₉₀Fe₁₀ | Co₉₀Fe₁₀ | (Co₇₅Fe₂₅)_{99.7}Ir_{0.15}Pd_{0.07}Rh_{0.08} | (Co₇₅Fe₂₅)_{99.7}Ir_{0.15}Pd_{0.07}Rh_{0.08} |
| | | 260 | 24.2 | | | | |
| | | 300 | 24.1 | | | | |
| | | 350 | 23.9 | | | | |
| | | 400 | 23.8 | | | | |
| 20 | a) | r.t. | 20.6 | Co₉₀Fe₁₀ | Co₉₀Fe₁₀ | (Co₇₅Fe₂₅)₉₇Ir_{1.5}Pd_{0.75}Rh_{0.75} | (Co₇₅Fe₂₅)₉₇Ir_{1.5}Pd_{0.75}Rh_{0.75} |
| | | 260 | 22.9 | | | | |
| | | 300 | 23.3 | | | | |
| | | 350 | 24.2 | | | | |
| | | 400 | 24.5 | | | | |
| 21 | a) | r.t. | 20.5 | Co₉₀Fe₁₀ | Co₉₀Fe₁₀ | (Co₇₅Fe₂₅)₈₅Ir_{7.5}Pd_{3.7}Rh_{3.8} | (Co₇₅Fe₂₅)₈₅Ir_{7.5}Pd_{3.7}Rh_{3.8} |
| | | 260 | 21.4 | | | | |
| | | 300 | 22.6 | | | | |
| | | 350 | 26.8 | | | | |
| | | 400 | 27.3 | | | | |
| 22 | a) | r.t. | 20.4 | Co₉₀Fe₁₀ | Co₉₀Fe₁₀ | (Co₇₅Fe₂₅)₇₁Ir_{14.5}Pd_{7.2}Rh_{7.3} | (Co₇₅Fe₂₅)₇₁Ir_{14.5}Pd_{7.2}Rh_{7.3} |
| | | 260 | 21.1 | | | | |
| | | 300 | 22.2 | | | | |
| | | 350 | 25.2 | | | | |
| | | 400 | 25.5 | | | | |
| 23 | a) | r.t. | 15.3 | Co₉₀Fe₁₀ | Co₉₀Fe₁₀ | (Co₇₅Fe₂₅)₄₁Ir_{29.5}Pd_{14.7}Rh_{14.8} | (Co₇₅Fe₂₅)₄₁Ir_{29.5}Pd_{14.7}Rh_{14.8} |
| | | 260 | 20.2 | | | | |
| | | 300 | 21.4 | | | | |
| | | 350 | 23.2 | | | | |
| | | 400 | 23.1 | | | | |
| 24 | a) | r.t. | 15.1 | Co₉₀Fe₁₀ | Co₉₀Fe₁₀ | (Co₇₅Fe₂₅)₃₈Ir₃₁Pd_{15.5}Rh_{15.5} | (Co₇₅Fe₂₅)₃₈Ir₃₁Pd_{15.5}Rh_{15.5} |
| | | 260 | 20.1 | | | | |
| | | 300 | 19.7 | | | | |
| | | 350 | 15.1 | | | | |
| | | 400 | 10.2 | | | | |

| | | Heat | | | |
|---|---|---|---|---|---|
| | | treat- | | | |
| | | ment | | | |
| | | tem- | | | |
| Sam- | | per- | | | |
| ple | Element | ature | MR | | |
| No. | type | (° C.) | (%) | Composition 5 | Composition 6 |
| 17 | a) | r.t. | 22.5 | Co₇₅Fe₂₅ | Co₇₅Fe₂₅ |
| | | 260 | 24.5 | | |
| | | 300 | 24.1 | | |
| | | 350 | 15.2 | | |
| | | 400 | 9.9 | | |
| 18 | a) | r.t. | 21.8 | (Co₇₅Fe₂₅)_{99.8}Ir_{0.1}Pd_{0.05}Rh_{0.05} | (Co₇₅Fe₂₅)_{99.8}Ir_{0.1}Pd_{0.05}Rh_{0.05} |
| | | 260 | 23.7 | | |
| | | 300 | 23.4 | | |
| | | 350 | 15.3 | | |
| | | 400 | 11.3 | | |
| 19 | a) | r.t. | 22.2 | (Co₇₅Fe₂₅)_{99.7}Ir_{0.15}Pd_{0.07}Rh_{0.08} | (Co₇₅Fe₂₅)_{99.7}Ir_{0.15}Pd_{0.07}Rh_{0.08} |
| | | 260 | 24.2 | | |
| | | 300 | 24.1 | | |
| | | 350 | 23.9 | | |
| | | 400 | 23.8 | | |
| 20 | a) | r.t. | 20.6 | (Co₇₅Fe₂₅)₉₇Ir_{1.5}Pd_{0.75}Rh_{0.75} | (Co₇₅Fe₂₅)₉₇Ir_{1.5}Pd_{0.75}Rh_{0.75} |
| | | 260 | 22.9 | | |
| | | 300 | 23.3 | | |
| | | 350 | 24.2 | | |
| | | 400 | 24.5 | | |
| 21 | a) | r.t. | 20.5 | (Co₇₅Fe₂₅)₈₅Ir_{7.5}Pd_{3.7}Rh_{3.8} | (Co₇₅Fe₂₅)₈₅Ir_{7.5}Pd_{3.7}Rh_{3.8} |
| | | 260 | 21.4 | | |
| | | 300 | 22.6 | | |
| | | 350 | 26.8 | | |
| | | 400 | 27.3 | | |
| 22 | a) | r.t. | 20.4 | (Co₇₅Fe₂₅)₇₁Ir_{14.5}Pd_{7.2}Rh_{7.3} | (Co₇₅Fe₂₅)₇₁Ir_{14.5}Pd_{7.2}Rh_{7.3} |
| | | 260 | 21.1 | | |
| | | 300 | 22.2 | | |
| | | 350 | 25.2 | | |
| | | 400 | 25.5 | | |
| 23 | a) | r.t. | 15.3 | (Co₇₅Fe₂₅)₄₁Ir_{29.5}Pd_{14.7}Rh_{14.8} | (Co₇₅Fe₂₅)₄₁Ir_{29.5}Pd_{14.7}Rh_{14.8} |
| | | 260 | 20.2 | | |
| | | 300 | 21.4 | | |
| | | 350 | 23.2 | | |
| | | 400 | 23.1 | | |
| 24 | a) | r.t. | 15.1 | (Co₇₅Fe₂₅)₃₈Ir₃₁Pd_{15.5}Rh_{15.5} | (Co₇₅Fe₂₅)₃₈Ir₃₁Pd_{15.5}Rh_{15.5} |
| | | 260 | 20.1 | | |
| | | 300 | 19.7 | | |
| | | 350 | 15.1 | | |
| | | 400 | 10.2 | | |

TABLE 4d)

| | | Heat | | | | | |
|---|---|---|---|---|---|---|---|
| | | treat- | | | | | |
| | | ment | | | | | |
| | | tem- | | | | | |
| Sam- | | per- | | | | | |
| ple | Element | ature | MR | | | | |
| No. | type | (° C.) | (%) | Composition 1 | Composition 2 | Composition 3 | Composition 4 |
| 25 | b) | r.t. | 22.5 | Ni₈₀Fe₂₀ | Ni₈₀Fe₂₀ | Co₇₅Fe₂₅ | Co₇₅Fe₂₅ |
| | | 260 | 34.2 | | | | |
| | | 300 | 36.1 | | | | |
| | | 350 | 22.2 | | | | |
| | | 400 | 14.8 | | | | |
| 26 | b) | r.t. | 21.8 | Ni₈₀Fe₂₀ | Ni₈₀Fe₂₀ | (Co₇₅Fe₂₅)_{99.8}Pt_{0.2} | (Co₇₅Fe₂₅)_{99.8}Pt_{0.2} |
| | | 260 | 33.8 | | | | |
| | | 300 | 35.5 | | | | |
| | | 350 | 18.9 | | | | |
| | | 400 | 15.1 | | | | |
| 27 | b) | r.t. | 22.2 | Ni₈₀Fe₂₀ | Ni₈₀Fe₂₀ | (Co₇₅Fe₂₅)_{99.7}Pt_{0.3} | (Co₇₅Fe₂₅)_{99.7}Pt_{0.3} |
| | | 260 | 34.1 | | | | |
| | | 300 | 35.7 | | | | |
| | | 350 | 35.5 | | | | |
| | | 400 | 32.2 | | | | |
| 28 | b) | r.t. | 20.6 | Ni₈₀Fe₂₀ | Ni₈₀Fe₂₀ | (Co₇₅Fe₂₅)₉₇Pt₃ | Co₇₅Fe₂₅)₉₇Pt₃ |
| | | 260 | 33.3 | | | | |
| | | 300 | 34.4 | | | | |
| | | 350 | 35 | | | | |
| | | 400 | 34.9 | | | | |
| 29 | b) | r.t. | 20.5 | Ni₈₀Fe₂₀ | Ni₈₀Fe₂₀ | (Co₇₅Fe₂₅)₈₅Pt₁₅ | (Co₇₅Fe₂₅)₈₅Pt₁₅ |
| | | 260 | 33.5 | | | | |
| | | 300 | 35.1 | | | | |
| | | 350 | 36.5 | | | | |
| | | 400 | 41.1 | | | | |
| 30 | b) | r.t. | 20.4 | Ni₈₀Fe₂₀ | Ni₈₀Fe₂₀ | (Co₇₅Fe₂₅)₇₁Pt₂₉ | (Co₇₅Fe₂₅)₇₁Pt₂₉ |
| | | 260 | 33.8 | | | | |
| | | 300 | 34.9 | | | | |
| | | 350 | 36.2 | | | | |
| | | 400 | 36.5 | | | | |
| 31 | b) | r.t. | 15.3 | Ni₈₀Fe₂₀ | Ni₈₀Fe₂₀ | (Co₇₅Fe₂₅)₄₁Pt₅₉ | (Co₇₅Fe₂₅)₄₁Pt₅₉ |
| | | 260 | 29.5 | | | | |
| | | 300 | 31.1 | | | | |
| | | 350 | 33.2 | | | | |
| | | 400 | 30.2 | | | | |
| 32 | b) | r.t. | 12.4 | Ni₈₀Fe₂₀ | Ni₈₀Fe₂₀ | (Co₇₅Fe₂₅)₃₈Pt₆₂ | (Co₇₅Fe₂₅)₃₈Pt₆₂ |
| | | 260 | 15.2 | | | | |
| | | 300 | 16.8 | | | | |
| | | 350 | 14.6 | | | | |
| | | 400 | 12.1 | | | | |

| | | Heat | | | |
|---|---|---|---|---|---|
| | | treat- | | | |
| | | ment | | | |
| | | tem- | | | |
| Sam- | | per- | | | |
| ple | Element | ature | MR | | |
| No. | type | (° C.) | (%) | Composition 5 | Composition 6 |
| 25 | b) | r.t. | 22.5 | Co₇₅Fe₂₅ | Co₇₅Fe₂₅ |
| | | 260 | 34.2 | | |
| | | 300 | 36.1 | | |
| | | 350 | 22.2 | (Co₇₅Fe₂₅)₉₉Mn₁ | (Co₇₅Fe₂₅)₉₅Mn₅ |
| | | 400 | 14.8 | (Co₇₅Fe₂₅)₉₈Mn₂ | (Co₇₅Fe₂₅)₉₀Mn₁₀ |
| 26 | b) | r.t. | 21.8 | (Co₇₅Fe₂₅)_{99.8}Pt_{0.2} | (Co₇₅Fe₂₅)_{99.8}Pt_{0.2} |
| | | 260 | 33.8 | | |
| | | 300 | 35.5 | | |
| | | 350 | 18.9 | (Co₇₅Fe₂₅)_{98.8}Pt_{0.2}Mn₁ | (Co₇₅Fe₂₅)_{94.8}Pt_{0.2}Mn₅ |
| | | 400 | 15.1 | (Co₇₅Fe₂₅)_{97.3}Pt_{0.7}Mn₂ | (Co₇₅Fe₂₅)_{98.8}Pt_{0.2}Mn₁₀ |
| 27 | b) | r.t. | 22.2 | (Co₇₅Fe₂₅)_{99.7}Pt_{0.3} | (Co₇₅Fe₂₅)_{99.7}Pt_{0.3} |
| | | 260 | 34.1 | | |
| | | 300 | 35.7 | | |
| | | 350 | 35.5 | (Co₇₅Fe₂₅)_{98.8}Pt_{0.3}Mn_{0.9} | (Co₇₅Fe₂₅)_{95.7}Pt_{0.3}Mn₄ |
| | | 400 | 32.2 | (Co₇₅Fe₂₅)_{97.9}Pt_{0.3}Mn_{1.8} | (Co₇₅Fe₂₅)_{90.7}Pt_{0.3}Mn₉ |
| 28 | b) | r.t. | 20.6 | (Co₇₅Fe₂₅)₉₇Pt₃ | (Co₇₅Fe₂₅)₉₇Pt₃ |
| | | 260 | 33.3 | | |
| | | 300 | 34.4 | | |
| | | 350 | 35 | (Co₇₅Fe₂₅)_{96.2}Pt₃Mn_{0.8} | (Co₇₅Fe₂₅)_{93.1}Pt_{2.9}Mn₄ |
| | | 400 | 34.9 | (Co₇₅Fe₂₅)_{95.4}Pt₃Mn_{1.6} | (Co₇₅Fe₂₅)_{89.2}Pt_{2.8}Mn₈ |
| 29 | b) | r.t. | 20.5 | (Co₇₅Fe₂₅)₈₅Pt₁₅ | (Co₇₅Fe₂₅)₈₅Pt₁₅ |
| | | 260 | 33.5 | | |
| | | 300 | 35.1 | | |
| | | 350 | 36.5 | (Co₇₅Fe₂₅)_{84.6}Pt_{14.9}Mn_{0.5} | (Co₇₅Fe₂₅)_{83.3}Pt_{14.7}Mn₂ |
| | | 400 | 41.1 | (Co₇₅Fe₂₅)_{84.2}Pt_{14.8}Mn₁ | (Co₇₅Fe₂₅)_{81.6}Pt_{14.4}Mn₄ |
| 30 | b) | r.t. | 20.4 | (Co₇₅Fe₂₅)₇₁Pt₂₉ | (Co₇₅Fe₂₅)₇₁Pt₂₉ |
| | | 260 | 33.8 | | |
| | | 300 | 34.9 | | |
| | | 350 | 36.2 | (Co₇₅Fe₂₅)_{70.6}Pt_{28.9}Mn_{0.5} | (Co₇₅Fe₂₅)_{69.6}Pt_{28.4}Mn₂ |
| | | 400 | 36.5 | (Co₇₅Fe₂₅)_{70.3}Pt_{28.7}Mn₁ | (Co₇₅Fe₂₅)_{68.2}Pt_{27.8}Mn₄ |
| 31 | b) | r.t. | 15.3 | (Co₇₅Fe₂₅)₄₁Pt₅₉ | (Co₇₅Fe₂₅)₄₁Pt₅₉ |
| | | 260 | 29.5 | | |
| | | 300 | 31.1 | | |
| | | 350 | 33.2 | (Co₇₅Fe₂₅)_{40.8}Pt_{58.7}Mn_{0.5} | (Co₇₅Fe₂₅)_{40.2}Pt_{57.8}Mn₂ |
| | | 400 | 30.2 | (Co₇₅Fe₂₅)_{40.6}Pt_{58.4}Mn₁ | (Co₇₅Fe₂₅)_{39.4}Pt_{56.6}Mn₄ |
| 32 | b) | r.t. | 12.4 | (Co₇₅Fe₂₅)₃₈Pt₆₂ | (Co₇₅Fe₂₅)₃₈Pt₆₂ |
| | | 260 | 15.2 | | |
| | | 300 | 16.8 | | |
| | | 350 | 14.6 | (Co₇₅Fe₂₅)_{37.8}Pt_{61.7}Mn_{0.5} | (Co₇₅Fe₂₅)_{37.2}Pt_{60.8}Mn₂ |
| | | 400 | 12.1 | (Co₇₅Fe₂₅)_{37.6}Pt_{61.4}Mn₁ | (Co₇₅Fe₂₅)_{36.5}Pt_{59.5}Mn₄ |

The samples 1 to 8 in Table 4a) indicate that the addition of 0.3 to 60 at % Pt improves the MR characteristics after heat treatment at 300° C. or more as compared with the sample that does not include Pt. In particular, the MR characteristics after heat treatment at 300° C. or more tend to be improved by adding Pt in an amount of about 3 to 30 at %. The same tendency can be confirmed in each of the cases where Co₇₅Fe₂₅ in Table 4a) is replaced by Co₉₀Fe₁₀, Co₅₀Fe₅₀, Ni₆₀Fe₄₀ or Fe₅₀Co₂₅Ni₂₅, where Ni₈₀Fe₂₀ is replaced by sendust or Co₉₀Fe₁₀, and where Pt is replaced by Re, Ru, Os, Rh, Ir, Pd or Au.

The samples 9 to 16 in Table 4b) indicate that the addition of Pt and Pd with a ratio of 2:1 in a total amount of 0.3 to 60 at %, particularly 3 to 30 at %, improves the MR characteristics after heat treatment at 300° C. or more as compared with the sample that does not include Pt and Pd.

The same tendency can be obtained when the ratio of the elements added is changed from 2:1 to 10:1, 6:1, 3:1, 1:1, 1:2, 1:3, 1:6, or 1:10. Moreover, the same tendency can be obtained by replacing Pt of (Pt, Pd) with Tc, Re, Ru, Rh, Cu or Ag and replacing Pd with Os, Ir or Au, i.e., a total of 28 combinations of the elements including (Pt, Pd). Further, the same tendency can be obtained in both cases where Ni₆₀Fe₄₀ is replaced by Co₇₅Fe₂₅ or Fe₅₀Co₂₅Ni₂₅ and where Ni₈₀Fe₂₀ is replaced by sendust or Co₉₀Fe₁₀.

The samples 17 to 24 in Table 4c) indicate that the addition of Ir, Pd and Rh with a ratio of 2:1:1 also improves the MR characteristics, like Tables 4a) and 4b). The same tendency can be confirmed when Ir is set to 1 and the contents of Pd and Rh are each changed in the range of 0.01 to 100. Moreover, the same tendency can be obtained in both cases where Co₉₀Fe₁₀ is replaced by Ni₈₀Fe₂₀, Ni₆₅Fe₂₅Co₁₀ or Co₆₀Fe₂₀Ni₂₀ and where Co₇₅Fe₂₅ is replaced by Co₅₀Fe₅₀, Fe₆₀Ni₄₀ or Fe₅₀Ni₅₀.

Further, the same tendency can be obtained by using the following combinations of the elements instead of (Ir, Pd, Rh): (Tc, Re, Ag), (Ru, Os, Ir), (Rh, Ir, Pt), (Pd, Pt, Cu), (Cu, Ag, Au), (Re, Ru, Os), (Ru, Rh, Pd), (Ir, Pt, Cu), and (Re, Ir, Ag).

The samples 25 to 32 in Table 4d) have the same tendency as that in Tables 4a) to 4c). Some samples show that Mn is diffused from the antiferromagnetic layer after heat treatment. However, the Mn diffusion can be suppressed by adding Pt. This indicates that the addition of Pt makes it possible to control the concentration of Mn at the interfaces of the non-magnetic layer. The same tendency can be obtained by replacing Pt with Tc, Ru, Os, Rh, Ir, Pd, Cu or Ag. Moreover, the same tendency can be obtained by modifying the ferromagnetic layers to the above compositions.

TABLE 5a)

| | | | MR | | | | | | |
|---|---|---|---|---|---|---|---|---|---|
| Sample No. | Element type | Heat treatment temperature (° C.) | (%) | Composition 1 | Composition 2 | Composition 3 | Composition 4 | Composition 5 | Composition 6 |
| 33 | b) | r.t. | 22.9 | Co₉₀Fe₁₀ | Co₉₀Fe₁₀ | Co₉₀Fe₁₀ | Co₇₅Fe₂₅ | Co₇₅Fe₂₅ | Co₇₅Fe₂₅ |
| | | 260 | 34.1 | | | | | | |
| | | 300 | 34.3 | | | | | | |
| | | 350 | 23.5 | | | | | (Co₇₅Fe₂₅)₉₉Mn₁ | (Co₇₅Fe₂₅)₉₅Mn₅ |
| | | 400 | 10.4 | | | | | (Co₇₅Fe₂₅)₉₈Mn₂ | (Co₇₅Fe₂₅)₉₀Mn₁₀ |
| 34 | b) | r.t. | 22.8 | Co₉₀Fe₁₀ | (Co₉₀Fe₁₀)_{99.9}Re_{0.1} | (Co₉₀Fe₁₀)_{99.8}Re_{0.2} | (Co₇₅Fe₂₅)_{99.8}Re_{0.2} | (Co₇₅Fe₂₅)_{99.9}Re_{0.1} | Co₇₅Fe₂₅ |
| | | 260 | 34.3 | | | | | | |
| | | 300 | 34.7 | | | | | | |
| | | 350 | 23.4 | | | | | (Co₇₅Fe₂₅)₉₉Re_{0.1}Mn_{0.9} | (Co₇₅Fe₂₅)₉₅Mn₅ |
| | | 400 | 11.8 | | | | | (Co₇₅Fe₂₅)_{98.1}Re_{0.1}Mn_{1.8} | (Co₇₅Fe₂₅)₉₀Mn₁₀ |
| 35 | b) | r.t. | 21.9 | Co₉₀Fe₁₀ | (Co₉₀Fe₁₀)_{99.85}Re_{0.15} | (Co₉₀Fe₁₀)_{99.7}Re_{0.3} | (Co₇₅Fe₂₅)_{99.7}Re_{0.3} | (Co₇₅Fe₂₅)_{99.85}Re_{0.15} | Co₇₅Fe₂₅ |
| | | 260 | 33.6 | | | | | | |
| | | 300 | 34.5 | | | | | | |
| | | 350 | 35.1 | | | | | (Co₇₅Fe₂₅)_{99.06}Re_{0.15}Mn_{0.8} | (Co₇₅Fe₂₅)₉₅Mn₅ |
| | | 400 | 33.6 | | | | | (Co₇₅Fe₂₅)_{98.25}Re_{0.15}Mn_{1.6} | (Co₇₅Fe₂₅)₉₀Mn₁₀ |
| 36 | b) | r.t. | 20.5 | Co₉₀Fe₁₀ | (Co₉₀Fe₁₀)_{98.5}Re_{1.5} | (Co₉₀Fe₁₀)₉₇Re₃ | (Co₇₅Fe₂₅)₉₇Re₃ | (Co₇₅Fe₂₅)_{98.5}Re_{1.5} | Co₇₅Fe₂₅ |
| | | 260 | 32.7 | | | | | | |
| | | 300 | 33.9 | | | | | | |
| | | 350 | 35.2 | | | | | (Co₇₅Fe₂₅)_{97.8}Re_{0.15}Mn_{0.7} | (Co₇₅Fe₂₅)₉₅Mn₅ |
| | | 400 | 35.3 | | | | | (Co₇₅Fe₂₅)_{97.1}Re_{1.5}Mn_{1.4} | (Co₇₅Fe₂₅)₉₀Mn₁₀ |
| 37 | b) | r.t. | 20.1 | Co₉₀Fe₁₀ | (Co₉₀Fe₁₀)_{92.5}Re_{7.5} | (Co₉₀Fe₁₀)₈₅Re₁₅ | (Co₇₅Fe₂₅)₈₅Re₁₅ | (Co₇₅Fe₂₅)_{92.5}Re_{7.5} | Co₇₅Fe₂₅ |
| | | 260 | 30.7 | | | | | | |
| | | 300 | 33.4 | | | | | | |
| | | 350 | 35.3 | | | | | (Co₇₅Fe₂₅)₉₂Re_{7.5}Mn_{0.5} | (Co₇₅Fe₂₅)₉₅Mn₅ |
| | | 400 | 37.6 | | | | | (Co₇₅Fe₂₅)_{91.6}Re_{7.4}Mn₁ | (Co₇₅Fe₂₅)₉₀Mn₁₀ |
| 38 | b) | r.t. | 22.4 | Co₉₀Fe₁₀ | (Co₉₀Fe₁₀)_{85.5}Re_{14.5} | (Co₉₀Fe₁₀)₇₁Re₂₉ | (Co₇₅Fe₂₅)₇₁Re₂₉ | (Co₇₅Fe₂₅)_{85.5}Re_{14.5} | Co₇₅Fe₂₅ |
| | | 260 | 32.9 | | | | | | |
| | | 300 | 34.3 | | | | | | |
| | | 350 | 35.1 | | | | | (Co₇₅Fe₂₅)_{85.1}Re_{14.4}Mn_{0.5} | (Co₇₅Fe₂₅)₉₅Mn₅ |
| | | 400 | 35.1 | | | | | (Co₇₅Fe₂₅)_{84.6}Re_{14.4}Mn₁ | (Co₇₅Fe₂₅)₉₀Mn₁₀ |
| 39 | b) | r.t. | 18.3 | Co₉₀Fe₁₀ | (Co₉₀Fe₁₀)_{70.5}Re_{29.5} | (Co₉₀Fe₁₀)₄₁Re₅₉ | (Co₇₅Fe₂₅)₄₁Re₅₉ | (Co₇₅Fe₂₅)_{70.5}Re_{29.5} | Co₇₅Fe₂₅ |
| | | 260 | 31.2 | | | | | | |
| | | 300 | 32.6 | | | | | | |
| | | 350 | 33 | | | | | (Co₇₅Fe₂₅)_{70.1}Re_{29.4}Mn_{0.5} | (Co₇₅Fe₂₅)₉₅Mn₅ |
| | | 400 | 32.5 | | | | | (Co₇₅Fe₂₅)_{69.8}Re_{29.2}Mn₁ | (Co₇₅Fe₂₅)₉₀Mn₁₀ |
| 40 | b) | r.t. | 13.8 | Co₉₀Fe₁₀ | (Co₉₀Fe₁₀)₆₉Re₃₁ | (Co₉₀Fe₁₀)₃₈Re₆₂ | (Co₇₅Fe₂₅)₃₈Re₆₂ | (Co₇₅Fe₂₅)₆₉Re₃₁ | Co₇₅Fe₂₅ |
| | | 260 | 24.9 | | | | | | |
| | | 300 | 26.2 | | | | | | |
| | | 350 | 15.4 | | | | | (Co₇₅Fe₂₅)_{68.7}Re_{30.8}Mn_{0.5} | (Co₇₅Fe₂₅)₉₅Mn₅ |
| | | 400 | 9.7 | | | | | (Co₇₅Fe₂₅)_{68.3}Re_{30.7}Mn₁ | (Co₇₅Fe₂₅)₉₀Mn₁₀ |

TABLE 5b)

| Sample No. | Element type | Heat treatment temperature (° C.) | MR (%) | Composition 1 | Composition 2 | Composition 3 | Composition 4 | Composition 5 | Composition 6 |
|---|---|---|---|---|---|---|---|---|---|
| 41 | c) | r.t. | 18 | Ni₈₀Fe₂₀ | Ni₈₀Fe₂₀ | Ni₆₀Fe₄₀ | Ni₆₀Fe₄₀ | Co₇₀Fe₃₀ | Co |
| | | 260 | 37.8 | | | | | | |
| | | 300 | 40.3 | | | | | | |
| | | 350 | 24.6 | | | | | | |
| | | 400 | 12.2 | | | | | | |
| 42 | c) | r.t. | 16.8 | Ni₈₀Fe₂₀ | (Ni₈₀Fe₂₀)_{99.9}Ru_{0.1} | (Ni₆₀Fe₄₀)_{99.8}Ru_{0.2} | (Ni₆₀Fe₄₀)_{99.8}Os_{0.2} | (Co₇₀Fe₃₀)_{99.8}Os_{0.2} | Co_{99.8}Os_{0.2} |
| | | 260 | 36.5 | | | | | | |
| | | 300 | 37.7 | | | | | | |
| | | 350 | 25.4 | | | | | (Co₇₀Fe₃₀)₉₉Os_{0.2}Mn_{0.8} | Co_{95.8}Os_{0.2}Mn₄ |
| | | 400 | 12.9 | | | | | (Co₇₀Fe₃₀)₉₈Os_{0.2}Mn_{1.8} | Co_{90.8}Os_{0.2}Mn₉ |
| 43 | c) | r.t. | 16.5 | Ni₈₀Fe₂₀ | (Ni₈₀Fe₂₀)_{99.85}Ru_{0.15} | (Ni₆₀Fe₄₀)_{99.7}Ru_{0.3} | (Ni₆₀Fe₄₀)_{99.7}Os_{0.3} | (Co₇₀Fe₃₀)_{99.7}Os_{0.3} | Co_{99.7}Os_{0.3} |
| | | 260 | 36.4 | | | | | | |
| | | 300 | 38.1 | | | | | | |
| | | 350 | 35.9 | | | | | (Co₇₀Fe₃₀)_{98.9}Os_{0.3}Mn_{0.8} | Co_{95.7}Os_{0.3}Mn₄ |
| | | 400 | 30.5 | | | | | (Co₇₀Fe₃₀)_{97.9}Os_{0.3}Mn_{1.8} | Co_{90.7}Os_{0.3}Mn₉ |
| 44 | c) | r.t. | 16.3 | Ni₈₀Fe₂₀ | (Ni₈₀Fe₂₀)_{98.5}Ru_{1.5} | (Ni₆₀Fe₄₀)₉₇Ru₃ | (Ni₆₀Fe₄₀)₉₇Os₃ | (Co₇₀Fe₃₀)₉₇Os₃ | Co₉₇Os₃ |
| | | 260 | 35.1 | | | | | | |
| | | 300 | 35.9 | | | | | | |
| | | 350 | 38.2 | | | | | (Co₇₀Fe₃₀)_{96.3}Os₃Mn_{0.7} | Co_{93.3}Os_{2.9}Mn_{3.8} |
| | | 400 | 37.9 | | | | | (Co₇₀Fe₃₀)_{95.4}Os_{2.9}Mn_{1.7} | Co_{88.5}Os_{2.7}Mn_{8.8} |
| 45 | c) | r.t. | 15.5 | Ni₈₀Fe₂₀ | (Ni₈₀Fe₂₀)_{92.5}Ru_{7.5} | (Ni₆₀Fe₄₀)₈₅Ru_{1.5} | (Ni₆₀Fe₄₀)₈₅Os₁₅ | (Co₇₀Fe₃₀)₈₅Os₁₅ | Co₈₅Os₁₅ |
| | | 260 | 30.6 | | | | | | |
| | | 300 | 32.3 | | | | | | |
| | | 350 | 35.4 | | | | | (Co₇₀Fe₃₀)_{84.6}Os_{14.9}Mn_{0.5} | Co_{81.9}Os_{14.5}Mn_{3.6} |
| | | 400 | 38.3 | | | | | (Co₇₀Fe₃₀)_{83.9}Os_{14.8}Mn_{1.3} | Co_{77.9}Os_{13.7}Mn_{8.4} |
| 46 | c) | r.t. | 17.6 | Ni₈₀Fe₂₀ | (Ni₈₀Fe₂₀)_{85.5}Ru_{14.5} | (Ni₆₀Fe₄₀)₇₁Ru₂₉ | (Ni₆₀Fe₄₀)₇₁Os₂₉ | (Co₇₀Fe₃₀)₇₁Os₂₉ | Co₇₁Os₂₉ |
| | | 260 | 32 | | | | | | |
| | | 300 | 33.1 | | | | | | |
| | | 350 | 34.3 | | | | | (Co₇₀Fe₃₀)_{70.6}Os_{28.9}Mn_{0.5} | Co_{68.4}Os₂₈Mn_{3.6} |
| | | 400 | 35.1 | | | | | (Co₇₀Fe₃₀)_{70.1}Os_{28.6}Mn_{1.3} | Co₆₅Os_{26.6}Mn_{8.4} |
| 47 | c) | r.t. | 11.7 | Ni₈₀Fe₂₀ | (Ni₈₀Fe₂₀)_{70.5}Ru_{29.5} | (Ni₆₀Fe₄₀)₄₁Ru₅₉ | (Ni₆₀Fe₄₀)₄₁Os₅₉ | (Co₇₀Fe₃₀)₄₁Os₅₉ | Co₄₁Os₅₉ |
| | | 260 | 30.3 | | | | | | |
| | | 300 | 32.4 | | | | | | |
| | | 350 | 32.2 | | | | | (Co₇₀Fe₃₀)_{40.8}Os_{58.7}Mn_{0.5} | Co_{39.5}Os_{56.9}Mn_{3.6} |
| | | 400 | 30.8 | | | | | (Co₇₀Fe₃₀)_{40.5}Os_{58.2}Mn_{1.3} | Co_{37.6}Os₅₄Mn_{8.4} |
| 48 | c) | r.t. | 9.5 | Ni₈₀Fe₂₀ | (Ni₈₀Fe₂₀)₆₉Ru₃₁ | (Ni₆₀Fe₄₀)₃₈Ru₆₂ | (Ni₆₀Fe₄₀)₃₈Os₆₂ | (Co₇₀Fe₃₀)₃₈Os₆₂ | Co₃₈Os₆₂ |
| | | 260 | 15.2 | | | | | | |
| | | 300 | 18.1 | | | | | | |
| | | 350 | 15.6 | | | | | (Co₇₀Fe₃₀)_{37.8}Os_{61.7}Mn_{0.5} | Co_{36.6}Os_{59.8}Mn_{3.6} |
| | | 400 | 11.7 | | | | | (Co₇₀Fe₃₀)_{37.5}Os_{61.2}Mn_{1.3} | Co_{34.8}Os_{56.8}Mn_{8.4} |

TABLE 5c)

| Sample No. | Element type | Heat treatment temperature (° C.) | MR (%) | Composition 1 | Composition 2 | Composition 3 | Composition 4 | Composition 5 | Composition 6 |
|---|---|---|---|---|---|---|---|---|---|
| 49 | c) | r.t. | 21.7 | Co₉₀Fe₁₀ | Co₉₀Fe₁₀ | Co₉₀Fe₁₀ | Co₇₅Fe₂₅ | Co₇₅Fe₂₅ | Co₉₀Fe₁₀ |
| | | 260 | 36.3 | | | | | | |
| | | 300 | 38.1 | | | | | | |
| | | 350 | 24.5 | | | | | (Co₇₅Fe₂₅)₉₉Mn₁ | (Co₇₅Fe₂₅)₉₅Mn₅ |
| | | 400 | 11.6 | | | | | (Co₇₅Fe₂₅)₉₈Mn₂ | Co₇₅Fe₂₅)₉₀Mn₁₀ |
| 50 | c) | r.t. | 22.2 | Co₉₀Fe₁₀ | Co₉₀Fe₁₀ | Co₉₀Fe₁₀ | (Co₇₅Fe₂₅)_{99.8}Pt_{0.1}Cu_{0.1} | (Co₇₅Fe₂₅)_{99.8}Pt_{0.1}Cu_{0.1} | (Co₇₅Fe₂₅)_{99.8}Pt_{0.1}Cu_{0.1} |
| | | 260 | 35.4 | | | | | | |
| | | 300 | 36.8 | | | | | | |
| | | 350 | 22.3 | | | | | (Co₇₅Fe₂₅)_{98.8}Pt_{0.1}Cu_{0.1}Mn₁ | (Co₇₅Fe₂₅)_{94.8}Pt_{0.1}Cu_{0.1}Mn₅ |
| | | 400 | 13.2 | | | | | (Co₇₅Fe₂₅)_{97.8}Pt_{0.1}Cu_{0.1}Mn₂ | (Co₇₅Fe₂₅)_{89.8}Pt_{0.1}Cu_{0.1}Mn₁₀ |
| 51 | c) | r.t. | 21.9 | Co₉₀Fe₁₀ | Co₉₀Fe₁₀ | Co₉₀Fe₁₀ | (Co₇₅Fe₂₅)_{99.7}Pt_{0.15}Cu_{0.15} | (Co₇₅Fe₂₅)_{99.7}Pt_{0.15}Cu_{0.15} | (Co₇₅Fe₂₅)_{99.7}Pt_{0.15}Cu_{0.15} |
| | | 260 | 35.1 | | | | | | |
| | | 300 | 36.6 | | | | | | |
| | | 350 | 35.4 | | | | | (Co₇₅Fe₂₅)_{98.8}Pt_{0.15}Cu_{0.15}Mn_{0.9} | (Co₇₅Fe₂₅)_{94.9}Pt_{0.15}Cu_{0.15}Mn_{4.8} |
| | | 400 | 33.8 | | | | | (Co₇₅Fe₂₅)_{97.9}Pt_{0.15}Cu_{0.15}Mn_{1.8} | (Co₇₅Fe₂₅)_{90.1}Pt_{0.15}Cu_{0.15}Mn_{9.6} |
| 52 | c) | r.t. | 20.2 | Co₉₀Fe₁₀ | Co₉₀Fe₁₀ | Co₉₀Fe₁₀ | (Co₇₅Fe₂₅)₉₇Pt_{1.5}Cu_{1.5} | (Co₇₅Fe₂₅)₉₇Pt_{1.5}Cu_{1.5} | (Co₇₅Fe₂₅)₉₇Pt_{1.5}Cu_{1.5} |
| | | 260 | 32.8 | | | | | | |
| | | 300 | 35.3 | | | | | | |
| | | 350 | 37.7 | | | | | (Co₇₅Fe₂₅)_{96.2}Pt_{1.5}Cu_{1.5}Mn_{0.8} | (Co₇₅Fe₂₅)_{92.5}Pt_{1.5}Cu_{1.4}Mn_{4.6} |
| | | 400 | 38.1 | | | | | (Co₇₅Fe₂₅)_{95.4}Pt_{1.5}Cu_{1.5}Mn_{1.6} | (Co₇₅Fe₂₅)_{88.1}Pt_{1.4}Cu_{1.3}Mn_{9.2} |
| 53 | c) | r.t. | 19 | Co₉₀Fe₁₀ | Co₉₀Fe₁₀ | Co₉₀Fe₁₀ | (Co₇₅Fe₂₅)₈₅Pt_{7.5}Cu_{7.5} | (Co₇₅Fe₂₅)₈₅Pt_{7.5}Cu_{7.5} | (Co₇₅Fe₂₅)₈₅Pt_{7.5}Cu_{7.5} |
| | | 260 | 31.6 | | | | | | |
| | | 300 | 34.5 | | | | | | |
| | | 350 | 38.9 | | | | | (Co₇₅Fe₂₅)_{84.5}Pt_{7.5}Cu_{7.5}Mn_{0.5} | (Co₇₅Fe₂₅)_{81.6}Pt_{7.2}Cu_{7.2}Mn₄ |
| | | 400 | 41.3 | | | | | (Co₇₅Fe₂₅)_{84.2}Pt_{7.4}Cu_{7.4}Mn₁ | (Co₇₅Fe₂₅)_{78.2}Pt_{6.9}Cu_{6.9}Mn₈ |
| 54 | c) | r.t. | 15.8 | Co₉₀Fe₁₀ | Co₉₀Fe₁₀ | Co₉₀Fe₁₀ | (Co₇₅Fe₂₅)₇₁Pt_{14.5}Cu_{14.5} | (Co₇₅Fe₂₅)₇₁Pt_{14.5}Cu_{14.5} | (Co₇₅Fe₂₅)₇₁Pt_{14.5}Cu_{14.5} |
| | | 260 | 31.2 | | | | | | |
| | | 300 | 32.7 | | | | | | |
| | | 350 | 37.1 | | | | | (Co₇₅Fe₂₅)_{70.7}Pt_{14.4}Cu_{14.4}Mn_{0.5} | (Co₇₅Fe₂₅)_{68.2}Pt_{13.9}Cu_{13.9}Mn₄ |
| | | 400 | 36.8 | | | | | (Co₇₅Fe₂₅)_{70.2}Pt_{14.4}Cu_{14.4}Mn₁ | (Co₇₅Fe₂₅)_{65.4}Pt_{13.3}Cu_{13.3}Mn₈ |
| 55 | c) | r.t. | 15.4 | Co₉₀Fe₁₀ | Co₉₀Fe₁₀ | Co₉₀Fe₁₀ | (Co₇₅Fe₂₅)₄₁Pt_{29.5}Cu_{29.5} | (Co₇₅Fe₂₅)₄₁Pt_{29.5}Cu_{29.5} | (Co₇₅Fe₂₅)₄₁Pt_{29.5}Cu_{29.5} |
| | | 260 | 31 | | | | | | |
| | | 300 | 32.6 | | | | | | |
| | | 350 | 35.1 | | | | | (Co₇₅Fe₂₅)_{40.8}Pt_{29.4}Cu_{29.3}Mn_{0.5} | (Co₇₅Fe₂₅)_{68.2}Pt_{13.9}Cu_{13.9}Mn₄ |
| | | 400 | 33.8 | | | | | (Co₇₅Fe₂₅)_{40.6}Pt_{29.2}Cu_{29.2}Mn₁ | (Co₇₅Fe₂₅)_{37.7}Pt_{27.2}Cu_{27.1}Mn₈ |
| 56 | c) | r.t. | 11.8 | Co₉₀Fe₁₀ | Co₉₀Fe₁₀ | Co₉₀Fe₁₀ | (Co₇₅Fe₂₅)₃₈Pt₃₁Cu₃₁ | (Co₇₅Fe₂₅)₃₈Pt₃₁Cu₃₁ | (Co₇₅Fe₂₅)₃₈Pt₃₁Cu₃₁ |
| | | 260 | 24.9 | | | | | | |
| | | 300 | 24.7 | | | | | | |
| | | 350 | 14.9 | | | | | (Co₇₅Fe₂₅)_{37.9}Pt_{30.8}Cu_{30.8}Mn_{0.5} | (Co₇₅Fe₂₅)_{36.4}Pt_{29.8}Cu_{29.8}Mn₄ |
| | | 400 | 10.5 | | | | | (Co₇₅Fe₂₅)_{37.6}Pt_{30.7}Cu_{30.7}Mn₁ | (Co₇₅Fe₂₅)₃₅Pt_{28.5}Cu_{28.5}Mn₈ |

TABLE 5d)

| | | Heat | | | | | | | |
|---|---|---|---|---|---|---|---|---|---|
| Sam- | | treatment | | | | | | | |
| ple | Element | temperature | MR | Compo- | Compo- | | | | |
| No. | type | (° C.) | (%) | sition 1 | sition 2 | Composition 3 | Composition 4 | Composition 5 | Composition 6 |
| 57 | c) | r.t. | 12.7 | Ni₈₀Fe₂₀ | Ni₈₀Fe₂₀ | Fe | Fe | Co₇₅Fe₂₅ | Co₇₅Fe₂₅ |
| | | 260 | 28.4 | | | | | | |
| | | 300 | 29.3 | | | | | | |
| | | 350 | 18.9 | | | | | (Co₇₅Fe₂₅)₉₉Mn₁ | (Co₇₅Fe₂₅)₉₉Mn₅ |
| | | 400 | 15.1 | | | | Fe_{99.8}Mn_{0.2} | (Co₇₅Fe₂₅)₉₈Mn₂ | (Co₇₅Fe₂₅)₉₀Mn₁₀ |
| 58 | c) | r.t. | 12.7 | Ni₈₀Fe₂₀ | Ni₈₀Fe₂₀ | Fe_{99.8}Pt_{0.2} | Fe_{99.8}Pt_{0.2} | Co₇₅Fe₂₅ | Co₇₅Fe₂₅ |
| | | 260 | 28.2 | | | | | | |
| | | 300 | 29.7 | | | | | | |
| | | 350 | 19.3 | | | | | (Co₇₅Fe₂₅)₉₉Mn₁ | (Co₇₅Fe₂₅)₉₅Mn₅ |
| | | 400 | 15.4 | | | | Fe_{99.6}Pt_{0.2}Mn_{0.2} | (Co₇₅Fe₂₅)₉₈Mn₂ | (Co₇₅Fe₂₅)₉₀Mn₁₀ |
| 59 | c) | r.t. | 12.5 | Ni₈₀Fe₂₀ | Ni₈₀Fe₂₀ | Fe_{99.7}Pt_{0.3} | Fe_{99.7}Pt_{0.3} | Co₇₅Fe₂₅ | Co₇₅Fe₂₅ |
| | | 260 | 27.1 | | | | | | |
| | | 300 | 29.4 | | | | | | |
| | | 350 | 27.2 | | | | | (Co₇₅Fe₂₅)₉₉Mn₁ | (Co₇₅Fe₂₅)₉₅Mn₅ |
| | | 400 | 29 | | | | Fe_{99.55}Pt_{0.3}Mn_{0.15} | (Co₇₅Fe₂₅)₉₈Mn₂ | (Co₇₅Fe₂₅)₉₀Mn₁₀ |
| 60 | c) | r.t. | 12.3 | Ni₈₀Fe₂₀ | Ni₈₀Fe₂₀ | Fe₉₇Pt₃ | Fe₉₇Pt₃ | Co₇₅Fe₂₅ | Co₇₅Fe₂₅ |
| | | 260 | 26.5 | | | | | | |
| | | 300 | 26.8 | | | | | | |
| | | 350 | 28.7 | | | | | (Co₇₅Fe₂₅)₉₉Mn₁ | (Co₇₅Fe₂₅)₉₅Mn₅ |
| | | 400 | 30 | | | | Fe_{96.9}Pt₃Mn_{0.1} | (Co₇₅Fe₂₅)₉₈Mn₂ | (Co₇₅Fe₂₅)₉₀Mn₁₀ |
| 61 | c) | r.t. | 12.4 | Ni₈₀Fe₂₀ | Ni₈₀Fe₂₀ | Fe₈₅Pt₁₅ | Fe₈₅Pt₁₅ | Co₇₅Fe₂₅ | Co₇₅Fe₂₅ |
| | | 260 | 23.9 | | | | | | |
| | | 300 | 25.1 | | | | | | |
| | | 350 | 30.4 | | | | | (Co₇₅Fe₂₅)₉₉Mn₁ | (Co₇₅Fe₂₅)₉₅Mn₅ |
| | | 400 | 37 | | | | | (Co₇₅Fe₂₅)₉₈Mn₂ | (Co₇₅Fe₂₅)₉₀Mn₁₀ |
| 62 | c) | r.t. | 11.9 | Ni₈₀Fe₂₀ | Ni₈₀Fe₂₀ | Fe₇₁Pt₂₉ | Fe₇₁Pt₂₉ | Co₇₅Fe₂₅ | Co₇₅Fe₂₅ |
| | | 260 | 25.1 | | | | | | |
| | | 300 | 27.8 | | | | | | |
| | | 350 | 29.1 | | | | | (Co₇₅Fe₂₅)₉₉Mn₁ | (Co₇₅Fe₂₅)₉₅Mn₅ |
| | | 400 | 33.4 | | | | | (Co₇₅Fe₂₅)₉₈Mn₂ | (Co₇₅Fe₂₅)₉₀Mn₁₀ |
| 63 | c) | r.t. | 11.5 | Ni₈₀Fe₂₀ | Ni₈₀Fe₂₀ | Fe₄₁Pt₅₉ | Fe₄₁Pt₅₉ | Co₇₅Fe₂₅ | Co₇₅Fe₂₅ |
| | | 260 | 24.9 | | | | | | |
| | | 300 | 27.4 | | | | | | |
| | | 350 | 27.6 | | | | | (Co₇₅Fe₂₅)₉₉Mn₁ | (Co₇₅Fe₂₅)₉₅Mn₅ |
| | | 400 | 29.4 | | | | | (Co₇₅Fe₂₅)₉₈Mn₂ | (Co₇₅Fe₂₅)₉₀Mn₁₀ |
| 64 | c) | r.t. | 10.3 | Ni₈₀Fe₂₀ | Ni₈₀Fe₂₀ | Fe₃₈Pt₆₂ | Fe₃₈Pt₆₂ | Co₇₅Fe₂₅ | Co₇₅Fe₂₅ |
| | | 260 | 21 | | | | | | |
| | | 300 | 22.1 | | | | | | |
| | | 350 | 18.5 | | | | | (Co₇₅Fe₂₅)₉₉Mn₁ | (Co₇₅Fe₂₅)₉₅Mn₅ |
| | | 400 | 15.9 | | | | | (Co₇₅Fe₂₅)₉₈Mn₂ | (Co₇₅Fe₂₅)₉₀Mn₁₀ |

TABLE 6a)

| Sample No. | Element type | Heat treatment temperature (° C.) | MR (%) | Composition 1 | Composition 2 | Composition 3 | Composition 4 | Composition 5 | Composition 6 |
|---|---|---|---|---|---|---|---|---|---|
| 65 | c) | r.t. | 12.6 | (Ni₈₀Fe₂₀)_{99.8}Mn_{0.2} | (Ni₈₀Fe₂₀)_{99.8}Mn_{0.2} | Fe_{99.8}Mn_{0.2} | Fe_{99.8}Mn_{0.2} | (Co₇₅Fe₂₅)_{99.8}Mn_{0.2} | (Co₇₅Fe₂₅)_{99.8}Mn_{0.2} |
| | | 260 | 28.5 | | | | | | |
| | | 300 | 29.1 | | | | | | |
| | | 350 | 18.9 | | | | | (Co₇₅Fe₂₅)_{98.8}Mn_{1.2} | (Co₇₅Fe₂₅)_{94.8}Mn_{5.2} |
| | | 400 | 15.1 | | | | Fe_{99.6}Mn_{0.4} | (Co₇₅Fe₂₅)_{97.8}Mn_{2.2} | (Co₇₅Fe₂₅)_{89.8}Mn_{10.2} |
| 66 | c) | r.t. | 12.8 | (Ni₈₀Fe₂₀)_{99.8}Mn_{0.2} | (Ni₈₀Fe₂₀)_{99.8}Mn_{0.2} | Fe_{99.6}Pt_{0.2}Mn_{0.2} | Fe_{99.6}Pt_{0.2}Mn_{0.2} | (Co₇₅Fe₂₅)_{99.8}Mn_{0.2} | (Co₇₅Fe₂₅)_{99.8}Mn_{0.2} |
| | | 260 | 28.4 | | | | | | |
| | | 300 | 29.1 | | | | | | |
| | | 350 | 19.5 | | | | | (Co₇₅Fe₂₅)_{98.8}Mn_{1.2} | (Co₇₅Fe₂₅)_{94.8}Mn_{5.2} |
| | | 400 | 15.6 | | | | Fe_{99.4}Pt_{0.2}Mn_{0.4} | (Co₇₅Fe₂₅)_{97.8}Mn_{2.2} | (Co₇₅Fe₂₅)_{89.8}Mn_{10.2} |
| 67 | c) | r.t. | 12.7 | (Ni₈₀Fe₂₀)_{99.8}Mn_{0.2} | (Ni₈₀Fe₂₀)_{99.8}Mn_{0.2} | Fe_{99.5}Pt_{0.3}Mn_{0.2} | Fe_{99.5}Pt_{0.3}Mn_{0.2} | (Co₇₅Fe₂₅)_{99.8}Mn_{0.2} | (Co₇₅Fe₂₅)_{99.8}Mn_{0.2} |
| | | 260 | 27.4 | | | | | | |
| | | 300 | 30.1 | | | | | | |
| | | 350 | 29.5 | | | | | (Co₇₅Fe₂₅)_{98.8}Mn_{1.2} | (Co₇₅Fe₂₅)_{94.8}Mn_{5.2} |
| | | 400 | 33.4 | | | | Fe_{99.35}Pt_{0.3}Mn_{0.35} | (Co₇₅Fe₂₅)_{97.8}Mn_{2.2} | (Co₇₅Fe₂₅)_{89.8}Mn_{10.2} |
| 68 | c) | r.t. | 12.5 | (Ni₈₀Fe₂₀)_{99.8}Mn_{0.2} | (Ni₈₀Fe₂₀)_{99.8}Mn_{0.2} | Fe₉₇Pt_{2.8}Mn_{0.2} | Fe₉₇Pt_{2.8}Mn_{0.2} | (Co₇₅Fe₂₅)_{99.8}Mn_{0.2} | (Co₇₅Fe₂₅)_{99.8}Mn_{0.2} |
| | | 260 | 27 | | | | | | |
| | | 300 | 28.9 | | | | | | |
| | | 350 | 33.6 | | | | | (Co₇₅Fe₂₅)_{98.8}Mn_{1.2} | (Co₇₅Fe₂₅)_{94.8}Mn_{5.2} |
| | | 400 | 36.7 | | | | Fe_{96.9}Pt_{2.8}Mn_{0.3} | (Co₇₅Fe₂₅)_{97.8}Mn_{2.2} | (Co₇₅Fe₂₅)_{89.8}Mn_{10.2} |
| 69 | c) | r.t. | 12.1 | (Ni₈₀Fe₂₀)_{99.8}Mn_{0.2} | (Ni₈₀Fe₂₀)_{99.8}Mn_{0.2} | Fe₈₅Pt₁₄₈Mn_{0.2} | Fe₈₅Pt₁₄₈Mn_{0.2} | (Co₇₅Fe₂₅)_{99.8}Mn_{0.2} | (Co₇₅Fe₂₅)_{99.8}Mn_{0.2} |
| | | 260 | 25.3 | | | | | | |
| | | 300 | 29.9 | | | | | | |
| | | 350 | 34.2 | | | | | (Co₇₅Fe₂₅)_{98.8}Mn_{1.2} | (Co₇₅Fe₂₅)_{94.8}Mn_{5.2} |
| | | 400 | 39.6 | | | | | (Co₇₅Fe₂₅)_{97.8}Mn_{2.2} | (Co₇₅Fe₂₅)_{89.8}Mn_{10.2} |
| 70 | c) | r.t. | 11.8 | (Ni₈₀Fe₂₀)_{99.8}Mn_{0.2} | (Ni₈₀Fe₂₀)_{99.8}Mn_{0.2} | Fe₇₁Pt_{28.8}Mn_{0.2} | Fe₇₁Pt_{28.8}Mn_{0.2} | (Co₇₅Fe₂₅)_{99.8}Mn_{0.2} | (Co₇₅Fe₂₅)_{99.8}Mn_{0.2} |
| | | 260 | 25.3 | | | | | | |
| | | 300 | 27.4 | | | | | | |
| | | 350 | 31.8 | | | | | (Co₇₅Fe₂₅)_{98.8}Mn_{1.2} | (Co₇₅Fe₂₅)_{94.8}Mn_{5.2} |
| | | 400 | 37.9 | | | | | (Co₇₅Fe₂₅)_{97.8}Mn_{2.2} | (Co₇₅Fe₂₅)_{89.8}Mn_{10.2} |
| 71 | c) | r.t. | 11.4 | (Ni₈₀Fe₂₀)_{99.8}Mn_{0.2} | (Ni₈₀Fe₂₀)_{99.8}Mn_{0.2} | Fe₄₁Pt_{58.8}Mn_{0.2} | Fe₄₁Pt_{58.8}Mn_{0.2} | (Co₇₅Fe₂₅)_{99.8}Mn_{0.2} | (Co₇₅Fe₂₅)_{99.8}Mn_{0.2} |
| | | 260 | 25.1 | | | | | | |
| | | 300 | 27.1 | | | | | | |
| | | 350 | 28.5 | | | | | (Co₇₅Fe₂₅)_{98.8}Mn_{1.2} | (Co₇₅Fe₂₅)_{94.8}Mn_{5.2} |
| | | 400 | 34.2 | | | | | (Co₇₅Fe₂₅)_{97.8}Mn_{2.2} | (Co₇₅Fe₂₅)_{89.8}Mn_{10.2} |
| 72 | c) | r.t. | 10.5 | (Ni₈₀Fe₂₀)_{99.8}Mn_{0.2} | (Ni₈₀Fe₂₀)_{99.8}Mn_{0.2} | Fe₃₈Pt_{61.8}Mn_{0.2} | Fe₃₈Pt_{61.8}Mn_{0.2} | (Co₇₅Fe₂₅)_{99.8}Mn_{0.2} | (Co₇₅Fe₂₅)_{99.8}Mn_{0.2} |
| | | 260 | 20.5 | | | | | | |
| | | 300 | 22.3 | | | | | | |
| | | 350 | 18.7 | | | | | (Co₇₅Fe₂₅)_{98.8}Mn_{1.2} | (Co₇₅Fe₂₅)_{94.8}Mn_{5.2} |
| | | 400 | 16 | | | | | (Co₇₅Fe₂₅)_{97.8}Mn_{2.2} | (Co₇₅Fe₂₅)_{89.8}Mn_{10.2} |

TABLE 6b)

| Sample No. | Element type | Heat treatment temperature (° C.) | MR (%) | Composition 1 | Composition 2 | Composition 3 | Composition 4 | Composition 5 | Composition 6 |
|---|---|---|---|---|---|---|---|---|---|
| 73 | c) | r.t. | 12.8 | (Ni₈₀Fe₂₀)_{99.5}Mn_{0.5} | (Ni₈₀Fe₂₀)_{99.5}Mn_{0.5} | Fe_{99.5}Mn_{0.5} | Fe_{99.5}Mn_{0.5} | (Co₇₅Fe₂₅)_{99.5}Mn_{0.5} | (Co₇₅Fe₂₅)_{99.5}Mn_{0.5} |
| | | 260 | 28.6 | | | | | | |
| | | 300 | 28.9 | | | | | | |
| | | 350 | 19.5 | | | | | (Co₇₅Fe₂₅)_{98.5}Mn_{1.5} | (Co₇₅Fe₂₅)_{94.5}Mn_{5.5} |
| | | 400 | 15.6 | | | | Fe_{99.3}Mn_{0.7} | (Co₇₅Fe₂₅)_{97.5}Mn_{2.5} | (Co₇₅Fe₂₅)_{98.5}Mn_{10.4} |
| 74 | c) | r.t. | 12.7 | (Ni₈₀Fe₂₀)_{99.5}Mn_{0.5} | (Ni₈₀Fe₂₀)_{99.5}Mn_{0.5} | Fe_{99.3}Pt_{0.2}Mn_{0.5} | Fe_{99.3}Pt_{0.2}Mn_{0.5} | (Co₇₅Fe₂₅)_{99.5}Mn_{0.5} | (Co₇₅Fe₂₅)_{99.5}Mn_{0.5} |
| | | 260 | 28.6 | | | | | | |
| | | 300 | 29.5 | | | | | | |
| | | 350 | 19.7 | | | | | (Co₇₅Fe₂₅)_{98.5}Mn_{1.5} | (Co₇₅Fe₂₅)_{94.5}Mn_{5.5} |
| | | 400 | 15.7 | | | | Fe_{99.1}Pt_{0.2}Mn_{0.7} | (Co₇₅Fe₂₅)_{97.5}Mn_{2.5} | (Co₇₅Fe₂₅)_{89.6}Mn_{10.4} |
| 75 | c) | r.t. | 12.4 | (Ni₈₀Fe₂₀)_{99.5}Mn_{0.5} | (Ni₈₀Fe₂₀)_{99.5}Mn_{0.5} | Fe_{99.2}Pt_{0.3}Mn_{0.5} | Fe_{99.2}Pt_{0.3}Mn_{0.5} | (Co₇₅Fe₂₅)_{99.5}Mn_{0.5} | (Co₇₅Fe₂₅)_{99.5}Mn_{0.5} |
| | | 260 | 27.1 | | | | | | |
| | | 300 | 29.9 | | | | | | |
| | | 350 | 28.4 | | | | | (Co₇₅Fe₂₅)_{98.5}Mn_{1.5} | (Co₇₅Fe₂₅)_{94.5}Mn_{5.5} |
| | | 400 | 30.8 | | | | Fe₉₉Pt_{0.3}Mn_{0.7} | (Co₇₅Fe₂₅)_{97.5}Mn_{2.5} | (Co₇₅Fe₂₅)_{89.6}Mn_{10.4} |
| 76 | c) | r.t. | 12.8 | (Ni₈₀Fe₂₀)_{99.5}Mn_{0.5} | (Ni₈₀Fe₂₀)_{99.5}Mn_{0.5} | Fe₉₇Pt_{2.5}Mn_{0.5} | Fe₉₇Pt_{2.5}Mn_{0.5} | (Co₇₅Fe₂₅)_{99.5}Mn_{0.5} | (Co₇₅Fe₂₅)_{99.5}Mn_{0.5} |
| | | 260 | 27.6 | | | | | | |
| | | 300 | 29.4 | | | | | | |
| | | 350 | 34.4 | | | | | (Co₇₅Fe₂₅)_{98.5}Mn_{1.5} | (Co₇₅Fe₂₅)_{94.5}Mn_{5.5} |
| | | 400 | 37.7 | | | | Fe_{96.85}Pt_{2.5}Mn_{0.65} | (Co₇₅Fe₂₅)_{97.5}Mn_{2.5} | (Co₇₅Fe₂₅)_{89.6}Mn_{10.4} |
| 77 | c) | r.t. | 13.1 | (Ni₈₀Fe₂₀)_{99.5}Mn_{0.5} | (Ni₈₀Fe₂₀)_{99.5}Mn_{0.5} | Fe₈₅Pt_{14.5}Mn_{0.5} | Fe₈₅Pt_{14.5}Mn_{0.5} | (Co₇₅Fe₂₅)_{99.5}Mn_{0.5} | (Co₇₅Fe₂₅)_{99.5}Mn_{0.5} |
| | | 260 | 26.7 | | | | | | |
| | | 300 | 31.2 | | | | | | |
| | | 350 | 38.4 | | | | | (Co₇₅Fe₂₅)_{98.5}Mn_{1.5} | (Co₇₅Fe₂₅)_{94.5}Mn_{5.5} |
| | | 400 | 42.4 | | | | Fe_{84.9}Pt_{14.5}Mn_{0.6} | (Co₇₅Fe₂₅)_{97.5}Mn_{2.5} | (Co₇₅Fe₂₅)_{89.6}Mn_{10.4} |
| 78 | c) | r.t. | 12.1 | (Ni₈₀Fe₂₀)_{99.5}Mn_{0.5} | (Ni₈₀Fe₂₀)_{99.5}Mn_{0.5} | Fe₇₁Pt_{28.5}Mn_{0.5} | Fe₇₁Pt_{28.5}Mn_{0.5} | (Co₇₅Fe₂₅)_{99.5}Mn_{0.5} | (Co₇₅Fe₂₅)_{99.5}Mn_{0.5} |
| | | 260 | 25.5 | | | | | | |
| | | 300 | 27.1 | | | | | | |
| | | 350 | 37 | | | | | (Co₇₅Fe₂₅)_{98.5}Mn_{1.5} | (Co₇₅Fe₂₅)_{94.5}Mn_{5.5} |
| | | 400 | 42.1 | | | | | (Co₇₅Fe₂₅)_{97.5}Mn_{2.5} | (Co₇₅Fe₂₅)_{89.8}Mn_{10.4} |
| 79 | c) | r.t. | 11.6 | (Ni₈₀Fe₂₀)_{99.5}Mn_{0.5} | (Ni₈₀Fe₂₀)_{99.5}Mn_{0.5} | Fe₄₁Pt_{58.5}Mn_{0.5} | Fe₄₁Pt_{58.5}Mn_{0.5} | (Co₇₅Fe₂₅)_{99.5}Mn_{0.5} | (Co₇₅Fe₂₅)_{99.5}Mn_{0.5} |
| | | 260 | 24.9 | | | | | | |
| | | 300 | 26.8 | | | | | | |
| | | 350 | 33.8 | | | | | (Co₇₅Fe₂₅)_{98.5}Mn_{1.5} | (Co₇₅Fe₂₅)_{94.5}Mn_{5.5} |
| | | 400 | 39 | | | | | (Co₇₅Fe₂₅)_{97.5}Mn_{2.5} | (Co₇₅Fe₂₅)_{89.6}Mn_{10.4} |
| 80 | c) | r.t. | 10.4 | (Ni₈₀Fe₂₀)_{99.5}Mn_{0.5} | (Ni₈₀Fe₂₀)_{99.5}Mn_{0.5} | Fe₃₈Pt_{61.5}Mn_{0.5} | Fe₃₈Pt_{61.5}Mn_{0.5} | (Co₇₅Fe₂₅)_{99.5}Mn_{0.5} | (Co₇₅Fe₂₅)_{99.5}Mn_{0.5} |
| | | 260 | 19.9 | | | | | | |
| | | 300 | 22.5 | | | | | | |
| | | 350 | 19.5 | | | | | (Co₇₅Fe₂₅)_{98.5}Mn_{1.5} | (Co₇₅Fe₂₅)_{94.5}Mn_{5.5} |
| | | 400 | 16.5 | | | | | (Co₇₅Fe₂₅)_{97.5}Mn_{2.5} | (Co₇₅Fe₂₅)_{89.6}Mn_{10.4} |

TABLE 6c)

| | | Heat | | | | | | | |
|---|---|---|---|---|---|---|---|---|---|
| Sam- | Ele- | treatment | | | | | | | |
| ple | ment | tempera- | MR | | | | | | |
| No. | type | ture (° C.) | (%) | Composition 1 | Composition 2 | Composition 3 | Composition 4 | Composition 5 | Composition 6 |
| 81 | c) | r.t. | 12.7 | (Ni₈₀Fe₂₀)₉₉Mn₁ | (Ni₈₀Fe₂₀)₉₉Mn₁ | Fe₉₉Mn₁ | Fe₉₉Mn₁ | (Co₇₅Fe₂₅)₉₉Mn₁ | (Co₇₅Fe₂₅)₉₉Mn₁ |
| | | 260 | 28.4 | | | | | | |
| | | 300 | 28.6 | | | | | | |
| | | 350 | 18.9 | | | | | (Co₇₅Fe₂₅)₉₈Mn₂ | (Co₇₅Fe₂₅)_{94.1}Mn_{5.9} |
| | | 400 | 15.1 | | | | Fe_{99.8}Mn_{1.2} | (Co₇₅Fe₂₅)₉₇Mn₃ | (Co₇₅Fe₂₅)_{89.1}Mn_{10.9} |
| 82 | c) | r.t. | 12.5 | (Ni₈₀Fe₂₀)₉₉Mn₁ | (Ni₈₀Fe₂₀)₉₉Mn₁ | Fe_{98.8}Pt_{0.2}Mn₁ | Fe_{98.8}Pt_{0.2}Mn₁ | (Co₇₅Fe₂₅)₉₉Mn₁ | (Co₇₅Fe₂₅)₉₉Mn₁ |
| | | 260 | 28.3 | | | | | | |
| | | 300 | 29.6 | | | | | | |
| | | 350 | 19.09 | | | | | (Co₇₅Fe₂₅)₉₈Mn₂ | (Co₇₅Fe₂₅)_{94.1}Mn_{5.9} |
| | | 400 | 15.3 | | | | Fe_{98.6}Pt_{0.2}Mn_{1.2} | (Co₇₅Fe₂₅)₉₇Mn₃ | (Co₇₅Fe₂₅)_{89.1}Mn_{10.9} |
| 83 | c) | r.t. | 12.1 | (Ni₈₀Fe₂₀)₉₉Mn₁ | (Ni₈₀Fe₂₀)₉₉Mn₁ | Fe_{98.7}Pt_{0.3}Mn₁ | Fe_{98.7}Pt_{0.3}Mn₁ | (Co₇₅Fe₂₅)₉₉Mn₁ | (Co₇₅Fe₂₅)₉₉Mn₁ |
| | | 260 | 26.9 | | | | | | |
| | | 300 | 29.5 | | | | | | |
| | | 350 | 27.4 | | | | | (Co₇₅Fe₂₅)₉₈Mn₂ | (Co₇₅Fe₂₅)_{94.1}Mn_{5.9} |
| | | 400 | 28.8 | | | | Fe_{98.5}Pt_{0.3}Mn_{1.2} | (Co₇₅Fe₂₅)₉₇Mn₃ | (Co₇₅Fe₂₅)_{89.1}Mn_{10.9} |
| 84 | c) | r.t. | 12.5 | (Ni₈₀Fe₂₀)₉₉Mn₁ | (Ni₈₀Fe₂₀)₉₉Mn₁ | Fe₉₇Pt₂Mn₁ | Fe₉₇Pt₂Mn₁ | (Co₇₅Fe₂₅)₉₉Mn₁ | (Co₇₅Fe₂₅)₉₉Mn₁ |
| | | 260 | 27.4 | | | | | | |
| | | 300 | 29.6 | | | | | | |
| | | 350 | 33.3 | | | | | (Co₇₅Fe₂₅)₉₈Mn₂ | (Co₇₅Fe₂₅)_{94.1}Mn_{5.9} |
| | | 400 | 36.2 | | | | Fe_{96.85}Pt₂Mn_{1.15} | (Co₇₅Fe₂₅)₉₇Mn₃ | (Co₇₅Fe₂₅)_{89.1}Mn_{10.9} |
| 85 | c) | r.t. | 13.3 | (Ni₈₀Fe₂₀)₉₉Mn₁ | (Ni₈₀Fe₂₀)₉₉Mn₁ | Fe₈₅Pt₁₄Mn₁ | Fe₈₅Pt₁₄Mn₁ | (Co₇₅Fe₂₅)₉₉Mn₁ | (Co₇₅Fe₂₅)₉₉Mn₁ |
| | | 260 | 26.8 | | | | | | |
| | | 300 | 31.5 | | | | | | |
| | | 350 | 39.1 | | | | | (Co₇₅Fe₂₅)₉₈Mn₂ | (Co₇₅Fe₂₅)_{94.1}Mn_{5.9} |
| | | 400 | 43.8 | | | | Fe_{84.9}Pt₁₄Mn_{1.1} | (Co₇₅Fe₂₅)₉₇Mn₃ | (Co₇₅Fe₂₅)_{89.1}Mn_{10.9} |
| 86 | c) | r.t. | 12.1 | (Ni₈₀Fe₂₀)₉₉Mn₁ | (Ni₈₀Fe₂₀)₉₉Mn₁ | Fe₇₁Pt₂₈Mn₁ | Fe₇₁Pt₂₈Mn₁ | (Co₇₅Fe₂₅)₉₉Mn₁ | (Co₇₅Fe₂₅)₉₉Mn₁ |
| | | 260 | 25.6 | | | | | | |
| | | 300 | 27 | | | | | | |
| | | 350 | 37 | | | | | (Co₇₅Fe₂₅)₉₈Mn₂ | (Co₇₅Fe₂₅)_{94.1}Mn_{5.9} |
| | | 400 | 42.4 | | | | | (Co₇₅Fe₂₅)₉₇Mn₃ | (Co₇₅Fe₂₅)_{89.1}Mn_{10.9} |
| 87 | c) | r.t. | 11.7 | (Ni₈₀Fe₂₀)₉₉Mn₁ | (Ni₈₀Fe₂₀)₉₉Mn₁ | Fe₄₁Pt₅₈Mn₁ | Fe₄₁Pt₅₈Mn₁ | (Co₇₅Fe₂₅)₉₉Mn₁ | (Co₇₅Fe₂₅)₉₉Mn₁ |
| | | 260 | 25.1 | | | | | | |
| | | 300 | 26.9 | | | | | | |
| | | 350 | 34.8 | | | | | (Co₇₅Fe₂₅)₉₈Mn₂ | (Co₇₅Fe₂₅)_{94.1}Mn_{5.9} |
| | | 400 | 39.4 | | | | | (Co₇₅Fe₂₅)₉₇Mn₃ | (Co₇₅Fe₂₅)_{89.1}Mn_{10.9} |
| 88 | c) | r.t. | 10.5 | (Ni₈₀Fe₂₀)₉₉Mn₁ | (Ni₈₀Fe₂₀)₉₉Mn₁ | Fe₃₈Pt₆₁Mn₁ | Fe₃₈Pt₆₁Mn₁ | (Co₇₅Fe₂₅)₉₉Mn₁ | (Co₇₅Fe₂₅)₉₉Mn₁ |
| | | 260 | 19.8 | | | | | | |
| | | 300 | 22.6 | | | | | | |
| | | 350 | 19.7 | | | | | (Co₇₅Fe₂₅)₉₈Mn₂ | (Co₇₅Fe₂₅)_{94.1}Mn_{5.9} |
| | | 400 | 16.6 | | | | | (Co₇₅Fe₂₅)₉₇Mn₃ | (Co₇₅Fe₂₅)_{89.1}Mn_{10.9} |

TABLE 6d)

| | | Heat | | | | | | | |
|---|---|---|---|---|---|---|---|---|---|
| | | treatment | | | | | | | |
| Sam- | Ele- | temper- | | | | | | | |
| ple | ment | ature | MR | | | | | | |
| No. | type | (° C.) | (%) | Composition 1 | Composition 2 | Composition 3 | Composition 4 | Composition 5 | Composition 6 |
| 89 | c) | r.t. | 12.5 | (Ni₈₀Fe₂₀)₉₈Mn₂ | (Ni₈₀Fe₂₀)₉₈Mn₂ | Fe₉₈Mn₂ | Fe₉₈Mn₂ | (Co₇₅Fe₂₅)₉₈Mn₂ | (Co₇₅Fe₂₅)₉₈Mn₂ |
| | | 260 | 28.2 | | | | | | |
| | | 300 | 28.3 | | | | | | |
| | | 350 | 18.7 | | | | | (Co₇₅Fe₂₅)₉₇Mn₃ | (Co₇₅Fe₂₅)_{93.1}Mn_{6.9} |
| | | 400 | 14.9 | | | | Fe_{97.8}Mn_{2.2} | (Co₇₅Fe₂₅)₉₆Mn₄ | (Co₇₅Fe₂₅)_{88.2}Mn_{11.8} |
| 90 | c) | r.t. | 12.4 | (Ni₈₀Fe₂₀)₉₈Mn₂ | (Ni₈₀Fe₂₀)₉₈Mn₂ | Fe_{97.8}Pt_{0.2}Mn₂ | Fe_{97.8}Pt_{0.2}Mn₂ | (Co₇₅Fe₂₅)₉₈Mn₂ | (Co₇₅Fe₂₅)₉₈Mn₂ |
| | | 260 | 28.1 | | | | | | |
| | | 300 | 29.1 | | | | | | |
| | | 350 | 18.9 | | | | | (Co₇₅Fe₂₅)₉₇Mn₃ | (Co₇₅Fe₂₅)_{93.1}Mn_{6.9} |
| | | 400 | 15.1 | | | | Fe_{97.6}Pt_{0.2}Mn_{2.2} | (Co₇₅Fe₂₅)₉₆Mn₄ | (Co₇₅Fe₂₅)_{88.2}Mn_{11.8} |
| 91 | c) | r.t. | 11.9 | (Ni₈₀Fe₂₀)₉₈Mn₂ | (Ni₈₀Fe₂₀)₉₈Mn₂ | Fe_{97.7}Pt_{0.3}Mn₂ | Fe_{97.7}Pt_{0.3}Mn₂ | (Co₇₅Fe₂₅)₉₈Mn₂ | (Co₇₅Fe₂₅)₉₈Mn₂ |
| | | 260 | 26.6 | | | | | | |
| | | 300 | 29.1 | | | | | | |
| | | 350 | 27 | | | | | (Co₇₅Fe₂₅)₉₇Mn₃ | (Co₇₅Fe₂₅)_{93.1}Mn_{6.9} |
| | | 400 | 28.4 | | | | Fe_{97.55}Pt_{0.3}Mn_{2.15} | (Co₇₅Fe₂₅)₉₆Mn₄ | (Co₇₅Fe₂₅)_{88.2}Mn_{11.8} |
| 92 | c) | r.t. | 12.6 | (Ni₈₀Fe₂₀)₉₈Mn₂ | (Ni₈₀Fe₂₀)₉₈Mn₂ | Fe₉₆Pt₂Mn₂ | Fe₉₆Pt₂Mn₂ | (Co₇₅Fe₂₅)₉₈Mn₂ | (Co₇₅Fe₂₅)₉₈Mn₂ |
| | | 260 | 27.7 | | | | | | |
| | | 300 | 30.2 | | | | | | |
| | | 350 | 32.9 | | | | | (Co₇₅Fe₂₅)₉₇Mn₃ | (Co₇₅Fe₂₅)_{93.1}Mn_{6.9} |
| | | 400 | 35.8 | | | | Fe_{95.9}Pt₂Mn_{2.1} | (Co₇₅Fe₂₅)₉₆Mn₄ | (Co₇₅Fe₂₅)_{88.2}Mn_{11.8} |
| 93 | c) | r.t. | 13.5 | (Ni₈₀Fe₂₀)₉₈Mn₂ | (Ni₈₀Fe₂₀)₉₈Mn₂ | Fe₈₅Pt₁₃Mn₂ | Fe₈₅Pt₁₃Mn₂ | (Co₇₅Fe₂₅)₉₈Mn₂ | (Co₇₅Fe₂₅)₉₈Mn₂ |
| | | 260 | 27.1 | | | | | | |
| | | 300 | 32.2 | | | | | | |
| | | 350 | 40.6 | | | | | (Co₇₅Fe₂₅)₉₇Mn₃ | (Co₇₅Fe₂₅)_{93.1}Mn_{6.9} |
| | | 400 | 46.8 | | | | | (Co₇₅Fe₂₅)₉₆Mn₄ | (Co₇₅Fe₂₅)_{88.2}Mn_{11.8} |
| 94 | c) | r.t. | 12.4 | (Ni₈₀Fe₂₀)₉₈Mn₂ | (Ni₈₀Fe₂₀)₉₈Mn₂ | Fe₇₁Pt₂₇Mn₂ | Fe₇₁Pt₂₇Mn₂ | (Co₇₅Fe₂₅)₉₈Mn₂ | (Co₇₅Fe₂₅)₉₈Mn₂ |
| | | 260 | 25.7 | | | | | | |
| | | 300 | 28.1 | | | | | | |
| | | 350 | 38.6 | | | | | (Co₇₅Fe₂₅)₉₇Mn₃ | (Co₇₅Fe₂₅)_{93.1}Mn_{6.9} |
| | | 400 | 44.5 | | | | | (Co₇₅Fe₂₅)₉₆Mn₄ | (Co₇₅Fe₂₅)_{88.2}Mn_{11.8} |
| 95 | c) | r.t. | 11.9 | (Ni₈₀Fe₂₀)₉₈Mn₂ | (Ni₈₀Fe₂₀)₉₈Mn₂ | Fe₄₁Pt₅₇Mn₂ | Fe₄₁Pt₅₇Mn₂ | (Co₇₅Fe₂₅)₉₈Mn₂ | (Co₇₅Fe₂₅)₉₈Mn₂ |
| | | 260 | 25.5 | | | | | | |
| | | 300 | 27.1 | | | | | | |
| | | 350 | 37 | | | | | (Co₇₅Fe₂₅)₉₇Mn₃ | (Co₇₅Fe₂₅)_{93.1}Mn_{6.9} |
| | | 400 | 42 | | | | | (Co₇₅Fe₂₅)₉₆Mn₄ | (Co₇₅Fe₂₅)_{88.2}Mn_{11.8} |
| 96 | c) | r.t. | 10.4 | (Ni₈₀Fe₂₀)₉₈Mn₂ | (Ni₈₀Fe₂₀)₉₈Mn₂ | Fe₃₈Pt₆₀Mn₂ | Fe₃₈Pt₆₀Mn₂ | (Co₇₅Fe₂₅)₉₈Mn₂ | (Co₇₅Fe₂₅)₉₈Mn₂ |
| | | 260 | 19.9 | | | | | | |
| | | 300 | 22.4 | | | | | | |
| | | 350 | 19.8 | | | | | (Co₇₅Fe₂₅)₉₇Mn₃ | (Co₇₅Fe₂₅)_{93.1}Mn_{6.9} |
| | | 400 | 16.8 | | | | | (Co₇₅Fe₂₅)₉₆Mn₄ | (Co₇₅Fe₂₅)_{88.2}Mn_{11.8} |

TABLE 7a)

| | | Heat | | | | | | | |
|---|---|---|---|---|---|---|---|---|---|
| | | treat- | | | | | | | |
| | | ment | | | | | | | |
| Sam- | Ele- | temper- | | | | | | | |
| ple | ment | ature | MR | | | | | | |
| No. | type | (° C.) | (%) | Composition 1 | Composition 2 | Composition 3 | Composition 4 | Composition 5 | Composition 6 |
| 97 | c) | r.t. | 12.4 | (Ni₈₀Fe₂₀)₉₅Mn₅ | (Ni₈₀Fe₂₀)₉₅Mn₅ | Fe₉₅Mn₅ | Fe₉₅Mn₅ | (Co₇₅Fe₂₅)₉₅Mn₅ | (Co₇₅Fe₂₅)₉₅Mn₅ |
| | | 260 | 28.3 | | | | | | |
| | | 300 | 28.4 | | | | | | |
| | | 350 | 18.5 | | | | | (Co₇₅Fe₂₅)_{94.1}Mn_{5.9} | (Co₇₅Fe₂₅)_{90.3}Mn_{9.7} |
| | | 400 | 14.8 | | | | Fe_{94.8}Mn_{5.2} | (Co₇₅Fe₂₅)_{93.1}Mn_{6.9} | (Co₇₅Fe₂₅)_{85.5}Mn_{14.5} |
| 98 | c) | r.t. | 12.2 | (Ni₈₀Fe₂₀)₉₅Mn₅ | (Ni₈₀Fe₂₀)₉₅Mn₅ | Fe_{94.8}Pt_{0.2}Mn₅ | Fe_{94.8}Pt_{0.2}Mn₅ | (Co₇₅Fe₂₅)₉₅Mn₅ | (Co₇₅Fe₂₅)₉₅Mn₅ |
| | | 260 | 28 | | | | | | |
| | | 300 | 28.9 | | | | | | |
| | | 350 | 18.7 | | | | | (Co₇₅Fe₂₅)_{94.1}Mn_{5.9} | (Co₇₅Fe₂₅)_{90.3}Mn_{9.7} |
| | | 400 | 14.9 | | | | Fe_{94.6}Pt_{0.2}Mn_{5.2} | (Co₇₅Fe₂₅)_{93.1}Mn_{6.9} | (Co₇₅Fe₂₅)_{85.5}Mn_{14.5} |
| 99 | c) | r.t. | 11.8 | (Ni₈₀Fe₂₀)₉₅Mn₅ | (Ni₈₀Fe₂₀)₉₅Mn₅ | Fe_{94.7}Pt_{0.3}Mn₅ | Fe_{94.7}Pt_{0.3}Mn₅ | (Co₇₅Fe₂₅)₉₅Mn₅ | (Co₇₅Fe₂₅)₉₅Mn₅ |
| | | 260 | 26.4 | | | | | | |
| | | 300 | 28.8 | | | | | | |
| | | 350 | 26.5 | | | | | (Co₇₅Fe₂₅)_{94.1}Mn_{5.9} | (Co₇₅Fe₂₅)_{90.3}Mn_{9.7} |
| | | 400 | 27.9 | | | | Fe_{94.55}Pt_{0.3}Mn_{5.15} | (Co₇₅Fe₂₅)_{93.1}Mn_{6.9} | (Co₇₅Fe₂₅)_{85.5}Mn_{14.5} |
| 100 | c) | r.t. | 12.4 | (Ni₈₀Fe₂₀)₉₅Mn₅ | (Ni₈₀Fe₂₀)₉₅Mn₅ | Fe₉₃Pt₂Mn₅ | Fe₉₃Pt₂Mn₅ | (Co₇₅Fe₂₅)₉₅Mn₅ | (Co₇₅Fe₂₅)₉₅Mn₅ |
| | | 260 | 27.1 | | | | | | |
| | | 300 | 29.9 | | | | | | |
| | | 350 | 31.6 | | | | | (Co₇₅Fe₂₅)_{94.1}Mn_{5.9} | (Co₇₅Fe₂₅)_{90.3}Mn_{9.7} |
| | | 400 | 32.8 | | | | Fe_{92.9}Pt₂Mn_{5.1} | (Co₇₅Fe₂₅)_{93.1}Mn_{6.9} | (Co₇₅Fe₂₅)_{85.5}Mn_{14.5} |
| 101 | c) | r.t. | 13.3 | (Ni₈₀Fe₂₀)₉₅Mn₅ | (Ni₈₀Fe₂₀)₉₅Mn₅ | Fe₈₅Pt₁₀Mn₅ | Fe₈₅Pt₁₀Mn₅ | (Co₇₅Fe₂₅)₉₅Mn₅ | (Co₇₅Fe₂₅)₉₅Mn₅ |
| | | 260 | 26.9 | | | | | | |
| | | 300 | 31.8 | | | | | | |
| | | 350 | 40.1 | | | | | (Co₇₅Fe₂₅)_{94.1}Mn_{5.9} | (Co₇₅Fe₂₅)_{90.3}Mn_{9.7} |
| | | 400 | 45 | | | | | (Co₇₅Fe₂₅)_{93.1}Mn_{6.9} | (Co₇₅Fe₂₅)_{85.5}Mn_{14.5} |
| 102 | c) | r.t. | 12.2 | (Ni₈₀Fe₂₀)₉₅Mn₅ | (Ni₈₀Fe₂₀)₉₅Mn₅ | Fe₇₁Pt₂₄Mn₅ | Fe₇₁Pt₂₄Mn₅ | (Co₇₅Fe₂₅)₉₅Mn₅ | (Co₇₅Fe₂₅)₉₅Mn₅ |
| | | 260 | 25.8 | | | | | | |
| | | 300 | 27.9 | | | | | | |
| | | 350 | 36.7 | | | | | (Co₇₅Fe₂₅)_{94.1}Mn_{5.9} | (Co₇₅Fe₂₅)_{90.3}Mn_{9.7} |
| | | 400 | 43.2 | | | | | (Co₇₅Fe₂₅)_{93.1}Mn_{6.9} | (Co₇₅Fe₂₅)_{85.5}Mn_{14.5} |
| 103 | c) | r.t. | 11.7 | (Ni₈₀Fe₂₀)₉₅Mn₅ | (Ni₈₀Fe₂₀)₉₅Mn₅ | Fe₄₁Pt₅₄Mn₅ | Fe₄₁Pt₅₄Mn₅ | (Co₇₅Fe₂₅)₉₅Mn₅ | (Co₇₅Fe₂₅)₉₅Mn₅ |
| | | 260 | 25.3 | | | | | | |
| | | 300 | 26.9 | | | | | | |
| | | 350 | 34.4 | | | | | (Co₇₅Fe₂₅)_{94.1}Mn_{5.9} | (Co₇₅Fe₂₅)_{90.3}Mn_{9.7} |
| | | 400 | 40.5 | | | | | (Co₇₅Fe₂₅)_{93.1}Mn_{6.9} | (Co₇₅Fe₂₅)_{85.5}Mn_{14.5} |
| 104 | c) | r.t. | 10.3 | (Ni₈₀Fe₂₀)₉₅Mn₅ | (Ni₈₀Fe₂₀)₉₅Mn₅ | Fe₃₈Pt₅₇Mn₅ | Fe₃₈Pt₅₇Mn₅ | (Co₇₅Fe₂₅)₉₅Mn₅ | (Co₇₅Fe₂₅)₉₅Mn₅ |
| | | 260 | 19.9 | | | | | | |
| | | 300 | 22.2 | | | | | | |
| | | 350 | 19.5 | | | | | (Co₇₅Fe₂₅)_{94.1}Mn_{5.9} | (Co₇₅Fe₂₅)_{90.3}Mn_{9.7} |
| | | 400 | 16.5 | | | | | (Co₇₅Fe₂₅)_{93.1}Mn_{6.9} | (Co₇₅Fe₂₅)_{85.5}Mn_{14.5} |

TABLE 7b)

| | | Heat | | | | | | | |
|---|---|---|---|---|---|---|---|---|---|
| | | treat- | | | | | | | |
| | | ment | | | | | | | |
| Sam- | Ele- | temper- | | | | | | | |
| ple | ment | ature | MR | | | | | | |
| No. | type | (° C.) | (%) | Composition 1 | Composition 2 | Composition 3 | Composition 4 | Composition 5 | Composition 6 |
| 105 | c) | r.t. | 12.1 | (Ni₈₀Fe₂₀)₉₂Mn₈ | (Ni₈₀Fe₂₀)₉₂Mn₈ | Fe₉₂Mn₈ | Fe₉₂Mn₈ | (Co₇₅Fe₂₅)₉₂Mn₈ | (Co₇₅Fe₂₅)₉₂Mn₈ |
| | | 260 | 27.6 | | | | | | |
| | | 300 | 27.8 | | | | | | |
| | | 350 | 18 | | | | | (Co₇₅Fe₂₅)_{91.2}Mn_{8.8} | (Co₇₅Fe₂₅)_{87.9}Mn_{12.1} |
| | | 400 | 14.3 | | | | Fe_{91.85}Mn_{8.15} | (Co₇₅Fe₂₅)_{90.3}Mn_{9.7} | (Co₇₅Fe₂₅)_{83.7}Mn_{16.3} |
| 106 | c) | r.t. | 12.2 | (Ni₈₀Fe₂₀)₉₂Mn₈ | (Ni₈₀Fe₂₀)₉₂Mn₈ | Fe_{91.8}Pt_{0.2}Mn₈ | Fe_{9.18}Pt_{0.2}Mn₈ | (Co₇₅Fe₂₅)₉₂Mn₈ | (Co₇₅Fe₂₅)₉₂Mn₈ |
| | | 260 | 27.9 | | | | | | |
| | | 300 | 28.2 | | | | | | |
| | | 350 | 18.1 | | | | | (Co₇₅Fe₂₅)_{91.2}Mn_{8.8} | (Co₇₅Fe₂₅)_{87.9}Mn_{12.1} |
| | | 400 | 14.5 | | | | Fe_{91.65}Pt_{0.2}Mn_{8.15} | (Co₇₅Fe₂₅)_{90.3}Mn_{9.7} | (Co₇₅Fe₂₅)_{83.7}Mn_{16.3} |
| 107 | c) | r.t. | 11.6 | (Ni₈₀Fe₂₀)₉₂Mn₈ | (Ni₈₀Fe₂₀)₉₂Mn₈ | Fe_{91.7}Pt_{0.3}Mn₈ | Fe_{91.7}Pt_{0.3}Mn₈ | (Co₇₅Fe₂₅)₉₂Mn₈ | (Co₇₅Fe₂₅)₉₂Mn₈ |
| | | 260 | 25.9 | | | | | | |
| | | 300 | 28.1 | | | | | | |
| | | 350 | 24.9 | | | | | (Co₇₅Fe₂₅)_{91.2}Mn_{8.8} | (Co₇₅Fe₂₅)_{87.9}Mn_{12.1} |
| | | 400 | 25.8 | | | | Fe_{9.16}Pt_{0.3}Mn_{8.1} | (Co₇₅Fe₂₅)_{90.3}Mn_{9.7} | (Co₇₅Fe₂₅)_{83.7}Mn_{16.3} |
| 108 | c) | r.t. | 12 | (Ni₈₀Fe₂₀)₉₂Mn₈ | (Ni₈₀Fe₂₀)₉₂Mn₈ | Fe₉₀Pt₂Mn₈ | Fe₉₀Pt₂Mn₈ | (Co₇₅Fe₂₅)₉₂Mn₈ | (Co₇₅Fe₂₅)₉₂Mn₈ |
| | | 260 | 26.8 | | | | | | |
| | | 300 | 29.7 | | | | | | |
| | | 350 | 28.7 | | | | | (Co₇₅Fe₂₅)_{91.2}Mn_{8.8} | (Co₇₅Fe₂₅)_{87.9}Mn_{12.1} |
| | | 400 | 30 | | | | Fe_{89.95}Pt₂Mn_{8.05} | (Co₇₅Fe₂₅)_{90.3}Mn_{9.7} | (Co₇₅Fe₂₅)_{83.7}Mn_{16.3} |
| 109 | c) | r.t. | 12.9 | (Ni₈₀Fe₂₀)₉₂Mn₈ | (Ni₈₀Fe₂₀)₉₂Mn₈ | Fe₈₅Pt₇Mn₈ | Fe₈₅Pt₇Mn₈ | (Co₇₅Fe₂₅)₉₂Mn₈ | (Co₇₅Fe₂₅)₉₂Mn₈ |
| | | 260 | 26.2 | | | | | | |
| | | 300 | 31.1 | | | | | | |
| | | 350 | 32.3 | | | | | (Co₇₅Fe₂₅)_{91.2}Mn_{8.8} | (Co₇₅Fe₂₅)_{87.9}Mn_{12.1} |
| | | 400 | 37.3 | | | | | (Co₇₅Fe₂₅)_{90.3}Mn_{9.7} | (Co₇₅Fe₂₅)_{83.7}Mn_{16.3} |
| 110 | c) | r.t. | 11 | (Ni₈₀Fe₂₀)₉₂Mn₈ | (Ni₈₀Fe₂₀)₉₂Mn₈ | Fe₇₁Pt₂₁Mn₈ | Fe₇₁Pt₂₁Mn₈ | (Co₇₅Fe₂₅)₉₂Mn₈ | (Co₇₅Fe₂₅)₉₂Mn₈ |
| | | 260 | 24.9 | | | | | | |
| | | 300 | 26.2 | | | | | | |
| | | 350 | 30.4 | | | | | (Co₇₅Fe₂₅)_{91.2}Mn_{8.8} | (Co₇₅Fe₂₅)_{87.9}Mn_{12.1} |
| | | 400 | 34.1 | | | | | (Co₇₅Fe₂₅)_{90.3}Mn_{9.7} | (Co₇₅Fe₂₅)_{83.7}Mn_{16.3} |
| 111 | c) | r.t. | 10.6 | (Ni₈₀Fe₂₀)₉₂Mn₈ | (Ni₈₀Fe₂₀)₉₂Mn₈ | Fe₄₁Pt₅₁Mn₈ | Fe₄₁Pt₅₁Mn₈ | (Co₇₅Fe₂₅)₉₂Mn₈ | (Co₇₅Fe₂₅)₉₂Mn₈ |
| | | 260 | 24.9 | | | | | | |
| | | 300 | 26.1 | | | | | | |
| | | 350 | 28.5 | | | | | (Co₇₅Fe₂₅)_{91.2}Mn_{8.8} | (Co₇₅Fe₂₅)_{87.9}Mn_{12.1} |
| | | 400 | 32.6 | | | | | (Co₇₅Fe₂₅)_{90.3}Mn_{9.7} | (Co₇₅Fe₂₅)_{83.7}Mn_{16.3} |
| 112 | c) | r.t. | 10.2 | (Ni₈₀Fe₂₀)₉₂Mn₈ | (Ni₈₀Fe₂₀)₉₂Mn₈ | Fe₃₈Pt₅₄Mn₈ | Fe₃₈Pt₅₄Mn₈ | (Co₇₅Fe₂₅)₉₂Mn₈ | (Co₇₅Fe₂₅)₉₂Mn₈ |
| | | 260 | 19.7 | | | | | | |
| | | 300 | 21.9 | | | | | | |
| | | 350 | 18.3 | | | | | (Co₇₅Fe₂₅)_{91.2}Mn_{8.8} | (Co₇₅Fe₂₅)_{87.9}Mn_{12.1} |
| | | 400 | 15.4 | | | | | (Co₇₅Fe₂₅)_{90.3}Mn_{9.7} | (Co₇₅Fe₂₅)_{83.7}Mn_{16.3} |

TABLE 7c)

| Sample | Element | Heat treatment | MR | | | |
|---|---|---|---|---|---|---|
| No. | type | temperature (° C.) | (%) | Composition 1 | Composition 2 | Composition 3 |
| 113 | | r.t. | 11.6 | (Ni₈₀Fe₂₀)₈₈Mn₁₂ | (Ni₈₀Fe₂₀)₈₈Mn₁₂ | Fe₈₈Mn₁₂ |
| | | 260 | 26.1 | | | |
| | | 300 | 26.5 | | | |
| | | 350 | 17 | | | |
| | | 400 | 13.6 | | | |
| 114 | c) | r.t. | 11.8 | (Ni₈₀Fe₂₀)₈₈Mn₁₂ | (Ni₈₀Fe₂₀)₈₈Mn₁₂ | Fe_{87.8}Pt_{0.2}Mn₁₂ |
| | | 260 | 26.5 | | | |
| | | 300 | 26.9 | | | |
| | | 350 | 17.2 | | | |
| | | 400 | 13.7 | | | |
| 115 | c) | r.t. | 11.5 | (Ni₈₀Fe₂₀)₈₈Mn₁₂ | (Ni₈₀Fe₂₀)₈₈Mn₁₂ | Fe_{87.7}Pt_{0.3}Mn₁₂ |
| | | 260 | 25.7 | | | |
| | | 300 | 27.8 | | | |
| | | 350 | 23.5 | | | |
| | | 400 | 24 | | | |
| 116 | c) | r.t. | 11.8 | (Ni₈₀Fe₂₀)₈₈Mn₁₂ | (Ni₈₀Fe₂₀)₈₈Mn₁₂ | Fe₈₆Pt₂Mn₁₂ |
| | | 260 | 26.6 | | | |
| | | 300 | 27.9 | | | |
| | | 350 | 25.7 | | | |
| | | 400 | 27.2 | | | |

| Sample | | | |
|---|---|---|---|
| No. | Composition 4 | Composition 5 | Composition 6 |
| 113 | Fe₈₈Mn₁₂ | (Co₇₅Fe₂₅)₈₈Mn₁₂ | (Co₇₅Fe₂₅)₈₈Mn₁₂ |
| | | (Co₇₅Fe₂₅)_{87.3}Mn_{12.7} | (Co₇₅Fe₂₅)_{84.5}Mn_{15.5} |
| | Fe_{87.9}Mn_{12.1} | (Co₇₅Fe₂₅)_{86.6}Mn_{13.4} | (Co₇₅Fe₂₅)₈₁Mn₁₉ |
| 114 | Fe_{87.8}Pt_{0.2}Mn₁₂ | (Co₇₅Fe₂₅)₈₈Mn₁₂ | (Co₇₅Fe₂₅)₈₈Mn₁₂ |
| | | (Co₇₅Fe₂₅)_{87.3}Mn_{12.7} | (Co₇₅Fe₂₅)_{84.5}Mn_{15.5} |
| | Fe_{87.7}Pt_{0.2}Mn_{12.1} | (Co₇₅Fe₂₅)_{86.6}Mn_{13.4} | (Co₇₅Fe₂₅)₈₁Mn₁₉ |
| 115 | Fe_{87.7}Pt_{0.3}Mn₁₂ | (Co₇₅Fe₂₅)₈₈Mn₁₂ | (Co₇₅Fe₂₅)₈₈Mn₁₂ |
| | | (Co₇₅Fe₂₅)_{87.3}Mn_{12.7} | (Co₇₅Fe₂₅)_{84.5}Mn_{15.5} |
| | Fe_{87.65}Pt_{0.3} MN_{12.05} | (Co₇₅Fe₂₅)_{86.6}Mn_{13.4} | (Co₇₅Fe₂₅)₈₁Mn₁₉ |
| 116 | Fe₈₆Pt₂Mn₁₂ | (Co₇₅Fe₂₅)₈₈Mn₁₂ | (Co₇₅Fe₂₅)₈₈Mn₁₂ |
| | | (Co₇₅Fe₂₅)_{87.3}Mn_{12.7} | (Co₇₅Fe₂₅)_{84.5}Mn_{15.5} |
| | | (Co₇₅Fe₂₅)_{86.6}Mn_{13.4} | (Co₇₅Fe₂₅)₈₁Mn₁₉ |

TABLE 7c)

| | | Heat | | | | | | | |
|---|---|---|---|---|---|---|---|---|---|
| | | treat- | | | | | | | |
| | | ment | | | | | | | |
| | | tem- | | | | | | | |
| Sam- | | per- | | | | | | | |
| ple | Element | ature | MR | | | | | | |
| No. | type | (° C.) | (%) | Composition 1 | Composition 2 | Composition 3 | Composition 4 | Composition 5 | Composition 6 |
| 117 | c) | r.t. | 11.9 | (Ni₈₀Fe₂₀)₈₈Mn₁₂ | (Ni₈₀Fe₂₀)₈₈Mn₁₂ | Fe₈₁Pt₇Mn₁₂ | Fe₈₁Pt₇Mn₁₂ | (Co₇₅Fe₂₅)₈₈Mn₁₂ | (Co₇₅Fe₂₅)₈₈Mn₁₂ |
| | | 260 | 25.9 | | | | | | |
| | | 300 | 30.2 | | | | | | |
| | | 350 | 27.2 | | | | | (Co₇₅Fe₂₅)_{87.3}Mn_{12.7} | (Co₇₅Fe₂₅)_{84.5}Mn_{15.5} |
| | | 400 | 29.9 | | | | | (Co₇₅Fe₂₅)_{86.6}Mn_{13.4} | (Co₇₅Fe₂₅)₈₁Mn₁₉ |
| 118 | c) | r.t. | 10.1 | (Ni₈₀Fe₂₀)₈₈Mn₁₂ | (Ni₈₀Fe₂₀)₈₈Mn₁₂ | Fe₇₁Pt₁₇Mn₁₂ | Fe₇₁Pt₁₇Mn₁₂ | (Co₇₅Fe₂₅)₈₈Mn₁₂ | (Co₇₅Fe₂₅)₈₈Mn₁₂ |
| | | 260 | 23.9 | | | | | | |
| | | 300 | 25.7 | | | | | | |
| | | 350 | 26.8 | | | | | (Co₇₅Fe₂₅)_{87.3}Mn_{12.7} | (Co₇₅Fe₂₅)_{84.5}Mn_{15.5} |
| | | 400 | 29.4 | | | | | (Co₇₅Fe₂₅)_{86.6}Mn_{13.4} | (Co₇₅Fe₂₅)₈₁Mn₁₉ |
| 119 | c) | r.t. | 10.1 | (Ni₈₀Fe₂₀)₈₈Mn₁₂ | (Ni₈₀Fe₂₀)₈₈Mn₁₂ | Fe₄₁Pt₄₇Mn₁₂ | Fe₄₁Pt₄₇Mn₁₂ | (Co₇₅Fe₂₅)₈₈Mn₁₂ | (Co₇₅Fe₂₅)₈₈Mn₁₂ |
| | | 260 | 24.2 | | | | | | |
| | | 300 | 25.6 | | | | | | |
| | | 350 | 24.9 | | | | | (Co₇₅Fe₂₅)_{87.3}Mn_{12.7} | (Co₇₅Fe₂₅)_{84.5}Mn_{15.5} |
| | | 400 | 27.2 | | | | | (Co₇₅Fe₂₅)_{86.6}Mn_{13.4} | (Co₇₅Fe₂₅)₈₁Mn₁₉ |
| 120 | c) | r.t. | 9.9 | (Ni₈₀Fe₂₀)₈₈Mn₁₂ | (Ni₈₀Fe₂₀)₈₈Mn₁₂ | Fe₃₈Pt₅₀Mn₁₂ | Fe₃₈Pt₅₀Mn₁₂ | (Co₇₅Fe₂₅)₈₈Mn₁₂ | (Co₇₅Fe₂₅)₈₈Mn₁₂ |
| | | 260 | 19.2 | | | | | | |
| | | 300 | 21.2 | | | | | | |
| | | 350 | 17 | | | | | (Co₇₅Fe₂₅)_{87.3}Mn_{12.7} | (Co₇₅Fe₂₅)_{84.5}Mn_{15.5} |
| | | 400 | 13.9 | | | | | (Co₇₅Fe₂₅)_{86.6}Mn_{13.4} | (Co₇₅Fe₂₅)₈₁Mn₁₉ |

TABLE 7d)

| | | | | | | | | | |
|---|---|---|---|---|---|---|---|---|---|
| 121 | c) | r.t. | 10.9 | (Ni₈₀Fe₂₀)₈₁Mn₁₉ | (Ni₈₀Fe₂₀)₈₁Mn₁₉ | Fe₈₁Mn₁₉ | Fe₈₁Mn₁₉ | (Co₇₅Fe₂₅)₈₁Mn₁₉ | (Co₇₅Fe₂₅)₈₁Mn₁₉ |
| | | 260 | 24.2 | | | | | | |
| | | 300 | 24.7 | | | | | | |
| | | 350 | 16.1 | | | | | (Co₇₅Fe₂₅)_{80.5}Mn_{19.5} | (Co₇₅Fe₂₅)_{78.6}Mn_{21.4} |
| | | 400 | 12.8 | | | | Fe_{80.95}Mn_{19.05} | (Co₇₅Fe₂₅)₈₀Mn₂₀ | (Co₇₅Fe₂₅)_{75.1}Mn_{23.9} |
| 122 | c) | r.t. | 11.2 | (Ni₈₀Fe₂₀)₈₁Mn₁₉ | (Ni₈₀Fe₂₀)₈₁Mn₁₉ | Fe_{80.8}Pt_{0.2}Mn₁₉ | Fe_{80.8}Pt_{0.2}Mn₁₉ | (Co₇₅Fe₂₅)₈₁Mn₁₉ | (Co₇₅Fe₂₅)₈₁Mn₁₉ |
| | | 260 | 25.1 | | | | | | |
| | | 300 | 25.3 | | | | | | |
| | | 350 | 16.1 | | | | | (Co₇₅Fe₂₅)_{80.5}Mn_{19.5} | (Co₇₅Fe₂₅)_{78.6}Mn_{21.4} |
| | | 400 | 12.8 | | | | Fe_{80.75}Pt_{0.2}Mn_{19.05} | (Co₇₅Fe₂₅)₈₀Mn₂₀ | (Co₇₅Fe₂₅)_{75.1}Mn_{23.9} |
| 123 | c) | r.t. | 11.4 | (Ni₈₀Fe₂₀)₈₁Mn₁₉ | (Ni₈₀Fe₂₀)₈₁Mn₁₉ | Fe_{80.7}Pt_{0.3}Mn₁₉ | Fe_{80.7}Pt_{0.3}Mn₁₉ | (Co₇₅Fe₂₅)₈₁Mn₁₉ | Co₇₅Fe₂₅)₈₁Mn₁₉ |
| | | 260 | 25.5 | | | | | | |
| | | 300 | 26.9 | | | | | | |
| | | 350 | 21.8 | | | | | (Co₇₅Fe₂₅)_{80.5}Mn_{19.5} | (Co₇₅Fe₂₅)_{78.6}Mn_{21.4} |
| | | 400 | 21.9 | | | | | (Co₇₅Fe₂₅)₈₀Mn₂₀ | (Co₇₅Fe₂₅)_{75.1}Mn_{23.9} |
| 124 | c) | r.t. | 11.4 | (Ni₈₀Fe₂₀)₈₁Mn₁₉ | (Ni₈₀Fe₂₀)₈₁Mn₁₉ | Fe₇₉Pt₂Mn₁₉ | Fe₇₉Pt₂Mn₁₉ | (Co₇₅Fe₂₅)₈₁Mn₁₉ | (Co₇₅Fe₂₅)₈₁Mn₁₉ |
| | | 260 | 26.1 | | | | | | |
| | | 300 | 27.2 | | | | | | |
| | | 350 | 22.7 | | | | | (Co₇₅Fe₂₅)_{80.5}Mn_{19.5} | (Co₇₅Fe₂₅)_{78.6}Mn_{21.4} |
| | | 400 | 23.1 | | | | | (Co₇₅Fe₂₅)₈₀Mn₂₀ | (Co₇₅Fe₂₅)_{75.1}Mn_{23.9} |
| 125 | c) | r.t. | 11.6 | (Ni₈₀Fe₂₀)₈₁Mn₁₉ | (Ni₈₀Fe₂₀)₈₁Mn₁₉ | Fe₇₄Pt₇Mn₁₉ | Fe₇₄Pt₇Mn₁₉ | (Co₇₅Fe₂₅)₈₁Mn₁₉ | (Co₇₅Fe₂₅)₈₁Mn₁₉ |
| | | 260 | 25.8 | | | | | | |
| | | 300 | 28.9 | | | | | | |
| | | 350 | 24.4 | | | | | (Co₇₅Fe₂₅)_{80.5}Mn_{19.5} | (Co₇₅Fe₂₅)_{78.6}Mn_{21.4} |
| | | 400 | 25.1 | | | | | (Co₇₅Fe₂₅)₈₀Mn₂₀ | (Co₇₅Fe₂₅)_{75.1}Mn_{23.9} |
| 126 | c) | r.t. | 9.9 | (Ni₈₀Fe₂₀)₈₁Mn₁₉ | (Ni₈₀Fe₂₀)₈₁Mn₁₉ | Fe₇₁Pt₁₀Mn₁₉ | Fe₇₁Pt₁₀Mn₁₉ | (Co₇₅Fe₂₅)₈₁Mn₁₉ | (Co₇₅Fe₂₅)₈₁Mn₁₉ |
| | | 260 | 22.1 | | | | | | |
| | | 300 | 24.2 | | | | | | |
| | | 350 | 23.1 | | | | | (Co₇₅Fe₂₅)_{80.5}Mn_{19.5} | (Co₇₅Fe₂₅)_{78.6}Mn_{21.4} |
| | | 400 | 24 | | | | | (Co₇₅Fe₂₅)₈₀Mn₂₀ | (Co₇₅Fe₂₅)_{75.1}Mn_{23.9} |
| 127 | c) | r.t. | 9.8 | (Ni₈₀Fe₂₀)₈₁Mn₁₉ | (Ni₈₀Fe₂₀)₈₁Mn₁₉ | Fe₄₁Pt₄₀Mn₁₉ | Fe₄₁Pt₄₀Mn₁₉ | (Co₇₅Fe₂₅)₈₁Mn₁₉ | Co₇₅Fe₂₅)₈₁Mn₁₉ |
| | | 260 | 23.9 | | | | | | |
| | | 300 | 24.2 | | | | | | |
| | | 350 | 21.4 | | | | | (Co₇₅Fe₂₅)_{80.5}Mn_{19.5} | (Co₇₅Fe₂₅)_{78.6}Mn_{21.4} |
| | | 400 | 21.9 | | | | | (Co₇₅Fe₂₅)₈₀Mn₂₀ | (Co₇₅Fe₂₅)_{75.1}Mn_{23.9} |
| 128 | c) | r.t. | 9.5 | (Ni₈₀Fe₂₀)₈₁Mn₁₉ | (Ni₈₀Fe₂₀)₈₁Mn₁₉ | Fe₃₈Pt₄₃Mn₁₉ | Fe₃₈Pt₄₃Mn₁₉ | (Co₇₅Fe₂₅)₈₁Mn₁₉ | (Co₇₅Fe₂₅)₈₁Mn₁₉ |
| | | 260 | 18.2 | | | | | | |
| | | 300 | 20.1 | | | | | | |
| | | 350 | 15.1 | | | | | (Co₇₅Fe₂₅)_{80.5}Mn_{19.5} | (Co₇₅Fe₂₅)_{78.6}Mn_{21.4} |
| | | 400 | 12.7 | | | | | (Co₇₅Fe₂₅)₈₀Mn₂₀ | (Co₇₅Fe₂₅)_{75.1}Mn_{23.9} |

TABLE 8a)

| | | Heat | | | | | | | |
|---|---|---|---|---|---|---|---|---|---|
| | | treat- | | | | | | | |
| | | ment | | | | | | | |
| | | tem- | | | | | | | |
| Sam- | | per- | | | | | | | |
| ple | Element | ature | MR | | | | | | |
| No. | type | (° C.) | (%) | Composition 1 | Composition 2 | Composition 3 | Composition 4 | Composition 5 | Composition 6 |
| 129 | c) | r.t. | 10.1 | (Ni₈₀Fe₂₀)₇₈Mn₂₂ | (Ni₈₀Fe₂₀)₇₈Mn₂₂ | Fe₇₈Mn₂₂ | Fe₇₈Mn₂₂ | (Co₇₅Fe₂₅)₇₈Mn₂₂ | (Co₇₅Fe₂₅)₇₈Mn₂₂ |
| | | 260 | 21.1 | | | | | | |
| | | 300 | 21.4 | | | | | | |
| | | 350 | 13.2 | | | | | (Co₇₅Fe₂₅)_{77.7}Mn_{22.3} | (Co₇₅Fe₂₅)_{76.4}Mn_{23.6} |
| | | 400 | 10.6 | | | | | (Co₇₅Fe₂₅)_{77.4}Mn_{22.6} | (Co₇₅Fe₂₅)_{74.9}Mn_{25.1} |
| 130 | c) | r.t. | 10.2 | (Ni₈₀Fe₂₀)₇₈Mn₂₂ | (Ni₈₀Fe₂₀)₇₈Mn₂₂ | Fe_{77.8}Pt_{0.2}Mn₂₂ | Fe_{77.8}Pt_{0.2}Mn₂₂ | (Co₇₅Fe₂₅)₇₈Mn₂₂ | (Co₇₅Fe₂₅)₇₈Mn₂₂ |
| | | 260 | 21.4 | | | | | | |
| | | 300 | 21.6 | | | | | | |
| | | 350 | 13 | | | | | (Co₇₅Fe₂₅)_{77.7}Mn_{22.3} | (Co₇₅Fe₂₅)_{76.4}Mn_{23.6} |
| | | 400 | 10.4 | | | | | (Co₇₅Fe₂₅)_{77.4}Mn_{22.6} | (Co₇₅Fe₂₅)_{74.9}Mn_{25.1} |
| 131 | c) | r.t. | 10.4 | (Ni₈₀Fe₂₀)₇₈Mn₂₂ | (Ni₈₀Fe₂₀)₇₈Mn₂₂ | Fe_{77.7}Pt_{0.3}Mn₂₂ | Fe_{77.7}Pt_{0.3}Mn₂₂ | (Co₇₅Fe₂₅)₇₈Mn₂₂ | (Co₇₅Fe₂₅)₇₈Mn₂₂ |
| | | 260 | 21.6 | | | | | | |
| | | 300 | 21.7 | | | | | | |
| | | 350 | 14.6 | | | | | (Co₇₅Fe₂₅)_{77.7}Mn_{22.3} | (Co₇₅Fe₂₅)_{76.4}Mn_{23.6} |
| | | 400 | 12.2 | | | | | (Co₇₅Fe₂₅)_{77.4}Mn_{22.6} | (Co₇₅Fe₂₅)_{74.9}Mn_{25.1} |
| 132 | c) | r.t. | 10.5 | (Ni₈₀Fe₂₀)₇₈Mn₂₂ | (Ni₈₀Fe₂₀)₇₈Mn₂₂ | Fe₇₆Pt₂Mn₂₂ | Fe₇₆Pt₂Mn₂₂ | (Co₇₅Fe₂₅)₇₈Mn₂₂ | (Co₇₅Fe₂₅)₇₈Mn₂₂ |
| | | 260 | 21.9 | | | | | | |
| | | 300 | 21.7 | | | | | | |
| | | 350 | 14.7 | | | | | (Co₇₅Fe₂₅)_{77.7}Mn_{22.3} | (Co₇₅Fe₂₅)_{76.4}Mn_{23.6} |
| | | 400 | 12.5 | | | | | (Co₇₅Fe₂₅)_{77.4}Mn_{22.6} | (Co₇₅Fe₂₅)_{74.9}Mn_{25.1} |
| 133 | c) | r.t. | 10.7 | (Ni₈₀Fe₂₀)₇₈Mn₂₂ | (Ni₈₀Fe₂₀)₇₈Mn₂₂ | Fe₇₁Pt₇Mn₂₂ | Fe₇₁Pt₇Mn₂₂ | (Co₇₅Fe₂₅)₇₈Mn₂₂ | (Co₇₅Fe₂₅)₇₈Mn₂₂ |
| | | 260 | 22.1 | | | | | | |
| | | 300 | 22.3 | | | | | | |
| | | 350 | 14.9 | | | | | (Co₇₅Fe₂₅)_{77.7}Mn_{22.3} | (Co₇₅Fe₂₅)_{76.4}Mn_{23.6} |
| | | 400 | 12.8 | | | | | (Co₇₅Fe₂₅)_{77.4}Mn_{22.6} | (Co₇₅Fe₂₅)_{74.9}Mn_{25.1} |
| 134 | c) | r.t. | 9.6 | (Ni₈₀Fe₂₀)₇₈Mn₂₂ | (Ni₈₀Fe₂₀)₇₈Mn₂₂ | Fe₆₈Pt₁₀Mn₂₂ | Fe₆₈Pt₁₀Mn₂₂ | (Co₇₅Fe₂₅)₇₈Mn₂₂ | (Co₇₅Fe₂₅)₇₈Mn₂₂ |
| | | 260 | 18.2 | | | | | | |
| | | 300 | 19.9 | | | | | | |
| | | 350 | 14.6 | | | | | (Co₇₅Fe₂₅)_{77.7}Mn_{22.3} | (Co₇₅Fe₂₅)_{76.4}Mn_{23.6} |
| | | 400 | 12.7 | | | | | (Co₇₅Fe₂₅)_{77.4}Mn_{22.6} | (Co₇₅Fe₂₅)_{74.9}Mn_{25.1} |
| 135 | c) | r.t. | 9.5 | (Ni₈₀Fe₂₀)₇₈Mn₂₂ | (Ni₈₀Fe₂₀)₇₈Mn₂₂ | Fe₄₁Pt₃₇Mn₂₂ | Fe₄₁Pt₃₇Mn₂₂ | (Co₇₅Fe₂₅)₇₈Mn₂₂ | (Co₇₅Fe₂₅)₇₈Mn₂₂ |
| | | 260 | 17.6 | | | | | | |
| | | 300 | 18.1 | | | | | | |
| | | 350 | 13.4 | | | | | (Co₇₅Fe₂₅)_{77.7}Mn_{22.3} | (Co₇₅Fe₂₅)_{76.4}Mn_{23.6} |
| | | 400 | 10.4 | | | | | (Co₇₅Fe₂₅)_{77.4}Mn_{22.6} | (Co₇₅Fe₂₅)_{74.9}Mn_{25.1} |
| 136 | c) | r.t. | 8.1 | (Ni₈₀Fe₂₀)₇₈Mn₂₂ | (Ni₈₀Fe₂₀)₇₈Mn₂₂ | Fe₃₈Pt₄₀Mn₂₂ | Fe₃₈Pt₄₀Mn₂₂ | (Co₇₅Fe₂₅)₇₈Mn₂₂ | (Co₇₅Fe₂₅)₇₈Mn₂₂ |
| | | 260 | 16.2 | | | | | | |
| | | 300 | 16.9 | | | | | | |
| | | 350 | 11.3 | | | | | (Co₇₅Fe₂₅)_{77.7}Mn_{22.3} | (Co₇₅Fe₂₅)_{76.4}Mn_{23.6} |
| | | 400 | 10.7 | | | | | (Co₇₅Fe₂₅)_{77.4}Mn_{22.6} | (Co₇₅Fe₂₅)_{74.9}Mn_{25.1} |

TABLE 8b)

| | | Heat | | | | | | | | | | |
|---|---|---|---|---|---|---|---|---|---|---|---|---|
| | | treat- | | | | | | | | | | |
| | | ment | | | | | | | | | | |
| | | tem- | | | | | | | | | | |
| | | per- | | | | | | | | | | |
| Sample | Element | ature | MR | | | | | | | | | |
| No. | type | (° C.) | (%) | Composition 1 | Composition 2 | Composition 3 | Composition 4 | Composition 5 | Composition 6 | Composition 7 | Composition 8 | Composition 9 |
| 137 | d) | r.t. | 18.9 | Co₅₀Pt₅₀ | Co₅₀Pt₅₀ | Co₇₅Fe₂₅ | Co₇₅Fe₂₅ | Ni₈₀Fe₂₀ | Co₇₅Fe₂₅ | Co₇₅Fe₂₅ | Co₅₀Pt₅₀ | Co₅₀Pt₅₀ |
| | | 260 | 37.1 | | | | | | | | | |
| | | 300 | 36.5 | | | | | | | | | |
| | | 350 | 15.1 | | | | | | | | | |
| | | 400 | 9.9 | | | | | | | | | |
| 138 | d) | r.t. | 18.8 | Co₅₀Pt₅₀ | Co₅₀Pt₅₀ | (Co₇₅Fe₂₅)_{99.8}Rh_{0.2} | (Co₇₅Fe₂₅)_{99.8}Rh_{0.2} | Ni₈₀Fe₂₀ | (Co₇₅Fe₂₅)_{99.8}Rh_{0.2} | (Co₇₅Fe₂₅)_{99.8}Rh_{0.2} | Co₅₀Pt₅₀ | Co₅₀Pt₅₀ |
| | | 260 | 35.6 | | | | | | | | | |
| | | 300 | 36.6 | | | | | | | | | |
| | | 350 | 15.4 | | | | | | | | | |
| | | 400 | 10.5 | | | | | | | | | |
| 139 | d) | r.t. | 18.5 | Co₅₀Pt₅₀ | Co₅₀Pt₅₀ | (Co₇₅Fe₂₅)_{99.7}Rh_{0.3} | (Co₇₅Fe₂₅)_{99.7}Rh_{0.3} | Ni₈₀Fe₂₀ | (Co₇₅Fe₂₅)_{99.7}Rh_{0.3} | (Co₇₅Fe₂₅)_{99.7}Rh_{0.3} | Co₅₀Pt₅₀ | Co₅₀Pt₅₀ |
| | | 260 | 35.9 | | | | | | | | | |
| | | 300 | 36.6 | | | | | | | | | |
| | | 350 | 26.5 | | | | | | | | | |
| | | 400 | 25.9 | | | | | | | | | |
| 140 | d) | r.t. | 18.1 | Co₅₀Pt₅₀ | Co₅₀Pt₅₀ | (Co₇₅Fe₂₅)₉₇Rh₃ | (Co₇₅Fe₂₅)₉₇Rh₃ | Ni₈₀Fe₂₀ | (Co₇₅Fe₂₅)₉₇Rh₃ | (Co₇₅Fe₂₅)₉₇Rh₃ | Co₅₀Pt₅₀ | Co₅₀Pt₅₀ |
| | | 260 | 36.2 | | | | | | | | | |
| | | 300 | 36.4 | | | | | | | | | |
| | | 350 | 35.6 | | | | | | | | | |
| | | 400 | 30.1 | | | | | | | | | |
| 141 | d) | r.t. | 16.5 | Co₅₀Pt₅₀ | Co₅₀Pt₅₀ | (Co₇₅Fe₂₅)₈₅Rh₁₅ | (Co₇₅Fe₂₅)₈₅Rh₁₅ | Ni₈₀Fe₂₀ | (Co₇₅Fe₂₅)₈₅Rh₁₅ | (Co₇₅Fe₂₅)₈₅Rh₁₅ | Co₅₀Pt₅₀ | Co₅₀Pt₅₀ |
| | | 260 | 32.1 | | | | | | | | | |
| | | 300 | 33.2 | | | | | | | | | |
| | | 350 | 34.2 | | | | | | | | | |
| | | 400 | 36.6 | | | | | | | | | |
| 142 | d) | r.t. | 16.1 | Co₅₀Pt₅₀ | Co₅₀Pt₅₀ | (Co₇₅Fe₂₅)₇₁Rh₂₉ | (Co₇₅Fe₂₅)₇₁Rh₂₉ | Ni₈₀Fe₂₀ | (Co₇₅Fe₂₅)₇₁Rh₂₉ | (Co₇₅Fe₂₅)₇₁Rh₂₉ | Co₅₀Pt₅₀ | Co₅₀Pt₅₀ |
| | | 260 | 30.1 | | | | | | | | | |
| | | 300 | 32.4 | | | | | | | | | |
| | | 350 | 34.5 | | | | | | | | | |
| | | 400 | 34.3 | | | | | | | | | |
| 143 | d) | r.t. | 15.2 | Co₅₀Pt₅₀ | Co₅₀Pt₅₀ | (Co₇₅Fe₂₅)₄₁Rh₅₉ | (Co₇₅Fe₂₅)₄₁Rh₅₉ | Ni₈₀Fe₂₀ | (Co₇₅Fe₂₅)₄₁Rh₅₉ | (Co₇₅Fe₂₅)₄₁Rh₅₉ | Co₅₀Pt₅₀ | Co₅₀Pt₅₀ |
| | | 260 | 25.7 | | | | | | | | | |
| | | 300 | 26.6 | | | | | | | | | |
| | | 350 | 30.3 | | | | | | | | | |
| | | 400 | 29.8 | | | | | | | | | |
| 144 | d) | r.t. | 10.3 | Co₅₀Pt₅₀ | Co₅₀Pt₅₀ | (Co₇₅Fe₂₅)₃₈Rh₆₂ | (Co₇₅Fe₂₅)₃₈Rh₆₂ | Ni₈₀Fe₂₀ | (Co₇₅Fe₂₅)₃₈Rh₆₂ | (Co₇₅Fe₂₅)₃₈Rh₆₂ | Co₅₀Pt₅₀ | Co₅₀Pt₅₀ |
| | | 260 | 22.1 | | | | | | | | | |
| | | 300 | 23.5 | | | | | | | | | |
| | | 350 | 16.1 | | | | | | | | | |
| | | 400 | 11.2 | | | | | | | | | |

TABLE 8c)

| | | Heat | | | | | | |
|---|---|---|---|---|---|---|---|---|
| | | treat- | | | | | | |
| | | ment | | | | | | |
| | | tem- | | | | | | |
| | | per- | | | | | | |
| | Element | ature | MR | | | | | |
| Sample No. | type | (° C.) | (%) | Composition 1 | Composition 2 | Composition 3 | Composition 4 | Composition 5 |
| 145 | d) | r.t. | 15.1 | Co₅₀Fe₅₀ | Co₅₀Fe₅₀ | Co₉₀Fe₁₀ | Fe₆₀Ni₄₀ | Ni₈₀Fe₂₀ |
| | | 260 | 32.1 | | | | | |
| | | 300 | 34.1 | | | | | |
| | | 350 | 10.1 | Fe₅₇Ni₄₃ | Ni_{78.9}Fe_{21.1} | Fe₅₇Ni₄₃ | | |
| | | 400 | 8.5 | Fe₅₄Ni₄₆ | Ni_{77.8}Fe_{22.2} | Fe₅₄Ni₄₆ | | |
| 146 | d) | r.t. | 15.3 | (Co₅₀Fe₅₀)_{99.8}Pt_{0.2} | (Co₅₀Fe₅₀)_{99.8}Pt_{0.2} | (Co₅₀Fe₅₀)_{99.9}Pt_{0.1} | (Fe₆₀Ni₄₀)_{99.8}Ir_{0.2} | Ni₈₀Fe₂₀ |
| | | 260 | 32.4 | | | | | |
| | | 300 | 34.3 | | | | | |
| | | 350 | 11.1 | | | (Co₉₀Fe₁₀)_{99.8}Pt_{0.1}Mn_{0.1} | (Fe₅₇Ni₄₃)_{99.8}Ir_{0.2} | Ni_{78.9}Fe_{21.1} |
| | | 400 | 9.5 | | | (Co₉₀Fe₁₀)_{99.7}Pt_{0.2}Mn_{0.1} | (Fe₅₄Ni₄₆)_{99.8}Ir_{0.2} | Ni_{77.8}Fe_{22.2} |
| 147 | d) | r.t. | 15.5 | (Co₅₀Fe₅₀)_{99.7}Pt_{0.3} | (Co₅₀Fe₅₀)_{99.7}Pt_{0.3} | (Co₉₀Fe₁₀)_{99.85}Mn_{0.15} | (Fe₆₀Ni₄₀)_{99.7}Ir_{0.3} | Ni₈₀Fe₂₀ |
| | | 260 | 33.1 | | | | | |
| | | 300 | 35.2 | | | | | |
| | | 350 | 28.4 | | | (Co₉₀Fe₁₀)_{99.7}Pt_{0.15}Mn_{0.15} | (Fe₅₇Ni₄₃)_{99.7}Ir_{0.3} | Ni_{78.9}Fe_{21.1} |
| | | 400 | 24.6 | | | (Co₉₀Fe₁₀)_{99.55}Pt_{0.3}Mn_{0.15} | (Fe₅₄Ni₄₆)_{99.7}Ir_{0.3} | Ni_{77.8}Fe_{22.2} |
| 148 | d) | r.t. | 16.3 | (Co₅₀Fe₅₀)₉₇Pt₃ | (Co₅₀Fe₅₀)₉₇Pt₃ | (Co₉₀Fe₁₀)₉₉Mn₁ | (Fe₆₀Ni₄₀)₉₇Ir₃ | Ni₈₀Fe₂₀ |
| | | 260 | 35.2 | | | | | |
| | | 300 | 36.7 | | | | | |
| | | 350 | 32.8 | | | (Co₉₀Fe₁₀)₉₈Pt₁Mn₁ | (Fe_{56.9}Ni_{43.1})_{97.1}Ir_{2.9} | Ni_{78.9}Fe_{21.1} |
| | | 400 | 29.9 | | | (Co₉₀Fe₁₀)₉₇Pt₂Mn₁ | | |
| 149 | d) | r.t. | 17.5 | (Co₅₀Fe₅₀)₈₅Pt₁₅ | (Co₅₀Fe₅₀)₈₅Pt₁₅ | (Co₉₀Fe₁₀)₉₅Mn₅ | (Fe₆₀Ni₄₀)₈₅Ir₁₅ | Ni₈₀Fe₂₀ |
| | | 260 | 39.2 | | | | | |
| | | 300 | 42.4 | | | | | |
| | | 350 | 42.6 | | | (Co₉₀Fe₁₀)₉₀Pt₅Mn₅ | (Fe_{58.5}Ni_{43.5})_{85.7}Ir_{14.3} | Ni_{78.9}Fe_{21.1} |
| | | 400 | 38.1 | | | (Co₉₀Fe₁₀)₈₅Pt₁₀Mn₅ | (Fe_{53.1}Ni_{46.9})_{86.5}Ir_{13.5} | Ni_{77.8}Fe_{22.2} |
| 150 | d) | r.t. | 16.9 | (Co₅₀Fe₅₀)₇₁Pt₂₉ | (Co₆₀Fe₅₀)₇₁Pt₂₉ | (Co₉₀Fe₁₀)_{90.5}Mn_{9.5} | | |
| | | 260 | 37.8 | | | | | |
| | | 300 | 38.2 | | | | | |
| | | 350 | 38.1 | | | (Co₉₀Fe₁₀)₈₁Pt_{9.5}Mn_{9.5} | (Fe_{55.9}Ni_{44.1})_{72.4}Ir_{27.6} | Ni_{78.9}Fe_{21.1} |
| | | 400 | 37.9 | | | (Co₉₀Fe₁₀)_{71.5}Pt₁₉Mn_{9.5} | (Fe_{51.9}Ni_{48.1})_{73.9}Ir_{26.1} | Ni_{77.8}Fe_{22.2} |
| 151 | d) | r.t. | 15.2 | (Co₅₀Fe₅₀)₄₁Pt₅₉ | (Co₅₀Fe₅₀)₄₁Pt₅₉ | (Co₉₀Fe₁₀)_{80.5}Mn_{19.5} | (Fe₆₀Ni₄₀)₄₁Ir₅₉ | Ni₈₀Fe₂₀ |
| | | 260 | 34.3 | | | | | |
| | | 300 | 34.5 | | | | | |
| | | 350 | 33.6 | | | (Co₉₀Fe₁₀)₆₁Pt_{19.5}Mn_{19.5} | (Fe_{53.2}Ni_{46.8})_{43.9}Ir_{56.1} | Ni_{78.9}Fe_{21.1} |
| | | 400 | 33.1 | | | (Co₉₀Fe₁₀)_{41.5}Pt₃₉Mn_{19.5} | (Fe_{47.2}Ni_{51.8})_{46.9}Ir_{53.1} | Ni_{77.8}Fe_{22.2} |
| 152 | d) | r.t. | 13.2 | (Co₅₀Fe₅₀)₃₈Pt₆₂ | (Co₅₀Fe₅₀)₃₈Pt₆₂ | (Co₉₀Fe₁₀)₇₈Mn₂₁ | (Fe₆₀Ni₄₀)₃₃Ir₆₇ | Ni₈₀Fe₂₀ |
| | | 260 | 25.9 | | | | | |
| | | 300 | 26.3 | | | | | |
| | | 350 | 14.2 | | | (Co₉₀Fe₁₀)₅₈Pt₂₁Mn₂₁ | (Fe_{51.8}Ni_{48.2})_{36.3}Ir_{63.7} | Ni_{78.9}Fe_{21.1} |
| | | 400 | 12.5 | | | (Co₉₀Fe₁₀)₃₇Pt₄₂Mn₂₁ | (Fe_{44.9}Ni_{55.1})_{39.7}Ir_{60.3} | Ni_{77.8}Fe_{22.2} |

| | | Heat | | | | | |
|---|---|---|---|---|---|---|---|
| | | treat- | | | | | |
| | | ment | | | | | |
| | | tem- | | | | | |
| | | per- | | | | | |
| | Element | ature | MR | | | | |
| Sample No. | type | (° C.) | (%) | Composition 6 | Composition 7 | Composition 8 | Composition 9 |
| 145 | d) | r.t. | 15.1 | Fe₆₀Ni₄₀ | Co₉₀Fe₁₀ | Co₅₀Fe₅₀ | Co₅₀Fe₅₀ |
| | | 260 | 32.1 | | | | |
| | | 300 | 34.1 | | | | |
| | | 350 | 10.1 | (Fe₅₇Ni₄₃)_{99.8}Ir_{0.2} | (Co₉₀Fe₁₀)_{99.8}Pt_{0.1}Mn_{0.1} | | |
| | | 400 | 8.5 | (Fe₅₄Ni₄₆)_{99.8}Ir_{0.2} | (Co₉₀Fe₁₀)_{99.7}Pt_{0.2}Mn_{0.1} | | |
| 146 | d) | r.t. | 15.3 | (Fe₈₀Ni₄₀)_{99.8}Ir_{0.2} | (Co₉₀Fe₁₀)_{99.8}Mn_{0.1} | (Co₅₀Fe₅₀)_{99.8}Pt_{0.2} | (Co₅₀Fe₅₀)_{99.8}Pt_{0.2} |
| | | 260 | 32.4 | | | | |
| | | 300 | 34.3 | | | | |
| | | 350 | 11.1 | (Fe₅₇Ni₄₃)_{99.8}Ir_{0.2} | (Co₉₀Fe₁₀)_{99.8}Pt_{0.15}Mn_{0.15} | | |
| | | 400 | 9.5 | (Fe₅₄Ni₄₆)_{99.8}Ir_{0.2} | (Co₉₀Fe₁₀)_{99.7}Pt_{0.3}Mn_{0.15} | | |
| 147 | d) | r.t. | 15.5 | (Fe₆₀Ni₄₀)_{99.7}Ir_{0.3} | (Co₉₀Fe₁₀)_{99.85}Mn_{0.15} | (Co₅₀Fe₅₀)_{99.7}Pt_{0.3} | (Co₅₀Fe₅₀)_{99.7}Pt_{0.3} |
| | | 260 | 33.1 | | | | |
| | | 300 | 35.2 | | | | |
| | | 350 | 28.4 | (Fe₅₇Ni₄₃)_{99.8}Ir_{0.2} | (Co₉₀Fe₁₀)_{99.7}Pt_{0.15}Mn_{0.15} | | |
| | | 400 | 24.6 | (Fe₅₄Ni₄₆)_{99.8}Ir_{0.2} | (Co₉₀Fe₁₀)_{99.55}Pt_{0.3}Mn_{0.15} | | |
| 148 | d) | r.t. | 16.3 | (Fe₆₀Ni₄₀)₉₇Ir₃ | (Co₉₀Fe₁₀)₉₉Mn₁ | (Co₅₀Fe₅₀)₉₇Pt₃ | (Co₅₀Fe₅₀)₉₇Pt₃ |
| | | 260 | 35.2 | | | | |
| | | 300 | 36.7 | | | | |
| | | 350 | 32.8 | (Fe_{56.9}Ni_{43.1})_{97.1}Ir_{2.9} | (Co₉₀Fe₁₀)₉₈Pt₁Mn₁ | | |
| | | 400 | 29.9 | (Fe_{53.8}Ni_{46.2})_{97.3}Ir_{2.7} | (Co₉₀Fe₁₀)₉₇Pt₂Mn₁ | | |
| 149 | d) | r.t. | 17.5 | (Fe₆₀Ni₄₀)₈₅Ir₁₅ | (Co₉₀Fe₁₀)₈₅Mn₅ | (Co₅₀Fe₅₀)₈₅Pt₁₅ | (Co₅₀Fe₅₀)₈₅Pt₁₅ |
| | | 260 | 39.2 | | | | |
| | | 300 | 42.4 | | | | |
| | | 350 | 42.6 | (Fe_{56.5}Ni_{43.5})_{85.7}Ir_{14.3} | (Co₉₀Fe₁₀)₉₀Pt₁Mn₅ | | |
| | | 400 | 38.1 | (Fe_{53.1}Ni_{46.9})_{86.5}Ir_{13.5} | (Co₉₀Fe₁₀)₈₅Pt₁₀Mn₅ | | |
| 150 | d) | r.t. | 16.9 | (Fe₆₀Ni₄₀)₇₁Ir₂₉ | (Co₉₀Fe₁₀)_{90.5}Mn_{9.5} | (Co₅₀Fe₅₀)₇₁Pt₂₉ | (Co₅₀Fe₅₀)₇₁Pt₂₉ |
| | | 260 | 37.8 | | | | |
| | | 300 | 38.2 | | | | |
| | | 350 | 38.1 | (Fe_{55.9}Ni_{44.1})_{72.4}Ir_{27.6} | (Co₉₀Fe₁₀)₈₁Pt_{9.5}Mn_{9.5} | | |
| | | 400 | 37.9 | (Fe_{51.9}Ni_{48.1})_{73.9}Ir_{26.1} | (Co₉₀Fe₁₀)_{71.5}Pt₁₉Mn_{9.5} | | |
| 151 | d) | r.t. | 15.2 | (Fe₆₀Ni₄₀)₄₁Ir₅₉ | (Co₉₀Fe₁₀)_{80.5}Mn_{19.5} | (Co₅₀Fe₅₀)₄₁Pt₅₉ | (Co₅₀Fe₅₀)₄₁Pt₅₉ |
| | | 260 | 34.3 | | | | |
| | | 300 | 34.5 | | | | |
| | | 350 | 33.6 | (Fe_{53.2}Ni_{46.8})_{43.9}Ir_{56.1} | (Co₉₀Fe₁₀)₆₁Pt_{19.5}Mn_{19.5} | | |
| | | 400 | 33.1 | (Fe_{47.2}Ni_{51.8})_{46.9}Ir_{53.1} | (Co₉₀Fe₁₀)_{41.5}Pt₃₉Mn_{19.5} | | |
| 152 | d) | r.t. | 13.2 | (Fe₆₀Ni₄₀)₄₁Ir₅₉ | (Co₉₀Fe₁₀)₇₉Mn₂₁ | (Co₅₀Fe₅₀)₃₈Pt₆₂ | (Co₅₀Fe₅₀)₃₈Pt₆₂ |
| | | 260 | 25.9 | | | | |
| | | 300 | 26.3 | | | | |
| | | 350 | 14.2 | (Fe_{51.8}Ni_{48.2})_{36.3}Ir_{63.7} | (Co₉₀Fe₁₀)₅₈Pt₂₁Mn₂₁ | | |
| | | 400 | 12.5 | (Fe_{44.9}Ni_{55.1})_{39.7}Ir_{60.3} | (Co₉₀Fe₁₀)₃₇Pt₄₂Mn₂₁ | | |

TABLE 8d)

| | | Heat | | | | | | | | | | |
|---|---|---|---|---|---|---|---|---|---|---|---|---|
| | | treat- | | | | | | | | | | |
| | | ment | | | | | | | | | | |
| | | tem- | | | | | | | | | | |
| | | per- | | | | | | | | | | |
| | Element | ature | MR | | | | | | | | | |
| Sample No. | type | (° C.) | (%) | Composition 1 | Composition 2 | Composition 3 | Composition 4 | Composition 5 | Composition 6 | Composition 7 | Composition 8 | |
| 153 | c) | r.t. | 17.2 | Co₅₀Fe₅₀ | Ni₅₀Fe₅₀ | Ni₅₀Fe₅₀ | Ni₅₀Fe₅₀ | Ni₈₀Fe₂₀ | Co₇₅Fe₂₅ | Co₇₅Pt₂₅ | Co₇₅Fe₂₅ | Co₅₀Pd₅₀ |
| | | 260 | 30.4 | | | | | | | | | |
| | | 300 | 31.3 | | | | | | | | | |
| | | 350 | 16.7 | | | | | | | | | |
| | | 400 | 12.2 | | | | | | | | | |
| 154 | c) | r.t. | 17.3 | Co₅₀Fe₅₀ | Ni₅₀Fe₅₀ | (Ni₅₀Fe₅₀)_{99.8}Pt_{0.2} | Ni₅₀Fe₅₀ | Ni₈₀Fe₂₀ | Co₇₅Fe₂₅ | (Co₇₅Fe₂₅)_{99.8}Pt_{0.14}Mn_{0.03}Cr_{0.03} | Co₇₅Fe₂₅ | Co₅₀Pd₅₀ |
| | | 260 | 30.6 | | | | | | | | | |
| | | 300 | 31.1 | | | | | | | | | |
| | | 350 | 16.5 | | | | | | | | | |
| | | 400 | 13.1 | | | | | | | | | |
| 155 | c) | r.t. | 17.5 | Co₅₀Fe₅₀ | Ni₅₀Fe₅₀ | (Ni₅₀Fe₅₀)_{99.7}Pt_{0.3} | Ni₅₀Fe₅₀ | Ni₈₀Fe₂₀ | Co₇₅Fe₂₅ | (Co₇₅Fe₂₅)_{99.7}Pt_{0.2}Mn_{0.05}Cr_{0.05} | Co₇₅Fe₂₅ | Co₅₀Pd₅₀ |
| | | 260 | 31.2 | | | | | | | | | |
| | | 300 | 32.4 | | | | | | | | | |
| | | 350 | 27.6 | | | | | | | | | |
| | | 400 | 25.8 | | | | | | | | | |
| 156 | c) | r.t. | 18.2 | Co₅₀Fe₅₀ | Ni₅₀Fe₅₀ | (Ni₅₀Fe₅₀)₉₇Pt₃ | Ni₅₀Fe₅₀ | Ni₈₀Fe₂₀ | Co₇₅Fe₂₅ | (Co₇₅Fe₂₅)₉₇Pt₂Mn_{0.5}Cr_{0.5} | Co₇₅Fe₂₅ | Co₅₀Pd₅₀ |
| | | 260 | 32.9 | | | | | | | | | |
| | | 300 | 33.4 | | | | | | | | | |
| | | 350 | 31.3 | | | | | | | | | |
| | | 400 | 31.1 | | | | | | | | | |
| 157 | c) | r.t. | 17.9 | Co₅₀Fe₅₀ | Ni₅₀Fe₅₀ | (Ni₅₀Fe₅₀)₈₅Pt₁₅ | Ni₅₀Fe₅₀ | Ni₈₀Fe₂₀ | Co₇₅Fe₂₅ | (Co₇₅Fe₂₅)₈₅Pt₁₀Mn_{2.5}Cr_{2.5} | Co₇₅Fe₂₅ | Co₅₀Pd₅₀ |
| | | 260 | 30.5 | | | | | | | | | |
| | | 300 | 31.1 | | | | | | | | | |
| | | 350 | 32.2 | | | | | | | | | |
| | | 400 | 32.7 | | | | | | | | | |
| 158 | c) | r.t. | 17.5 | Co₅₀Fe₅₀ | Ni₅₀Fe₅₀ | (Ni₅₀Fe₅₀)₇₁Pt₂₉ | Ni₅₀Fe₅₀ | Ni₈₀Fe₂₀ | Co₇₅Fe₂₅ | (Co₇₅Fe₂₅)₇₁Pt₁₉Mn₅Cr₅ | Co₇₅Fe₂₅ | Co₅₀Pd₅₀ |
| | | 260 | 29.3 | | | | | | | | | |
| | | 300 | 29.7 | | | | | | | | | |
| | | 350 | 31.3 | | | | | | | | | |
| | | 400 | 31.5 | | | | | | | | | |
| 159 | c) | r.t. | 15.6 | Co₅₀Fe₅₀ | Ni₅₀Fe₅₀ | (Ni₅₀Fe₅₀)₄₁Pt₅₉ | Ni₅₀Fe₅₀ | Ni₈₀Fe₂₀ | Co₇₅Fe₂₅ | (Co₇₅Fe₂₅)₄₁Pt₃₉Mn₁₀Cr₁₀ | Co₇₅Fe₂₅ | Co₅₀Pd₅₀ |
| | | 260 | 25.4 | | | | | | | | | |
| | | 300 | 26 | | | | | | | | | |
| | | 350 | 27.9 | | | | | | | | | |
| | | 400 | 26.1 | | | | | | | | | |
| 160 | c) | r.t. | 12.1 | Co₅₀Fe₅₀ | Ni₅₀Fe₅₀ | (Ni₅₀Fe₅₀)₃₈Pt₆₂ | Ni₅₀Fe₅₀ | Ni₈₀Fe₂₀ | Co₇₅Fe₂₅ | (Co₇₅Fe₂₅)₃₈Pt₄₁Mn_{10.5}Cr_{10.5} | Co₇₅Fe₂₅ | Co₅₀Pd₅₀ |
| | | 260 | 20.4 | | | | | | | | | |
| | | 300 | 21.7 | | | | | | | | | |
| | | 350 | 17.2 | | | | | | | | | |
| | | 400 | 13.5 | | | | | | | | | |

In the samples shown in Table 5a), Re is added to the vicinity of each of the interfaces of the non-magnetic layer. According to Table 5a), it is preferable that Re has a concentration of 3 to 30 at %. However, the Mn diffusion is not suppressed here. One of the reasons for this is that Re is not added to the vicinity of the interface with the antiferromagnetic layer. The same tendency can be obtained by replacing Re with Ru, Os, Rh, Ir, Pd, Pt, Cu, Au or the like. Moreover, the same tendency can be obtained by modifying the ferromagnetic layers to the above compositions.

In the samples shown in Table 5b), another element is added to both sides of the non-magnetic layer. This can provide the same effect as well. Moreover, the same effect can be obtained by replacing Ru in Table 5b) with Tc, Re, Rh, Ir, Pd, Pt, Ag or Au and replacing Os with Tc, Re, Rh, Ir, Pd, Pt, Cu or Au. The modification of the ferromagnetic layers to the above compositions also can provide the same tendency.

In the samples shown in Table 5c), Pt and Cu are added only to one of the interfaces of the non-magnetic layer. This can provide the same tendency as well. Moreover, the same tendency can be obtained by replacing (Pt, Cu) in Table 5c) with Tc, Re, Rh, Ir, Pd, Pt, Ag, Au, (Ru, Ir), (Pt, Pd), (Pt, Au), (Ir, Rh), (Ru, Pd), (Tc, Re, Ag), (Ru, Os, Ir), (Rh, Ir, Pt), (Pd, Pt, Cu), (Cu, Ag, Au), (Re, Ru, Os), (Ru, Rh, Pd), (Ir, Pt, Cu) or (Re, Ir, Ag). The modification of the ferromagnetic layers to the above compositions also can provide the same tendency.

Tables 5d) to 8a) show the results obtained when Mn and Pt are added. Table 5d) corresponds to the addition of Mn in an amount of zero at %. Tables 6a) to 8a) show the results of a change in amount of Pt according to the addition of Mn in an amount of 0.2, 0.5, 1, 2, 5, 8, 12, 19 or 22 at %.

There is a little Mn, which is diffused from the antiferromagnetic layer, at the interface in a region containing a small amount of Pt. However, the diffusion can be suppressed by adding Pt.

Tables 8b) to 8d) show the measurements on elements, each having a plurality of non-magnetic layers. Even if a plurality of barriers are present due to the non-magnetic layers, the MR characteristics after heat treatment can be improved by controlling the composition in the vicinity of either of the interfaces of at least one of the non-magnetic layers.

Table 9a) shows the ratios of MR ratios of each sample including Mn and Pt after heat treatment at 350° C. and 400° C. to MR ratios of a sample to which neither Mn nor Pt is added (i.e., the sample 57).

In Table 9a), the amounts of Pt and (Pt+Mn) correspond to the amount of each element in the composition 4 of a sample before heat treatment.

Table 9b) shows the ratios of MR ratios of each sample to MR ratios of a sample in which the amount of Pt is zero for each addition of Mn.

Favorable characteristics were obtained when the amount of addition of Pt was 0.3 to 60 at % and that of Mn was not more than 20 at %, particularly in the range of Mn<Pt. It was confirmed that the characteristics might be more improved by simultaneously adding Mn and Pt than by adding Pt alone in a region where Mn was 8 to 5 at % or less and Mn<Pt. The same tendency was obtained by an element to which Cr or (Mn, Cr) was added with a ratio from 1:0.01 to 1:100 instead of Mn. Moreover, the same tendency was obtained by adding the elements used in Tables 4a) to 5c) instead of Pt. Further, the same tendency was obtained by using the ferromagnetic layers in Table 4.

Some elements (not shown in Tables 4a) to 9b)), each having a composition between the samples shown in Tables, were produced. These elements also had the same tendency.

Tables 4a) to 9b) show the results of heat treatment up to 400° C. However, some samples were heat-treated at 400° C. to 540° C. in increments of 10° C., thus measuring the MR characteristics. Consequently, the magnetoresistive element that included the additional element M¹ such as Pt in an amount of 0.3 to 60 at % had excellent MR characteristics after heat treatment up to 450° C. as compared with the element that did not include the element M¹. In particular, when the amount of addition was 3 to 30 at %, excellent MR characteristics were obtained after heat treatment up to 500° C. as compared with the element that did not include the element M¹.

The same measurement was performed on the element to which Mn and Cr (the additional element M²) were added simultaneously with M¹. Consequently, the magnetoresistive element that included 0.3 to 60 at % of M¹ and achieved M²<M¹ had relatively excellent MR characteristics after heat treatment up to 450° C. Moreover, the element that included 3 to 30 at % of M¹ and less than 8 at % of M² and achieved M²<M¹ had relatively excellent MR characteristics after heat treatment up to 500° C. as compared with the element that included neither M¹ and M².

The above description shows the results obtained when a AlOx film formed with natural oxidation is used as the non-magnetic layer. However, the same tendency can be obtained by using the following films as the non-magnetic layer: AlO with plasma oxidation; AlO with ion radical oxidation; AlO with reactive evaporation; AlN with natural nitridation; AlN with plasma nitridation; AlN with reactive evaporation; BN with plasma nitridation or reactive evaporation; TaO with thermal oxidation, plasma oxidation, or ion radical oxidation; AlSiO with thermal oxidation, natural oxidation, or plasma oxidation; and AlON with natural oxynitridation, plasma oxynitridation, or reactive sputtering.

The same tendency can be obtained by using FeMn, NiMn, IrMn, PtMn, RhMn, CrMnPt, CrAl, CrRu, CrRh, CrOs, CrIr, CrPt, or ThCo as the antiferromagnetic layer instead of PdPtMn.

The same tendency can be obtained by using Rh (thickness: 0.4 to 1.9 nm), Ir (0.3 to 1.4 nm), or Cr (0.9 to 1.4 nm) as the non-magnetic metal instead of Ru (0.7 to 0.9 nm).

Basically the same tendency can be obtained from each of the elements having the configurations shown in the drawings.

### Example 3

In this example, magnetoresistive elements were produced by the same methods of film forming and processing as those in Examples 1 and 2. The composition was measured in the same manner as that in Example 2.

A AlON film (thickness: 1.0 to 2 nm) was used as the non-magnetic layer. The AlON film was produced by oxynitriding an Al film in a chamber filled with a mixed gas of pure oxygen and high purity nitrogen with a radio of 1:1. Rh (1.4 to 1.9 nm) was used as the non-magnetic metal film, and PtMn (20 to 30 nm) was used as the antiferromagnetic layer.

The element configuration and the ferromagnetic layers were the same as those of the samples shown in Tables 5d) to 8a). In this example, the effect of adding Ta and N was measured in addition to Pt and Mn.

Like Example 2, the characteristics after heat treatment up to 540° C. were examined. Here, the measurements at 350° C. and 400° C., both indicating distinctive features, were described. In this example, a coercive force of the free layer was measured as the magnetic characteristics. Tables 10 to 22 plot the coercive force against the composition of elements added to each of the interfaces.

The magnetic characteristics of the samples whose coercive forces are not shown in Tables cannot be measured. The addition of Ta and N improves the soft magnetic characteristics. However, when the amount of non-magnetic additives is not less than about 70 at %, it is impossible to measure the magnetic characteristics.

The MR characteristics of the samples in Tables 10, 11, 12, 15, 16, 19 and 20 are within ±10% after heat treatment, compared with the element that does not include Ta and N. The MR characteristics of the samples in Tables 13, 17 and 21 are degraded by about 10 to 20%, and those of the samples in Tables 14, 18 and 22 are degraded by about 50 to 60%.

The same tendency can be obtained by replacing Ta with Ti, Zr, Hf, V, Nb, Mo, W, Al, Si, Ga, Ge, In or Sn. Moreover, the same tendency can be obtained by replacing N with B, C or O.

### Example 4

In this example, magnetoresistive elements were produced by the same method of film forming and processing as those in Examples 1 and 2. The composition was measured in the same manner as that in Example 2.

A AlOx film (thickness: 1.0 to 2 nm) was used as the non-magnetic layer. The AlOx film was produced by oxidizing an Al film with an ion radical source of O. Ir (1.2 to 1.4 nm) was used as the non-magnetic metal layer, and NiMn (30 to 40 nm) was used as the antiferromagnetic layer.

The element configuration and the ferromagnetic layers were the same as those of the samples shown in Tables 4 to 8. In this example, Pt, Pr and Au were added to examine the MR characteristics after each of the heat treatments and the stability of solid solution.

The solid solution was evaluated in the following manner. First, the elements were heat-treated at different temperatures of 350° C., 400° C., 450° C. and 500° C. Then, the composition at the interfaces of the non-magnetic layer of each of the elements was determined, e.g., by XPS analysis after AES depth profile, SIMS, and milling. Next, alloy samples having the composition thus determined was produced separately, which then were heat-treated in the atmosphere of a reduced pressure (10⁻⁵ Pa) at 350° C., 400° C., 450° C. and 500° C. for 24 hours. The surfaces of the alloy samples were etched chemically and observed with a metallurgical microscope. After etching, ion milling was performed in the atmosphere of a reduced pressure, followed by structural observation with a scanning electron microscope (SEM) and in-plane composition analysis with EDX. Finally, the alloy samples were evaluated whether they had a single phase based on the measurements.

When composition distribution and a plurality of phases were observed in the alloy sample, whose heat treatment temperature and composition corresponded to those of the magnetoresistive element, the MR characteristics of this element were improved by about 30 to 100%, compared with the element that did not include M¹ or the like. When the alloy sample showed a single phase, the MR characteristics of the corresponding element were improved by about 80 to 200%, compared with the element that included no additional element. The element that corresponded to the alloy sample having a stable single phase provided even more favorable MR characteristics after heat treatment.

### Example 5

Using the samples in Tables 4d), 5a), 5c), and 5d) of Example 2, the diffusion effect of Mn observed after heat treatment was controlled by appropriately changing the distance between the interface of antiferromagnetic layer/ferromagnetic layer and the interface of ferromagnetic layer/non-magnetic layer and heat treatment temperatures. Here, the heat treatment temperature was 300° C. or more. This control was performed so that Mn at the interfaces of the non-magnetic layer was 20 to 0.5 at % after heat treatment. When the distance was less than 3 nm, the content of the magnetic elements (Fe, Co, Ni) was reduced to 40 at % or less after heat treatment even with the addition of Pt or the like, resulting in a significant degradation of the MR characteristics. When the distance was more than 50 nm, heat treatment at 400° C. or more was required only for increasing the content of Mn at the interfaces by 0.5 at %. Since the distance was too long, a sufficient effect of fixing the magnetization directions of the ferromagnetic layers was not obtained from the antiferromagnetic layer, resulting in a significant degradation of the MR characteristics after heat treatment.

TABLE 9a)

| | Amount of Mn | | 1 | 2 | 3 | 4 | 5 | 6 | 7 | 8 |
|---|---|---|---|---|---|---|---|---|---|---|
| TABLE | 0 | Amount of Pt | 0 | 0.2 | 0.3 | 3 | 15 | 29 | 59 | 62 |
| 5d) | | Amount of Pt + Mn | 0 | 0.2 | 0.3 | 3 | 15 | 29 | 59 | 62 |
| | | 350° C. | 1 | 1.02 | 1.44 | 1.52 | 1.61 | 1.54 | 1.46 | 0.98 |
| | | 400° C. | 1 | 1.02 | 1.92 | 1.99 | 2.45 | 2.21 | 1.95 | 1.05 |
| TABLE | 0.2 | Amount of Pt | 0 | 0.2 | 0.3 | 2.8 | 14.8 | 28.8 | 58.8 | 61.8 |
| 6a) | | Amount of Pt + Mn | 0.2 | 0.4 | 0.5 | 3 | 15 | 29 | 59 | 62 |
| | | 350° C. | 1 | 1.03 | 1.56 | 1.78 | 1.81 | 1.68 | 1.51 | 0.99 |
| | | 400° C. | 1 | 1.03 | 2.21 | 2.43 | 2.62 | 2.51 | 2.27 | 1.06 |
| TABLE | 0.5 | Amount of Pt | 0 | 0.2 | 0.3 | 2.5 | 14.5 | 28.5 | 58.5 | 61.5 |
| 6b) | | Amount of Pt + Mn | 0.5 | 0.7 | 0.8 | 3 | 15 | 29 | 59 | 62 |
| | | 350° C. | 1 | 1.01 | 1.46 | 1.77 | 1.97 | 1.9 | 1.74 | 1 |
| | | 400° C. | 1 | 1.01 | 1.98 | 2.42 | 2.73 | 2.71 | 2.5 | 1.06 |
| TABLE | 1 | Amount of Pt | 0 | 0.2 | 0.3 | 2 | 14 | 28 | 58 | 61 |
| 6c) | | Amount of Pt + Mn | 1 | 1.2 | 1.3 | 3 | 15 | 29 | 59 | 62 |
| | | 350° C. | 1 | 1.01 | 1.45 | 1.76 | 2.07 | 1.96 | 1.84 | 1.04 |
| | | 400° C. | 1 | 1.01 | 1.91 | 2.4 | 2.9 | 2.81 | 2.61 | 1.1 |
| TABLE | 2 | Amount of Pt | 0 | 0.2 | 0.3 | 2 | 13 | 27 | 57 | 60 |
| 6d) | | Amount of Pt + Mn | 2 | 2.2 | 2.3 | 4 | 15 | 29 | 59 | 62 |
| | | 350° C. | 1 | 1.01 | 1.44 | 1.76 | 2.17 | 2.06 | 1.98 | 1.06 |
| | | 400° C. | 1 | 1.01 | 1.9 | 2.39 | 3.13 | 2.98 | 2.81 | 1.12 |
| TABLE | 5 | Amount of Pt | 0 | 0.2 | 0.3 | 2 | 10 | 24 | 54 | 57 |
| 7a) | | Amount of Pt + Mn | 5 | 5.2 | 5.3 | 7 | 15 | 29 | 59 | 62 |
| | | 350° C. | 1 | 1.01 | 1.43 | 1.7 | 2.16 | 1.98 | 1.86 | 1.05 |
| | | 400° C. | 1 | 1.01 | 1.89 | 2.21 | 3.04 | 2.92 | 2.73 | 1.11 |
| TABLE | 8 | Amount of Pt | 0 | 0.2 | 0.3 | 2 | 7 | 21 | 51 | 54 |
| 7b) | | Amount of Pt + Mn | 8 | 8.2 | 8.3 | 10 | 15 | 29 | 59 | 62 |
| | | 350° C. | 1 | 1.01 | 1.39 | 1.6 | 1.8 | 1.69 | 1.59 | 1.02 |
| | | 400° C. | 1 | 1.01 | 1.8 | 2.09 | 2.6 | 2.38 | 2.27 | 1.07 |
| TABLE | 12 | Amount of Pt | 0 | 0.2 | 0.3 | 2 | 7 | 17 | 47 | 50 |
| 7c) | | Amount of Pt + Mn | 12 | 12.2 | 12.3 | 14 | 19 | 29 | 59 | 62 |
| | | 350° C. | 1 | 1.01 | 1.38 | 1.51 | 1.6 | 1.58 | 1.47 | 1 |
| | | 400° C. | 1 | 1.01 | 1.77 | 2 | 2.2 | 2.17 | 2 | 1.02 |
| TABLE | 19 | Amount of Pt | 0 | 0.2 | 0.3 | 2 | 7 | 10 | 40 | 43 |
| 7d) | | Amount of Pt + Mn | 19 | 19.2 | 19.3 | 21 | 26 | 29 | 59 | 62 |
| | | 350° C. | 1 | 1 | 1.36 | 1.41 | 1.52 | 1.44 | 1.33 | 0.94 |
| | | 400° C. | 1 | 1 | 1.71 | 1.8 | 1.95 | 1.87 | 1.71 | 0.99 |
| TABLE | 22 | Amount of Pt | 0 | 0.2 | 0.3 | 2 | 7 | 10 | 37 | 40 |
| 8a) | | Amount of Pt + Mn | 22 | 22.2 | 22.3 | 24 | 29 | 32 | 59 | 62 |
| | | 350° C. | 1 | 0.99 | 1.1 | 1.11 | 1.13 | 1.1 | 1.01 | 0.86 |
| | | 400° C. | 1 | 0.99 | 1.16 | 1.19 | 1.21 | 1.2 | 0.99 | 1.01 |

TABLE 9b)

| | Amount of Mn | | 1 | 2 | 3 | 4 | 5 | 6 | 7 | 8 |
|---|---|---|---|---|---|---|---|---|---|---|
| TABLE | 0 | Amount of Pt | 0 | 0.2 | 0.3 | 3 | 15 | 29 | 59 | 62 |
| 5d) | | Amount of Pt + Mn | 0 | 0.2 | 0.3 | 3 | 15 | 29 | 59 | 62 |
| | | 350° C. | 1 | 1.02 | 1.44 | 1.52 | 1.61 | 1.54 | 1.46 | 0.98 |
| | | 400° C. | 1 | 1.02 | 1.92 | 1.99 | 2.45 | 2.21 | 1.95 | 1.05 |
| TABLE | 0.2 | Amount of Pt | 0 | 0.2 | 0.3 | 2.8 | 14.8 | 28.8 | 58.8 | 61.8 |
| 6a) | | Amount of Pt + Mn | 0.2 | 0.4 | 0.5 | 3 | 15 | 29 | 59 | 62 |
| | | 350° C. | 1 | 1.03 | 1.56 | 1.78 | 1.81 | 1.68 | 1.51 | 0.99 |
| | | 400° C. | 1 | 1.03 | 2.21 | 2.43 | 2.62 | 2.51 | 2.27 | 1.06 |
| TABLE | 0.5 | Amount of Pt | 0 | 0.2 | 0.3 | 2.5 | 14.5 | 28.5 | 58.5 | 61.5 |
| 6b) | | Amount of Pt + Mn | 0.5 | 0.7 | 0.8 | 3 | 15 | 29 | 59 | 62 |
| | | 350° C. | 1 | 1.01 | 1.46 | 1.77 | 1.97 | 1.9 | 1.74 | 1 |
| | | 400° C. | 1 | 1.01 | 1.98 | 2.42 | 2.73 | 2.71 | 2.5 | 1.06 |
| TABLE | 1 | Amount of Pt | 0 | 0.2 | 0.3 | 2 | 14 | 28 | 58 | 61 |
| 6c) | | Amount of Pt + Mn | 1 | 1.2 | 1.3 | 3 | 15 | 29 | 59 | 62 |
| | | 350° C. | 1 | 1.01 | 1.45 | 1.76 | 2.07 | 1.96 | 1.84 | 1.04 |
| | | 400° C. | 1 | 1.01 | 1.91 | 2.4 | 2.9 | 2.81 | 2.61 | 1.1 |
| TABLE | 2 | Amount of Pt | 0 | 0.2 | 0.3 | 2 | 13 | 27 | 57 | 60 |
| 6d) | | Amount of Pt + Mn | 2 | 2.2 | 2.3 | 4 | 15 | 29 | 59 | 62 |
| | | 350° C. | 1 | 1.01 | 1.44 | 1.76 | 2.17 | 2.06 | 1.98 | 1.06 |
| | | 400° C. | 1 | 1.01 | 1.9 | 2.39 | 3.13 | 2.98 | 2.81 | 1.12 |
| TABLE | 5 | Amount of Pt | 0 | 0.2 | 0.3 | 2 | 10 | 24 | 54 | 57 |
| 7a) | | Amount of Pt + Mn | 5 | 5.2 | 5.3 | 7 | 15 | 29 | 59 | 62 |
| | | 350° C. | 1 | 1.01 | 1.43 | 1.7 | 2.16 | 1.98 | 1.86 | 1.05 |
| | | 400° C. | 1 | 1.01 | 1.89 | 2.21 | 3.04 | 2.92 | 2.73 | 1.11 |
| TABLE | 8 | Amount of Pt | 0 | 0.2 | 0.3 | 2 | 7 | 21 | 51 | 54 |
| 7b) | | Amount of Pt + Mn | 8 | 8.2 | 8.3 | 10 | 15 | 29 | 59 | 62 |
| | | 350° C. | 1 | 1.01 | 1.39 | 1.6 | 1.8 | 1.69 | 1.59 | 1.02 |
| | | 400° C. | 1 | 1.01 | 1.8 | 2.09 | 2.6 | 2.38 | 2.27 | 1.07 |
| TABLE | 12 | Amount of Pt | 0 | 0.2 | 0.3 | 2 | 7 | 17 | 47 | 50 |
| 7c) | | Amount of Pt + Mn | 12 | 12.2 | 12.3 | 14 | 19 | 29 | 59 | 62 |
| | | 350° C. | 1 | 1.01 | 1.38 | 1.51 | 1.6 | 1.58 | 1.47 | 1 |
| | | 400° C. | 1 | 1.01 | 1.77 | 2 | 2.2 | 2.17 | 2 | 1.02 |
| TABLE | 19 | Amount of Pt | 0 | 0.2 | 0.3 | 2 | 7 | 10 | 40 | 43 |
| 7d) | | Amount of Pt + Mn | 19 | 19.2 | 19.3 | 21 | 26 | 29 | 59 | 62 |
| | | 350° C. | 1 | 1 | 1.36 | 1.41 | 1.52 | 1.44 | 1.33 | 0.94 |
| | | 400° C. | 1 | 1 | 1.71 | 1.8 | 1.95 | 1.87 | 1.71 | 0.99 |
| TABLE | 22 | Amount of Pt | 0 | 0.2 | 0.3 | 2 | 7 | 10 | 37 | 40 |
| 8a) | | Amount of Pt + Mn | 22 | 22.2 | 22.3 | 24 | 29 | 32 | 59 | 62 |
| | | 350° C. | 1 | 0.99 | 1.1 | 1.11 | 1.13 | 1.1 | 1.01 | 0.86 |
| | | 400° C. | 1 | 0.99 | 1.16 | 1.19 | 1.21 | 1.2 | 0.99 | 1.01 |

TABLE 10
(Ta = 0, N = 0)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of additional elements | 0 | 0.2 | 0.3 | 3 | 15 | 29 | 59 | 62 |
| | 350° C. | 98 | 98 | 99 | 113 | 127 | 147 | 196 | 196 |
| | 400° C. | 88 | 88 | 89 | 101 | 115 | 132 | 176 | 176 |
| 0.5 | Amount of Pt | 0 | 0.2 | 0.3 | 2.5 | 14.5 | 28.5 | 58.5 | 61.5 |
| | Total amount of additional elements | 0.5 | 0.7 | 0.8 | 3 | 15 | 29 | 59 | 62 |
| | 350° C. | 97 | 97 | 98 | 112 | 126 | 146 | 194 | 194 |
| | 400° C. | 87 | 87 | 88 | 100 | 114 | 131 | 175 | 175 |
| 1 | Amount of Pt | 0 | 0.2 | 0.3 | 2 | 14 | 28 | 58 | 61 |
| | Total amount of additional elements | 1 | 1.2 | 1.3 | 3 | 15 | 29 | 59 | 62 |
| | 350° C. | 93 | 93 | 94 | 107 | 121 | 140 | 186 | 186 |
| | 400° C. | 84 | 84 | 85 | 96 | 109 | 126 | 168 | 168 |
| 5 | Amount of Pt | 0 | 0.2 | 0.3 | 2 | 10 | 24 | 54 | 57 |
| | Total amount of additional elements | 5 | 5.2 | 5.3 | 7 | 15 | 29 | 59 | 62 |
| | 350° C. | 88 | 88 | 89 | 101 | 115 | 132 | 176 | 176 |
| | 400° C. | 79 | 79 | 80 | 91 | 103 | 119 | 159 | 159 |
| 8 | Amount of Pt | 0 | 0.2 | 0.3 | 2 | 7 | 21 | 51 | 54 |
| | Total amount of additional elements | 8 | 8.2 | 8.3 | 10 | 15 | 29 | 59 | 62 |
| | 350° C. | 93 | 93 | 94 | 107 | 121 | 140 | 186 | 186 |
| | 400° C. | 84 | 84 | 85 | 96 | 109 | 126 | 168 | 168 |
| 19 | Amount of Pt | 0 | 0.2 | 0.3 | 2 | 7 | 10 | 40 | 43 |
| | Total amount of additional elements | 19 | 19.2 | 19.3 | 21 | 26 | 29 | 59 | 62 |
| | 350° C. | 96 | 96 | 97 | 110 | 125 | 144 | 192 | 192 |
| | 400° C. | 86 | 86 | 87 | 99 | 112 | 130 | 173 | 173 |
| 22 | Amount of Pt | 0 | 0.2 | 0.3 | 2 | 7 | 10 | 37 | 40 |
| | Total amount of additional elements | 22 | 22.2 | 22.3 | 24 | 29 | 32 | 59 | 62 |
| | 350° C. | 100 | 100 | 101 | 115 | 130 | 150 | 200 | 200 |
| | 400° C. | 90 | 90 | 91 | 103 | 117 | 135 | 180 | 180 |

TABLE 11
(Ta = 1, N = 0)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of additional elements | 1 | 1.2 | 1.3 | 4 | 16 | 30 | 60 | 63 |
| | 350° C. | 99 | 99 | 100 | 114 | 129 | 149 | 198 | 198 |
| | 400° C. | 89 | 89 | 90 | 102 | 116 | 134 | 178 | 178 |
| 0.5 | Amount of Pt | 0 | 0.2 | 0.3 | 2.5 | 14.5 | 28.5 | 58.5 | 61.5 |
| | Total amount of additional elements | 1.5 | 1.7 | 1.8 | 4 | 16 | 30 | 60 | 63 |
| | 350° C. | 98 | 98 | 99 | 113 | 127 | 147 | 196 | 196 |
| | 400° C. | 88 | 88 | 89 | 101 | 115 | 132 | 176 | 176 |
| 1 | Amount of Pt | 0 | 0.2 | 0.3 | 2 | 14 | 28 | 58 | 61 |
| | Total amount of additional elements | 2 | 2.2 | 2.3 | 4 | 16 | 30 | 60 | 63 |
| | 350° C. | 94 | 94 | 95 | 108 | 122 | 141 | 188 | 188 |
| | 400° C. | 85 | 85 | 85 | 97 | 110 | 127 | 169 | 169 |
| 5 | Amount of Pt | 0 | 0.2 | 0.3 | 2 | 10 | 24 | 54 | 57 |
| | Total amount of additional elements | 6 | 6.2 | 6.3 | 8 | 16 | 30 | 60 | 63 |
| | 350° C. | 89 | 89 | 90 | 102 | 116 | 134 | 178 | 178 |
| | 400° C. | 80 | 80 | 81 | 92 | 104 | 120 | 160 | 160 |
| 8 | Amount of Pt | 0 | 0.2 | 0.3 | 2 | 7 | 21 | 51 | 54 |
| | Total amount of additional elements | 9 | 9.2 | 9.3 | 11 | 16 | 30 | 60 | 63 |
| | 350° C. | 94 | 94 | 95 | 108 | 122 | 141 | 188 | 188 |
| | 400° C. | 85 | 85 | 85 | 97 | 110 | 127 | 169 | 169 |
| 19 | Amount of Pt | 0 | 0.2 | 0.3 | 2 | 7 | 10 | 40 | 43 |
| | Total amount of additional elements | 20 | 20.2 | 20.3 | 22 | 27 | 30 | 60 | 63 |
| | 350° C. | 97 | 97 | 98 | 112 | 126 | 146 | 194 | 194 |
| | 400° C. | 87 | 87 | 88 | 100 | 114 | 131 | 175 | 175 |
| 22 | Amount of Pt | 0 | 0.2 | 0.3 | 2 | 7 | 10 | 37 | 40 |
| | Total amount of additional elements | 23 | 23.2 | 23.3 | 25 | 30 | 33 | 60 | 63 |
| | 350° C. | 101 | 101 | 102 | 116 | 131 | 151 | 202 | 202 |
| | 400° C. | 91 | 91 | 92 | 105 | 118 | 136 | 182 | 182 |

TABLE 12
(Ta = 15, N = 0)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 15 | 15.2 | 15.3 | 18 | 30 | 44 | 74 | 77 |
| | additional elements | | | | | | | | |
| | 350° C. | 58 | 58 | 59 | 67 | 75 | 87 | — | — |
| | 400° C. | 52 | 52 | 53 | 60 | 68 | 78 | — | — |
| 0.5 | Amount of Pt | 0 | 0.2 | 0.3 | 2.5 | 14.5 | 28.5 | 58.5 | 61.5 |
| | Total amount of | 15.5 | 15.7 | 15.8 | 18 | 30 | 44 | 74 | 77 |
| | additional elements | | | | | | | | |
| | 350° C. | 57 | 57 | 58 | 66 | 75 | 86 | — | — |
| | 400° C. | 52 | 52 | 52 | 59 | 67 | 78 | — | — |
| 1 | Amount of Pt | 0 | 0.2 | 0.3 | 2 | 14 | 28 | 58 | 61 |
| | Total amount of | 16 | 16.2 | 16.3 | 18 | 30 | 44 | 74 | 77 |
| | additional elements | | | | | | | | |
| | 350° C. | 55 | 55 | 56 | 63 | 72 | 83 | — | — |
| | 400° C. | 50 | 50 | 50 | 57 | 64 | 74 | — | — |
| 5 | Amount of Pt | 0 | 0.2 | 0.3 | 2 | 10 | 24 | 54 | 57 |
| | Total amount of | 20 | 20.2 | 20.3 | 22 | 30 | 44 | 74 | 77 |
| | additional elements | | | | | | | | |
| | 350° C. | 52 | 52 | 53 | 60 | 68 | 78 | — | — |
| | 400° C. | 47 | 47 | 47 | 54 | 61 | 70 | — | — |
| 8 | Amount of Pt | 0 | 0.2 | 0.3 | 2 | 7 | 21 | 51 | 54 |
| | Total amount of | 23 | 23.2 | 23.3 | 25 | 30 | 44 | 74 | 77 |
| | additional elements | | | | | | | | |
| | 350° C. | 55 | 55 | 56 | 63 | 72 | 83 | — | — |
| | 400° C. | 50 | 50 | 50 | 57 | 64 | 74 | — | — |
| 19 | Amount of Pt | 0 | 0.2 | 0.3 | 2 | 7 | 10 | 40 | 43 |
| | Total amount of | 34 | 34.2 | 34.3 | 36 | 41 | 44 | 74 | 77 |
| | additional elements | | | | | | | | |
| | 350° C. | 57 | 57 | 57 | 65 | 74 | 85 | — | — |
| | 400° C. | 51 | 51 | 52 | 59 | 67 | 77 | — | — |
| 22 | Amount of Pt | 0 | 0.2 | 0.3 | 2 | 7 | 10 | 37 | 40 |
| | Total amount of | 37 | 37.2 | 37.3 | 39 | 44 | 47 | 74 | 77 |
| | additional elements | | | | | | | | |
| | 350° C. | 59 | 59 | 60 | 68 | 77 | 89 | — | — |
| | 400° C. | 53 | 53 | 54 | 61 | 69 | 80 | — | — |

TABLE 13
(Ta = 29, N = 0)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 29 | 29.2 | 29.3 | 32 | 44 | 58 | 88 | 91 |
| | additional elements | | | | | | | | |
| | 350° C. | 22 | 22 | 22 | 25 | 29 | 33 | — | — |
| | 400° C. | 20 | 20 | 20 | 23 | 26 | 30 | — | — |
| 0.5 | Amount of Pt | 0 | 0.2 | 0.3 | 2.5 | 14.5 | 28.5 | 58.5 | 61.5 |
| | Total amount of | 29.5 | 29.7 | 29.8 | 32 | 44 | 58 | 88 | 91 |
| | additional elements | | | | | | | | |
| | 350° C. | 22 | 22 | 22 | 25 | 28 | 33 | — | — |
| | 400° C. | 20 | 20 | 20 | 23 | 25 | 29 | — | — |
| 1 | Amount of Pt | 0 | 0.2 | 0.3 | 2 | 14 | 28 | 58 | 61 |
| | Total amount of | 30 | 30.2 | 30.3 | 32 | 44 | 58 | 88 | 91 |
| | additional elements | | | | | | | | |
| | 350° C. | 21 | 21 | 21 | 24 | 27 | 31 | — | — |
| | 400° C. | 19 | 19 | 19 | 22 | 24 | 28 | — | — |
| 5 | Amount of Pt | 0 | 0.2 | 0.3 | 2 | 10 | 24 | 54 | 57 |
| | Total amount of | 34 | 34.2 | 34.3 | 36 | 44 | 58 | 88 | 91 |
| | additional elements | | | | | | | | |
| | 350° C. | 20 | 20 | 20 | 23 | 26 | 30 | — | — |
| | 400° C. | 18 | 18 | 18 | 20 | 23 | 27 | — | — |
| 8 | Amount of Pt | 0 | 0.2 | 0.3 | 2 | 7 | 21 | 51 | 54 |
| | Total amount of | 37 | 37.2 | 37.3 | 39 | 44 | 58 | 88 | 91 |
| | additional elements | | | | | | | | |
| | 350° C. | 21 | 21 | 21 | 24 | 27 | 31 | — | — |
| | 400° C. | 19 | 19 | 19 | 22 | 24 | 28 | — | — |
| 19 | Amount of Pt | 0 | 0.2 | 0.3 | 2 | 7 | 10 | 40 | 43 |
| | Total amount of | 48 | 48.2 | 48.3 | 50 | 55 | 58 | 88 | 91 |
| | additional elements | | | | | | | | |
| | 350° C. | 22 | 22 | 22 | 25 | 28 | 32 | — | — |
| | 400° C. | 19 | 19 | 20 | 22 | 25 | 29 | — | — |
| 22 | Amount of Pt | 0 | 0.2 | 0.3 | 2 | 7 | 10 | 37 | 40 |
| | Total amount of | 51 | 51.2 | 51.3 | 53 | 58 | 61 | 88 | 91 |
| | additional elements | | | | | | | | |
| | 350° C. | 22 | 22 | 23 | 26 | 29 | 34 | — | — |
| | 400° C. | 20 | 20 | 20 | 23 | 26 | 30 | — | — |

TABLE 14
(Ta = 31, N = 0)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 31 | 31.2 | 31.3 | 34 | 46 | 60 | 90 | 93 |
| | additional elements | | | | | | | | |
| | 350° C. | 18 | 18 | 18 | 21 | 23 | 27 | — | — |
| | 400° C. | 16 | 16 | 16 | 19 | 21 | 24 | — | — |
| 0.5 | Amount of Pt | 0 | 0.2 | 0.3 | 2.5 | 14.5 | 28.5 | 58.5 | 61.5 |
| | Total amount of | 31.5 | 31.7 | 31.8 | 34 | 46 | 60 | 90 | 93 |
| | additional elements | | | | | | | | |
| | 350° C. | 18 | 18 | 18 | 20 | 23 | 27 | — | — |
| | 400° C. | 16 | 16 | 16 | 18 | 21 | 24 | — | — |
| 1 | Amount of Pt | 0 | 0.2 | 0.3 | 2 | 14 | 28 | 58 | 61 |
| | Total amount of | 32 | 322 | 32.3 | 34 | 46 | 60 | 90 | 93 |
| | additional elements | | | | | | | | |
| | 350° C. | 17 | 17 | 17 | 20 | 22 | 26 | — | — |
| | 400° C. | 15 | 15 | 16 | 18 | 20 | 23 | — | — |
| 5 | Amount of Pt | 0 | 0.2 | 0.3 | 2 | 10 | 24 | 54 | 57 |
| | Total amount of | 36 | 36.2 | 36.3 | 38 | 46 | 60 | 90 | 93 |
| | additional elements | | | | | | | | |
| | 350° C. | 16 | 16 | 16 | 19 | 21 | 24 | — | — |
| | 400° C. | 15 | 15 | 15 | 17 | 19 | 22 | — | — |
| 8 | Amount of Pt | 0 | 0.2 | 0.3 | 2 | 7 | 21 | 51 | 54 |
| | Total amount of | 39 | 39.2 | 39.3 | 41 | 46 | 60 | 90 | 93 |
| | additional elements | | | | | | | | |
| | 350° C. | 17 | 17 | 17 | 20 | 22 | 26 | — | — |
| | 400° C. | 15 | 15 | 16 | 18 | 20 | 23 | — | — |
| 19 | Amount of Pt | 0 | 0.2 | 0.3 | 2 | 7 | 10 | 40 | 43 |
| | Total amount of | 50 | 50.2 | 50.3 | 52 | 57 | 60 | 90 | 93 |
| | additional elements | | | | | | | | |
| | 350° C. | 18 | 18 | 18 | 20 | 23 | 26 | — | — |
| | 400° C. | 16 | 16 | 16 | 18 | 21 | 24 | — | — |
| 22 | Amount of Pt | 0 | 0.2 | 0.3 | 2 | 7 | 10 | 37 | 40 |
| | Total amount of | 53 | 53.2 | 53.3 | 55 | 60 | 63 | 90 | 93 |
| | additional elements | | | | | | | | |
| | 350° C. | 18 | 18 | 19 | 21 | 24 | 28 | — | — |
| | 400° C. | 17 | 17 | 17 | 19 | 21 | 25 | — | — |

TABLE 15
(Ta = 0, N = 1)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 1 | 1.2 | 1.3 | 4 | 16 | 30 | 60 | 63 |
| | additional elements | | | | | | | | |
| | 350° C. | 101 | 101 | 102 | 116 | 131 | 152 | 202 | 202 |
| | 400° C. | 91 | 91 | 92 | 105 | 118 | 136 | 182 | 182 |
| 0.5 | Amount of Pt | 0 | 0.2 | 0.3 | 2.5 | 14.5 | 28.5 | 58.5 | 61.5 |
| | Total amount of | 1.5 | 1.7 | 1.8 | 4 | 16 | 30 | 60 | 63 |
| | additional elements | | | | | | | | |
| | 350° C. | 100 | 100 | 101 | 115 | 130 | 150 | 200 | 200 |
| | 400° C. | 90 | 90 | 91 | 103 | 117 | 135 | 180 | 180 |
| 1 | Amount of Pt | 0 | 0.2 | 0.3 | 2 | 14 | 28 | 58 | 61 |
| | Total amount of | 2 | 2.2 | 2.3 | 4 | 16 | 30 | 60 | 63 |
| | additional elements | | | | | | | | |
| | 350° C. | 96 | 96 | 97 | 110 | 125 | 144 | 192 | 192 |
| | 400° C. | 86 | 86 | 87 | 99 | 112 | 130 | 173 | 173 |
| 5 | Amount of Pt | 0 | 0.2 | 0.3 | 2 | 10 | 24 | 54 | 57 |
| | Total amount of | 6 | 62 | 6.3 | 8 | 16 | 30 | 60 | 63 |
| | additional elements | | | | | | | | |
| | 350° C. | 91 | 91 | 92 | 105 | 118 | 136 | 182 | 182 |
| | 400° C. | 82 | 82 | 83 | 94 | 106 | 123 | 164 | 164 |
| 8 | Amount of Pt | 0 | 0.2 | 0.3 | 2 | 7 | 21 | 51 | 54 |
| | Total amount of | 9 | 9.2 | 9.3 | 11 | 16 | 30 | 60 | 63 |
| | additional elements | | | | | | | | |
| | 350° C. | 96 | 96 | 97 | 110 | 125 | 144 | 192 | 192 |
| | 400° C. | 86 | 86 | 87 | 99 | 112 | 130 | 173 | 173 |
| 19 | Amount of Pt | 0 | 0.2 | 0.3 | 2 | 7 | 10 | 40 | 43 |
| | Total amount of | 20 | 20.2 | 20.3 | 22 | 27 | 30 | 60 | 63 |
| | additional elements | | | | | | | | |
| | 350° C. | 99 | 99 | 100 | 114 | 129 | 148 | 198 | 198 |
| | 400° C. | 89 | 89 | 90 | 102 | 116 | 134 | 178 | 178 |
| 22 | Amount of Pt | 0 | 0.2 | 0.3 | 2 | 7 | 10 | 37 | 40 |
| | Total amount of | 23 | 23.2 | 23.3 | 25 | 30 | 33 | 60 | 63 |
| | additional elements | | | | | | | | |
| | 350° C. | 103 | 103 | 104 | 118 | 134 | 155 | 206 | 206 |
| | 400° C. | 93 | 93 | 94 | 107 | 121 | 139 | 185 | 185 |

TABLE 16
(Ta = 0, N = 10)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 10 | 10.2 | 10.3 | 13 | 25 | 39 | 69 | 72 |
| | additional elements | | | | | | | | |
| | 350° C. | 62 | 62 | 63 | 71 | 81 | 93 | — | — |
| | 400° C. | 56 | 56 | 56 | 64 | 73 | 84 | — | — |
| 0.5 | Amount of Pt | 0 | 0.2 | 0.3 | 2.5 | 14.5 | 28.5 | 58.5 | 61.5 |
| | Total amount of | 10.5 | 10.7 | 10.8 | 13 | 25 | 39 | 69 | 72 |
| | additional elements | | | | | | | | |
| | 350° C. | 61 | 61 | 62 | 71 | 80 | 92 | — | — |
| | 400° C. | 55 | 55 | 56 | 64 | 72 | 83 | — | — |
| 1 | Amount of Pt | 0 | 0.2 | 0.3 | 2 | 14 | 28 | 58 | 61 |
| | Total amount of | 11 | 11.2 | 11.3 | 13 | 25 | 39 | 69 | 72 |
| | additional elements | | | | | | | | |
| | 350° C. | 59 | 59 | 59 | 68 | 77 | 88 | — | — |
| | 400° C. | 53 | 53 | 54 | 61 | 69 | 80 | — | — |
| 5 | Amount of Pt | 0 | 0.2 | 0.3 | 2 | 10 | 24 | 54 | 57 |
| | Total amount of | 15 | 15.2 | 15.3 | 17 | 25 | 39 | 69 | 72 |
| | additional elements | | | | | | | | |
| | 350° C. | 56 | 56 | 56 | 64 | 73 | 84 | — | — |
| | 400° C. | 50 | 50 | 51 | 58 | 65 | 75 | — | — |
| 8 | Amount of Pt | 0 | 0.2 | 0.3 | 2 | 7 | 21 | 51 | 54 |
| | Total amount of | 18 | 18.2 | 18.3 | 20 | 25 | 39 | 69 | 72 |
| | additional elements | | | | | | | | |
| | 350° C. | 59 | 59 | 59 | 68 | 77 | 88 | — | — |
| | 400° C. | 53 | 53 | 54 | 61 | 69 | 80 | — | — |
| 19 | Amount of Pt | 0 | 0.2 | 0.3 | 2 | 7 | 10 | 40 | 43 |
| | Total amount of | 29 | 29.2 | 29.3 | 31 | 36 | 39 | 69 | 72 |
| | additional elements | | | | | | | | |
| | 350° C. | 61 | 61 | 61 | 70 | 79 | 91 | — | — |
| | 400° C. | 55 | 55 | 55 | 63 | 71 | 82 | — | — |
| 22 | Amount of Pt | 0 | 0.2 | 0.3 | 2 | 7 | 10 | 37 | 40 |
| | Total amount of | 32 | 32.2 | 32.3 | 34 | 39 | 42 | 69 | 72 |
| | additional elements | | | | | | | | |
| | 350° C. | 63 | 63 | 64 | 73 | 82 | 95 | — | — |
| | 400° C. | 57 | 57 | 57 | 65 | 74 | 85 | — | — |

TABLE 17
(Ta = 0, N = 19)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 19 | 19.2 | 19.3 | 22 | 34 | 48 | 78 | 81 |
| | additional elements | | | | | | | | |
| | 350° C. | 25 | 25 | 25 | 29 | 33 | 38 | — | — |
| | 400° C. | 23 | 23 | 23 | 26 | 29 | 34 | — | — |
| 0.5 | Amount of Pt | 0 | 0.2 | 0.3 | 2.5 | 14.5 | 28.5 | 58.5 | 61.5 |
| | Total amount of | 19.5 | 19.7 | 19.8 | 22 | 34 | 48 | 78 | 81 |
| | additional elements | | | | | | | | |
| | 350° C. | 25 | 25 | 25 | 28 | 32 | 37 | — | — |
| | 400° C. | 22 | 22 | 22 | 26 | 29 | 33 | — | — |
| 1 | Amount of Pt | 0 | 0.2 | 0.3 | 2 | 14 | 28 | 58 | 61 |
| | Total amount of | 20 | 20.2 | 20.3 | 22 | 34 | 48 | 78 | 81 |
| | additional elements | | | | | | | | |
| | 350° C. | 24 | 24 | 24 | 27 | 31 | 36 | — | — |
| | 400° C. | 21 | 21 | 22 | 25 | 28 | 32 | — | — |
| 5 | Amount of Pt | 0 | 0.2 | 0.3 | 2 | 10 | 24 | 54 | 57 |
| | Total amount of | 24 | 24.2 | 24.3 | 26 | 34 | 48 | 78 | 81 |
| | additional elements | | | | | | | | |
| | 350° C. | 23 | 23 | 23 | 26 | 29 | 34 | — | — |
| | 400° C. | 20 | 20 | 20 | 23 | 26 | 30 | — | — |
| 8 | Amount of Pt | 0 | 0.2 | 0.3 | 2 | 7 | 21 | 51 | 54 |
| | Total amount of | 27 | 27.2 | 27.3 | 29 | 34 | 48 | 78 | 81 |
| | additional elements | | | | | | | | |
| | 350° C. | 24 | 24 | 24 | 27 | 31 | 36 | — | — |
| | 400° C. | 21 | 21 | 22 | 25 | 28 | 32 | — | — |
| 19 | Amount of Pt | 0 | 0.2 | 0.3 | 2 | 7 | 10 | 40 | 43 |
| | Total amount of | 38 | 38.2 | 38.3 | 40 | 45 | 48 | 78 | 81 |
| | additional elements | | | | | | | | |
| | 350° C. | 25 | 25 | 25 | 28 | 32 | 37 | — | — |
| | 400° C. | 22 | 22 | 22 | 25 | 29 | 33 | — | — |
| 22 | Amount of Pt | 0 | 0.2 | 0.3 | 2 | 7 | 10 | 37 | 40 |
| | Total amount of | 41 | 41.2 | 41.3 | 43 | 48 | 51 | 78 | 81 |
| | additional elements | | | | | | | | |
| | 350° C. | 26 | 26 | 26 | 29 | 33 | 38 | — | — |
| | 400° C. | 23 | 23 | 23 | 26 | 30 | 34 | — | — |

TABLE 18
(Ta = 0, N = 21)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 21 | 21.2 | 21.3 | 24 | 36 | 50 | 80 | 83 |
| | additional elements | | | | | | | | |
| | 350° C. | 21 | 21 | 21 | 24 | 27 | 32 | — | — |
| | 400° C. | 19 | 19 | 19 | 22 | 25 | 28 | — | — |
| 0.5 | Amount of Pt | 0 | 0.2 | 0.3 | 2.5 | 14.5 | 28.5 | 58.5 | 61.5 |
| | Total amount of | 21.5 | 21.7 | 21.8 | 24 | 36 | 50 | 80 | 83 |
| | additional elements | | | | | | | | |
| | 350° C. | 21 | 21 | 21 | 24 | 27 | 31 | — | — |
| | 400° C. | 19 | 19 | 19 | 22 | 24 | 28 | — | — |
| 1 | Amount of Pt | 0 | 0.2 | 0.3 | 2 | 14 | 28 | 58 | 61 |
| | Total amount of | 22 | 22.2 | 22.3 | 24 | 36 | 50 | 80 | 83 |
| | additional elements | | | | | | | | |
| | 350° C. | 20 | 20 | 20 | 23 | 26 | 30 | — | — |
| | 400° C. | 18 | 18 | 18 | 21 | 23 | 27 | — | — |
| 5 | Amount of Pt | 0 | 0.2 | 0.3 | 2 | 10 | 24 | 54 | 57 |
| | Total amount of | 26 | 26.2 | 26.3 | 28 | 36 | 50 | 80 | 83 |
| | additional elements | | | | | | | | |
| | 350° C. | 19 | 19 | 19 | 22 | 25 | 28 | — | — |
| | 400° C. | 17 | 17 | 17 | 20 | 22 | 26 | — | — |
| 8 | Amount of Pt | 0 | 0.2 | 0.3 | 2 | 7 | 21 | 51 | 54 |
| | Total amount of | 29 | 29.2 | 29.3 | 31 | 36 | 50 | 80 | 83 |
| | additional elements | | | | | | | | |
| | 350° C. | 20 | 20 | 20 | 23 | 26 | 30 | — | — |
| | 400° C. | 18 | 18 | 18 | 21 | 23 | 27 | — | — |
| 19 | Amount of Pt | 0 | 0.2 | 0.3 | 2 | 7 | 10 | 40 | 43 |
| | Total amount of | 40 | 40.2 | 40.3 | 42 | 47 | 50 | 80 | 83 |
| | additional elements | | | | | | | | |
| | 350° C. | 21 | 21 | 21 | 24 | 27 | 31 | — | — |
| | 400° C. | 19 | 19 | 19 | 21 | 24 | 28 | — | — |
| 22 | Amount of Pt | 0 | 0.2 | 0.3 | 2 | 7 | 10 | 37 | 40 |
| | Total amount of | 43 | 43.2 | 43.3 | 45 | 50 | 53 | 80 | 83 |
| | additional elements | | | | | | | | |
| | 350° C. | 21 | 21 | 22 | 25 | 28 | 32 | — | — |
| | 400° C. | 19 | 19 | 19 | 22 | 25 | 29 | — | — |

TABLE 19
(Ta = 3, N = 2)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 5 | 5.2 | 5.3 | 8 | 20 | 34 | 64 | 67 |
| | additional elements | | | | | | | | |
| | 350° C. | 79 | 79 | 80 | 91 | 103 | 119 | 158 | 158 |
| | 400° C. | 71 | 71 | 72 | 82 | 92 | 107 | 142 | 142 |
| 0.5 | Amount of Pt | 0 | 0.2 | 0.3 | 2.5 | 14.5 | 28.5 | 58.5 | 61.5 |
| | Total amount of | 5.5 | 5.7 | 5.8 | 8 | 20 | 34 | 64 | 67 |
| | additional elements | | | | | | | | |
| | 350° C. | 78 | 78 | 79 | 90 | 102 | 117 | 156 | 156 |
| | 400° C. | 70 | 70 | 71 | 81 | 92 | 106 | 141 | 141 |
| 1 | Amount of Pt | 0 | 0.2 | 0.3 | 2 | 14 | 28 | 58 | 61 |
| | Total amount of | 6 | 6.2 | 6.3 | 8 | 20 | 34 | 64 | 67 |
| | additional elements | | | | | | | | |
| | 350° C. | 75 | 75 | 76 | 86 | 98 | 113 | 150 | 150 |
| | 400° C. | 68 | 68 | 68 | 78 | 88 | 101 | 135 | 135 |
| 5 | Amount of Pt | 0 | 0.2 | 0.3 | 2 | 10 | 24 | 54 | 57 |
| | Total amount of | 10 | 10.2 | 10.3 | 12 | 20 | 34 | 64 | 67 |
| | additional elements | | | | | | | | |
| | 350° C. | 71 | 71 | 72 | 82 | 92 | 107 | 142 | 142 |
| | 400° C. | 64 | 64 | 65 | 74 | 83 | 96 | 128 | 128 |
| 8 | Amount of Pt | 0 | 0.2 | 0.3 | 2 | 7 | 21 | 51 | 54 |
| | Total amount of | 13 | 13.2 | 13.3 | 15 | 20 | 34 | 64 | 67 |
| | additional elements | | | | | | | | |
| | 350° C. | 75 | 75 | 76 | 86 | 98 | 113 | 150 | 150 |
| | 400° C. | 68 | 68 | 68 | 78 | 88 | 101 | 135 | 135 |
| 19 | Amount of Pt | 0 | 0.2 | 0.3 | 2 | 7 | 10 | 40 | 43 |
| | Total amount of | 24 | 24.2 | 24.3 | 26 | 31 | 34 | 64 | 67 |
| | additional elements | | | | | | | | |
| | 350° C. | 77 | 77 | 78 | 89 | 101 | 116 | 155 | 155 |
| | 400° C. | 70 | 70 | 70 | 80 | 91 | 105 | 139 | 139 |
| 22 | Amount of Pt | 0 | 0.2 | 0.3 | 2 | 7 | 10 | 37 | 40 |
| | Total amount of | 27 | 27.2 | 27.3 | 29 | 34 | 37 | 64 | 67 |
| | additional elements | | | | | | | | |
| | 350° C. | 81 | 81 | 81 | 93 | 105 | 121 | 161 | 161 |
| | 400° C. | 73 | 73 | 73 | 83 | 94 | 109 | 145 | 145 |

TABLE 20
(Ta = 14, N = 7)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 21 | 21.2 | 21.3 | 24 | 36 | 50 | 80 | 83 |
| | additional elements | | | | | | | | |
| | 350° C. | 38 | 38 | 38 | 44 | 49 | 57 | — | — |
| | 400° C. | 34 | 34 | 35 | 39 | 44 | 51 | — | — |
| 0.5 | Amount of Pt | 0 | 0.2 | 0.3 | 2.5 | 14.5 | 28.5 | 58.5 | 61.5 |
| | Total amount of | 21.5 | 21.7 | 21.8 | 24 | 36 | 50 | 80 | 83 |
| | additional elements | | | | | | | | |
| | 350° C. | 38 | 38 | 38 | 43 | 49 | 56 | — | — |
| | 400° C. | 34 | 34 | 34 | 39 | 44 | 51 | — | — |
| 1 | Amount of Pt | 0 | 0.2 | 0.3 | 2 | 14 | 28 | 58 | 61 |
| | Total amount of | 22 | 22.2 | 22.3 | 24 | 36 | 50 | 80 | 83 |
| | additional elements | | | | | | | | |
| | 350° C. | 36 | 36 | 36 | 42 | 47 | 54 | — | — |
| | 400° C. | 32 | 32 | 33 | 37 | 42 | 49 | — | — |
| 5 | Amount of Pt | 0 | 0.2 | 0.3 | 2 | 10 | 24 | 54 | 57 |
| | Total amount of | 26 | 26.2 | 26.3 | 28 | 36 | 50 | 80 | 83 |
| | additional elements | | | | | | | | |
| | 350° C. | 34 | 34 | 35 | 39 | 44 | 51 | — | — |
| | 400° C. | 31 | 31 | 31 | 35 | 40 | 46 | — | — |
| 8 | Amount of Pt | 0 | 0.2 | 0.3 | 2 | 7 | 21 | 51 | 54 |
| | Total amount of | 29 | 29.2 | 29.3 | 31 | 36 | 50 | 80 | 83 |
| | additional elements | | | | | | | | |
| | 350° C. | 36 | 36 | 36 | 42 | 47 | 54 | — | — |
| | 400° C. | 32 | 32 | 33 | 37 | 42 | 49 | — | — |
| 19 | Amount of Pt | 0 | 0.2 | 0.3 | 2 | 7 | 10 | 40 | 43 |
| | Total amount of | 40 | 40.2 | 40.3 | 42 | 47 | 50 | 80 | 83 |
| | additional elements | | | | | | | | |
| | 350° C. | 37 | 37 | 38 | 43 | 48 | 56 | — | — |
| | 400° C. | 34 | 34 | 34 | 39 | 44 | 50 | — | — |
| 22 | Amount of Pt | 0 | 0.2 | 0.3 | 2 | 7 | 10 | 37 | 40 |
| | Total amount of | 43 | 43.2 | 43.3 | 45 | 50 | 53 | 80 | 83 |
| | additional elements | | | | | | | | |
| | 350° C. | 39 | 39 | 39 | 45 | 50 | 58 | — | — |
| | 400° C. | 35 | 35 | 35 | 40 | 45 | 52 | — | — |

TABLE 21
(Ta = 29, N = 19)
Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 48 | 48.2 | 48.3 | 51 | 63 | 77 | 107 | 110 |
| | additional elements | | | | | | | | |
| | 350° C. | 5 | 5 | 5 | 6 | 7 | — | — | — |
| | 400° C. | 5 | 5 | 5 | 5 | 6 | — | — | — |
| 0.5 | Amount of Pt | 0 | 0.2 | 0.3 | 2.5 | 14.5 | 28.5 | 58.5 | 61.5 |
| | Total amount of | 48.5 | 48.7 | 48.8 | 51 | 63 | 77 | 107 | 110 |
| | additional elements | | | | | | | | |
| | 350° C. | 5 | 5 | 5 | 6 | 6 | — | — | — |
| | 400° C. | 4 | 4 | 4 | 5 | 6 | — | — | — |
| 1 | Amount of Pt | 0 | 0.2 | 0.3 | 2 | 14 | 28 | 58 | 61 |
| | Total amount of | 49 | 49.2 | 49.3 | 51 | 63 | 77 | 107 | 110 |
| | additional elements | | | | | | | | |
| | 350° C. | 5 | 5 | 5 | 5 | 6 | — | — | — |
| | 400° C. | 4 | 4 | 4 | 5 | 6 | — | — | — |
| 5 | Amount of Pt | 0 | 0.2 | 0.3 | 2 | 10 | 24 | 54 | 57 |
| | Total amount of | 53 | 53.2 | 53.3 | 55 | 63 | 77 | 107 | 110 |
| | additional elements | | | | | | | | |
| | 350° C. | 5 | 5 | 5 | 5 | 6 | — | — | — |
| | 400° C. | 4 | 4 | 4 | 5 | 5 | — | — | — |
| 8 | Amount of Pt | 0 | 0.2 | 0.3 | 2 | 7 | 21 | 51 | 54 |
| | Total amount of | 56 | 56.2 | 56.3 | 58 | 63 | 77 | 107 | 110 |
| | additional elements | | | | | | | | |
| | 350° C. | 5 | 5 | 5 | 5 | 6 | — | — | — |
| | 400° C. | 4 | 4 | 4 | 5 | 6 | — | — | — |
| 19 | Amount of Pt | 0 | 0.2 | 0.3 | 2 | 7 | 10 | 40 | 43 |
| | Total amount of | 67 | 67.2 | 67.3 | 69 | 74 | 77 | 107 | 110 |
| | additional elements | | | | | | | | |
| | 350° C. | 5 | 5 | 5 | 6 | — | — | — | — |
| | 400° C. | 4 | 4 | 4 | 5 | — | — | — | — |
| 22 | Amount of Pt | 0 | 0.2 | 0.3 | 2 | 7 | 10 | 37 | 40 |
| | Total amount of | 70 | 70.2 | 70.3 | 72 | 77 | 80 | 107 | 110 |
| | additional elements | | | | | | | | |
| | 350° C. | 5 | 5 | 5 | — | — | — | — | — |
| | 400° C. | 5 | 5 | 5 | — | — | — | — | — |

TABLE 22
(Ta = 31, N = 21)

Amount of Mn

| | | | | | | | | | |
|---|---|---|---|---|---|---|---|---|---|
| 0 | Amount of Pt | 0 | 0.2 | 0.3 | 3 | 15 | 29 | 59 | 62 |
| | Total amount of | 52 | 52.2 | 52.3 | 55 | 67 | 81 | 11 | 114 |
| | additional elements | | | | | | | | |
| | 350° C. | 5 | 5 | 5 | 5 | 6 | — | — | — |
| | 400° C. | 4 | 4 | 4 | 5 | 5 | — | — | — |
| 0.5 | Amount of Pt | 0 | 0.2 | 0.3 | 2.5 | 14.5 | 28.5 | 58.5 | 61.5 |
| | Total amount of | 52.5 | 52.7 | 52.8 | 55 | 67 | 81 | 111 | 114 |
| | additional elements | | | | | | | | |
| | 350° C. | 4 | 4 | 4 | 5 | 6 | — | — | — |
| | 400° C. | 4 | 4 | 4 | 5 | 5 | — | — | — |
| 1 | Amount of Pt | 0 | 0.2 | 0.3 | 2 | 14 | 28 | 58 | 61 |
| | Total amount of | 53 | 53.2 | 53.3 | 55 | 67 | 81 | 111 | 114 |
| | additional elements | | | | | | | | |
| | 350° C. | 4 | 4 | 4 | 5 | 6 | — | — | — |
| | 400° C. | 4 | 4 | 4 | 4 | 5 | — | — | — |
| 5 | Amount of Pt | 0 | 0.2 | 0.3 | 2 | 10 | 24 | 54 | 57 |
| | Total amount of | 57 | 57.2 | 57.3 | 59 | 67 | 81 | 111 | 114 |
| | additional elements | | | | | | | | |
| | 350° C. | 4 | 4 | 4 | 5 | 5 | — | — | — |
| | 400° C. | 4 | 4 | 4 | 4 | 5 | — | — | — |
| 8 | Amount of Pt | 0 | 0.2 | 0.3 | 2 | 7 | 21 | 51 | 54 |
| | Total amount of | 60 | 60.2 | 60.3 | 62 | 67 | 81 | 111 | 114 |
| | additional elements | | | | | | | | |
| | 350° C. | 4 | 4 | 4 | 5 | 6 | — | — | — |
| | 400° C. | 4 | 4 | 4 | 4 | 5 | — | — | — |
| 19 | Amount of Pt | 0 | 0.2 | 0.3 | 2 | 7 | 10 | 40 | 43 |
| | Total amount of | 71 | 71.2 | 71.3 | 73 | 78 | 81 | 111 | 114 |
| | additional elements | | | | | | | | |
| | 350° C. | — | — | — | — | — | — | — | — |
| | 400° C. | — | — | — | — | — | — | — | — |
| 22 | Amount of Pt | 0 | 0.2 | 0.3 | 2 | 7 | 10 | 37 | 40 |
| | Total amount of | 74 | 74.2 | 74.3 | 76 | 81 | 84 | 111 | 114 |
| | additional elements | | | | | | | | |
| | 350° C. | — | — | — | — | — | — | — | — |
| | 400° C. | — | — | — | — | — | — | — | — |

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A magnetoresistive element comprising:
a substrate; and
a multi-layer film formed on the substrate,
the multi-layer film comprising a pair of ferromagnetic layers and a non-magnetic layer sandwiched between the pair of ferromagnetic layers,
wherein a resistance value depends on a relative angle formed by magnetization directions of the pair of ferromagnetic layers, and
wherein when a centerline is defined so as to divide the non-magnetic layer into equal parts in a thickness direction, the longest distance from the centerline to interfaces between the pair of ferromagnetic layers and the non-magnetic layer is not more than 20 nm,
where the longest distance is determined by defining ten centerlines, each of which has a length of 50 nm, measuring distances from the ten centerlines to the interfaces so as to find the longest distance for each of the ten centerlines, taking eight values except for the maximum and the minimum values from the ten longest distances, and calculating an average of the eight values.

2. The magnetoresistive element according to claim 1, wherein the substrate is a single-crystal substrate.

3. The magnetoresistive element according to claim 1, wherein the non-magnetic layer is a tunnel insulating layer.

4. The magnetoresistive element according to claim 1, the multi-layer film further comprises a pair of electrodes that are arranged so as to sandwich the pair of ferromagnetic layers.

5. The magnetoresistive element according to claim 1, wherein the longest distance is not more than 3 nm.

6. The magnetoresistive element according to claim 1, wherein a composition in a range that extends by 2 nm from at least one of the interfaces in a direction opposite to the non-magnetic layer is expressed by
(FexCoyNiz)pM¹qM²rM³sAt
where M¹ is at least one element selected from the group consisting of Tc, Re, Ru, Os, Rh, Ir, Pd, Pt, Cu, Ag and Au, M² is at least one element selected from the group consisting of Mn and Cr, M³ is at least one element selected from the group consisting of Ti, Zr, Hf, V, Nb, Ta, Mo, W, Al, Si, Ga, Ge, In and Sn, A is at least one element selected from the group consisting of B, C, N, O, P and S, and x, y, z, p, q, r, s, and t satisfy the following equations:
0≦x≦100,
0≦y≦100,
0≦z≦100,
x+y+z=100,
40≦p≦99.7,
0.3≦q≦60,
0≦r≦20,
0≦s≦30,
0≦t≦20, and
p+q+r+s+t=100.

7. The magnetoresistive element according to claim 6, wherein p, q, and r satisfy p+q+r=100.

8. The magnetoresistive element according to claim 7, wherein p and q satisfy p+q=100.

9. The magnetoresistive element according to claim 1, wherein the multi-layer film further comprises an antiferromagnetic layer.

10. The magnetoresistive element according to claim 9, wherein a distance between the non-magnetic layer and the antiferromagnetic layer is 3 nm to 50 nm.

11. A magnetoresistive element comprising:
a substrate; and
a multi-layer film formed on the substrate,
the multi-layer film comprising a pair of ferromagnetic layers and a non-magnetic layer sandwiched between the pair of ferromagnetic layers,
wherein a resistance value depends on a relative angle formed by magnetization directions of the pair of ferromagnetic layers, and
wherein a composition in a range that extends by 2 nm from at least one of interfaces between the pair of ferromagnetic layers and the non-magnetic layer in a direction opposite to the non-magnetic layer is expressed by
(FexCoyNiz)pM¹qM²rM³sAt
where M¹ is at least one element selected from the group consisting of Tc, Re, Ru, Os, Rh, Ir, Pd, Pt, Cu, Ag and Au, M² is at least one element selected from the group consisting of Mn and Cr, M³ is at least one element selected from the group consisting of Ti, Zr, Hf, V, Nb, Ta, Mo, W, Al, Si, Ga, Ge, In and Sn, A is at least one element selected from the group consisting of B, C, N, O, P and S, and x, y, z, p, q, r, s, and t satisfy the following equations:
0≦x≦100,
0≦y≦100,
0≦z≦100,
x+y+z=100,
40≦p≦99.7,
0.323 q≦60,
0≦r≦20,
0≦s≦30,
0≦t≦20, and
p+q+r+s+t=100.

12. A method for manufacturing a magnetoresistive element,
the magnetoresistive element comprising a substrate and a multi-layer film formed on the substrate, the multi-layer film comprising a pair of ferromagnetic layers and a non-magnetic layer sandwiched between the pair of ferromagnetic layers, wherein a resistance value depends on a relative angle formed by magnetization directions of the pair of ferromagnetic layers,
the method comprising:
forming a part of the multi-layer film other than the ferromagnetic layers and the non-magnetic layer on the substrate as an underlying film;
heat-treating the underlying film at 400° C. or more;
decreasing roughness of a surface of the underlying film by irradiating the surface with an ion beam;
forming the remaining part of the multi-layer film including the ferromagnetic layers and the non-magnetic layer on the surface; and
heat-treating the substrate and the multi-layer film at 330° C. or more.

13. The method according to claim 12, wherein the surface of the underlying film is irradiated with the ion beam so that an angle of incidence of the ion beam at the surface is 5° to 25°.

14. The method according to claim 12, wherein a lower electrode and an upper electrode are formed as a portion of the multi-layer film, and the lower electrode is included in the underlying film.
